(19) United States
(12) Patent Application Publication
(10) Pub. No.: US 2023/0217345 A1
(43) Pub. Date: Jul. 6, 2023

(54) SPACE-BASED AIRCRAFT MONITORING

(71) Applicant: AIREON LLC, McLean, VA (US)

(72) Inventor: Om GUPTA, McLean, VA (US)

(21) Appl. No.: 18/156,329

(22) Filed: Jan. 18, 2023

Related U.S. Application Data
(63) Continuation of application No. 17/488,585, filed on Sep. 29, 2021, now abandoned.
Application No. 17/488,585 is a continuation of application No. 15/923,396, filed on Mar. 16, 2018, now abandoned.
(60) Provisional application No. 62/473,065, filed on Mar. 17, 2017.

(51) Int. Cl. H04W 40/06; H04B 7/185; H04B 7/195; H04B 17/40; H04W 16/28; H04W 72/52

(52) U.S. Cl. CPC H04W 40/06; H04B 7/195; H04B 7/18508; H04B 7/18521; H04B 17/40; H04W 16/28; H04W 72/52; H04W 72/121

(57) ABSTRACT

In one implementation, a system for space-based aircraft monitoring includes a ground segment, multiple aircraft monitoring payloads on board corresponding satellites, and a resource scheduling system. Individual payloads include antenna systems configured to provide multiple beams for receiving ADS-B messages and two or more receivers configured to process received ADS-B messages that are implemented, at least in part, by reconfigurable FPGAs. In addition, individual payloads are configured to initiate transmission of ADS-B messages processed by one or more of their receivers to the ground segment. Meanwhile, the ground segment is configured to receive such messages and to route them to one or more destinations for aircraft monitoring. The resource scheduling system is configured to control the antenna systems of individual payloads to dynamically adjust the beams for receiving ADS-B messages of the individual antenna systems.

### CROSS-REFERENCE TO RELATED APPLICATION

This application is a continuation of U.S. Pat. Application No. 17/488,585 filed on Sep. 29, 2021, which is a continuation of U.S. Pat. Application No. 15/923,396 filed on Mar. 16, 2018, which claims the benefit of U.S. Provisional Pat. Application No. 62/473,065 filed on Mar. 17, 2017, the disclosures of each of which are incorporated herein by reference in their entirety.

### TECHNICAL FIELD

The present disclosure relates to space-based aircraft monitoring.

### SUMMARY

According to one general aspect, a system for space-based aircraft monitoring includes a ground segment, multiple aircraft monitoring payloads on board corresponding satellites, and a resource scheduling system. Individual payloads include antenna systems configured to provide multiple beams for receiving ADS-B messages and two or more receivers configured to process received ADS-B messages that are implemented, at least in part, by reconfigurable FPGAs. In addition, individual payloads are configured to initiate transmission of ADS-B messages processed by one or more of their receivers to the ground segment. Meanwhile, the ground segment is configured to receive such messages and to route them to one or more destinations for aircraft monitoring. The resource scheduling system is configured to control the antenna systems of individual payloads to dynamically adjust the beams for receiving ADS-B messages of the individual antenna systems.

According to another general aspect, a payload for space-based aircraft monitoring includes an antenna system configured to provide multiple beams for receiving ADS-B messages while in orbit above the Earth and to dynamically adjust the beams for receiving ADS-B messages. In addition, the payload also includes two or more receivers configured to process ADS-B messages received by the antenna system implemented, at least in part, by reconfigurable field programmable gate arrays, and a transmission system configured to initiate transmission of ADS-B messages processed by the receivers to a ground segment while in orbit above the Earth.

According to still another general aspect, a ground segment for a space-based aircraft monitoring system having multiple aircraft monitoring payloads on board corresponding satellites in orbit around the Earth includes an antenna system configured to transmit communications to and receive communications from the satellites, one or more processing elements, and computer readable storage media storing instructions that, when executed by the one or more processing elements, cause the one or more processing elements to control antenna subsystems of individual aircraft monitoring payloads configured to provide beams for receiving ADS-B messages to dynamically adjust the beams, process ADS-B messages received from the satellites, and route processed ADS-B messages to one or more destinations for aircraft monitoring.

Other features of the present disclosure will be apparent in view of the following detailed description of the disclosure and the accompanying drawings. Implementations described herein, including the above-described implementations, may include a method or process, a system, or computer-readable program code embodied on computer-readable media.

### BRIEF DESCRIPTION OF THE DRAWINGS

FIG. 1A is a high level block diagram of an example of a space-based ADS-B system in accordance with non-limiting implementations of the present disclosure.

FIG. 1B is a high level block diagram of an example of an air traffic management system ecosystem in accordance with a non-limiting implementation of the present disclosure.

FIG. 2 is a high level block diagram of an example of a space-based ADS-B system in accordance with non-limiting implementations of the present disclosure.

FIG. 3 is a diagram of an example of a satellite in accordance with a non-limiting implementation of the present disclosure.

FIG. 4 is a schematic block diagram of a constellation of satellites providing coverage in accordance with a non-limiting implementation of the present disclosure.

FIG. 5 is a schematic block diagram of a satellite coverage provisioning system in accordance with a non-limiting implementation of the present disclosure.

FIG. 6 is a schematic diagram of hysteresis for cumulative power consumption in accordance with a non-limiting implementation of the present disclosure.

FIG. 7 is a flow diagram of an exemplary satellite coverage provisioning process in accordance with a non-limiting implementation of the present disclosure.

FIG. 8 is a flow diagram of an exemplary iteration of a loop for satellite coverage provisioning in accordance with a non-limiting implementation of the present disclosure.

FIG. 9 is a flow diagram of an exemplary process for preparing satellites in accordance with a non-limiting implementation of the present disclosure.

FIG. 10 is a flow diagram of an exemplary process for updating statuses of satellites in accordance with a non-limiting implementation of the present disclosure.

FIG. 11 is a flow diagram of an exemplary process for determining whether a satellite may be put into a “High Idle” power level in accordance with a non-limiting implementation of the present disclosure.

FIG. 12 is a flow diagram of an exemplary process for determining whether a satellite may be put into a “Low Idle” power level in accordance with a non-limiting implementation of the present disclosure.

FIG. 13 is a flow chart of an example of a process for selecting a beam configuration in accordance with a non-limiting implementation of the present disclosure.

FIG. 14 is an illustration of an example of a beam pattern in accordance with a non-limiting implementation of the present disclosure.

FIGS. 15A-15B are illustrations of examples of beam patterns in accordance with a non-limiting implementation of the present disclosure.

FIGS. 16A-16B are illustrations of examples of beam patterns in accordance with a non-limiting implementation of the present disclosure.

FIG. 17 is a flow chart of an example of a process for selecting a beam configuration in accordance with a non-limiting implementation of the present disclosure.

FIG. 18 is a flow chart of a method for receiving 1090 MHz Mode S ES ADS-B messages in accordance with a non-limiting implementation of the present disclosure.

FIG. 19 is a functional block diagram of one example of a receiver for receiving 1090 MHz Mode S ES ADS-B messages in accordance with a non-limiting implementation of the present disclosure.

FIG. 20 is a functional block diagram of one example of a receiver for receiving 1090 MHz Mode S ES ADS-B messages in accordance with a non-limiting implementation of the present disclosure.

FIG. 21 is a functional block diagram of one example of a multi-layer signal screening test block in accordance with a non-limiting implementation of the present disclosure.

FIG. 22 is a functional block diagram of one example of a minimum mean square error signal estimator in accordance with a non-limiting implementation of the present disclosure.

FIG. 23 is a functional block diagram of one example of a module configured to calculate the residual phase error of a signal in accordance with a non-limiting implementation of the present disclosure.

FIG. 24 is a functional block diagram of one example of a module configured to calculate a measure of the amplitude consistency of pulses within a signal and a measure of the phase consistency of the signal in accordance with a non-limiting implementation of the present disclosure.

FIG. 25 is a functional block diagram of one example of a pattern recognition module in accordance with a non-limiting implementation of the present disclosure.

FIG. 26 is a functional block diagram of one example of a re-triggering test module in accordance with a non-limiting implementation of the present disclosure.

FIG. 27 is a functional block diagram of one example of a non-coherent matched filter in accordance with a non-limiting implementation of the present disclosure.

FIG. 28 is a functional block diagram of one example of a carrier frequency estimator in accordance with a non-limiting implementation of the present disclosure.

FIG. 29 is a flow chart of a method for receiving 1090 MHz Mode S ES ADS-B messages in accordance with a non-limiting implementation of the present disclosure.

FIG. 30 is a functional block diagram of one example of a receiver for receiving 1090 MHz Mode S ES ADS-B messages in accordance with a non-limiting implementation of the present disclosure.

FIG. 31 is a functional block diagram of one example of a receiver for receiving 1090 MHz Mode S ES ADS-B messages in accordance with a non-limiting implementation of the present disclosure.

FIG. 32 is a functional block diagram of one example of a multi-layer signal screening test block in accordance with a non-limiting implementation of the present disclosure.

FIG. 33 is a functional block diagram of an example of a minimum mean square error signal estimator in accordance with a non-limiting implementation of the present disclosure.

FIG. 34 is a functional block diagram of one example of a module configured to calculate the residual phase error of a signal in accordance with a non-limiting implementation of the present disclosure.

FIG. 35 is a functional block diagram of one example of a module configured to calculate a measure of the amplitude consistency of pulses within a signal and a measure of the phase consistency of the signal in accordance with a non-limiting implementation of the present disclosure.

FIG. 36 is a functional block diagram of one example of a pattern recognition module in accordance with a non-limiting implementation of the present disclosure.

FIG. 37 is a functional block diagram of one example of a re-triggering test module in accordance with a non-limiting implementation of the present disclosure.

FIG. 38 is a functional block diagram of one example of a correlator in accordance with a non-limiting implementation of the present disclosure.

FIG. 39 is a functional block diagram of one example of a carrier refinement module in accordance with a non-limiting implementation of the present disclosure.

FIG. 40 is a functional block diagram of an example of a minimum mean square error signal estimator in accordance with a non-limiting implementation of the present disclosure.

FIG. 41 is a functional block diagram of one example of a coherent matched filter module in accordance with a non-limiting implementation of the present disclosure.

FIG. 42 is a functional block diagram of an example of a ground control system and satellite interaction ecosystem in accordance with a non-limiting implementation of the present disclosure.

### DETAILED DESCRIPTION

Traditionally, air traffic control, aircraft surveillance, and flight path management services have relied on ground-based radar stations and surveillance data processing systems. These systems rely on aircraft-based radio transmitters and terrestrial interrogation and receiving stations to implement systems, such as, for example, primary surveillance radar (“PSR”), secondary surveillance radar (“SSR”), and/or mode select (“Mode S”) radar, for communicating aircraft position and monitoring information to local ground stations. The information received at the local ground stations is then relayed to regional or global aircraft monitoring systems. Such conventional radar-based systems for use in air traffic control, aircraft surveillance, and flight path management services are limited to use in regions in which the appropriate ground infrastructure exists to interrogate and receive messages from aircraft. Consequently, vast areas of the world’s airspace (e.g., over the oceans and poles, remote and/or mountainous regions, etc.) are not monitored by conventional, terrestrial radar-based systems.

Recently, modernization efforts have been launched to replace radar-based air traffic control, aircraft surveillance, and flight management systems with more advanced automatic dependent surveillance-broadcast (“ADS-B”) based systems. In an ADS-B-based system, an aircraft determines its position using a satellite-based navigation system (e.g., the Global Positioning System (“GPS”)) and periodically broadcasts its position, thereby enabling the aircraft to be tracked by systems that receive the aircraft’s ADS-B broadcasts. In some particular implementations, an ADS-B equipped aircraft uses onboard equipment and sensors to determine its horizontal position, altitude, and velocity and then combines this information with its aircraft identification and call sign into the ADS-B messages that it transmits.

ADS-B-based transponders, which may operate on the same frequency as traditional Mode A/C/S transponders (e.g., 1090 MHz), may utilize different data links and formats for broadcasting ADS-B messages, including, for example, DO-260, DO-260A and DO-260B (Link Versions 0, 1 and 2, respectively) and DO-260B/ED-102A. 1090 MHz Mode S ES is a particular example of one such data link that has been adopted in many jurisdictions. For example, in the United States, the Federal Aviation Administration (“FAA”) has mandated 1090 MHz Mode S ES for use by air carrier and private or commercial operators of high-performance aircraft. Like traditional radar-based systems, ADS-B-based systems require appropriate infrastructure for receiving ADS-B messages broadcast by aircraft. As a result, even as numerous jurisdictions transition to terrestrial, ADS-B-based systems, air traffic in vast airspaces remains unmonitored.

As described in this disclosure, to address this limitation of terrestrial ADS-B systems, ADS-B receivers may be hosted on satellites and used to receive ADS-B messages broadcast by aircraft. Such ABS-B messages received by the satellites then can be relayed back down to earth terminals or other terrestrial communications infrastructure for transmission to and use by air traffic control, aircraft surveillance, and flight path management services.

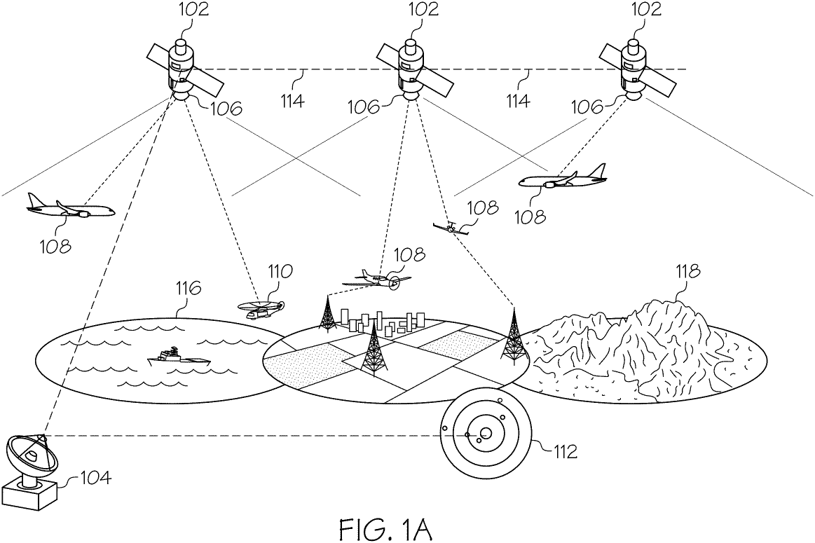

For example, as illustrated in FIG. 1A, a space-based ADS-B system 100 includes one or more satellites 102 in orbit above the Earth and a ground segment 104. Each satellite 102 is equipped with one or more receivers 106 configured to receive ADS-B messages transmitted by aircraft, including, but not limited to, airplanes 108 and helicopters 110, and the ground segment 104, among other things, is configured to communicate with the one or more satellites, including, for example, to receive ADS-B messages that the satellites receive from the aircraft and then relay to the ground segment. As illustrated in FIG. 1A, ADS-B messages transmitted by aircraft may be received by terrestrial ADS-B infrastructure, if within range of the aircraft and not obstructed (e.g., by a topographical feature like a mountain or a man-made structure), and/or by ADS-B receivers 106 on board one or more of the satellites 102.

When an ADS-B message transmitted by an aircraft is received by an ADS-B receiver on a satellite 102, the satellite 102 may retransmit the received ADS-B message to the space-based ADS-B system’s ground segment 104, for example via a ground station, earth station, earth terminal, teleport, and/or similar terrestrial component configured to communicate with the satellite(s). From there, the space-based ADS-B system’s ground segment may route (e.g., via one or more terrestrial communications networks) the ADS-B message (or some or all of the information contained therein) to one or more appropriate destinations 112, such as, for example, an air navigation service provider or other air traffic control authority, the airline to which the aircraft that transmitted the ADS-B message belongs, or any other entity with an interest in the ADS-B message. In some implementations, the information included in the ADS-B message may be combined with ground-based surveillance data and/or flight plan information for integration within air traffic control systems to provide air traffic controllers a single representation of a given aircraft. The space-based ADS-B system’s ground segment 104 may transmit the information included in a received ADS-B message to a destination in one of a variety of different formats, including, for example, ASTERIX CAT021, CAT023, CAT025, CAT238 and FAA CAT033 and CAT023.

In some implementations, individual satellites 102 within the space-based ADS-B system 100 may retransmit ADS-B messages that they receive directly to the ground segment 104. Additionally or alternatively, and as illustrated in FIG. 1A, in some implementations, communications crosslinks 114 may be established between two or more satellites 102 within the space-based ADS-B system 100, thereby enabling the satellites 102 to communicate with one another. In such implementations, a satellite 102 that receives an ADS-B message may retransmit the ADS-B message to the ground segment 104 indirectly through one or more additional satellites 102 within the space-based ADS-B system 100 via the communications crosslinks 114.

Notably, as illustrated in FIG. 1A, ADS-B messages transmitted by aircraft flying over regions where terrestrial ADS-B infrastructure does not exist, for example over oceans 116 or rugged or remote terrain like the poles or mountain ranges 118, may be received by ADS-B receivers 114 on board one or more of the satellites 102. As a result, tracking, monitoring, and/or surveilling aircraft flying over these regions still may be possible even in the absence of terrestrial ADS-B infrastructure in these regions. Providing space-based ADS-B coverage in regions like this where terrestrial ADS-B coverage is not available may have a number of advantages. For example, space-based ADS-B coverage in these regions may enable air traffic control to authorize better and/or more flexible flight paths and plans than in the absence of surveillance data, which may be particularly beneficial for transoceanic and other flights across large stretches of non-surveilled airspace. In non-surveilled airspace, air traffic control often requires aircraft to be separated by large distances (e.g., 60-90 nautical miles) and may restrict aircraft to flying specific, pre-defined flight paths at predefined altitudes even if, at flight time, the pre-defined flight paths and altitudes present sub-optimal flight conditions (e.g., bad weather, turbulence, fuel inefficiency, etc.). By brining surveillance to these airspaces, space-based ADS-B may allow aircraft to fly more closely together (e.g., as close as 15 nautical miles) and pilots may be allowed more flexibility in deviating from pre-defined flights paths and/or altitudes. This may lead to reduced fuel usage (and the related benefits of lower costs and less CO₂ and other greenhouse gas emissions), shorter flight times, and/or safer or more comfortable flights.

Space-based ADS-B systems such as described herein may provide a number of additional advantages over other systems as well. For example, traditional radar-based air traffic control systems may be limited in their ability to service high-traffic environments, such as, for example, near airports, among other reasons, for example, due to their limited range and update frequency. In contrast, space-based ADS-B systems may provide expanded range and increased update frequency, thereby enabling, for example, more efficient flight takeoff and landing schedules and more flexible aircraft maneuvers in congested environments. Additionally or alternatively, a space-based ADS-B system that provides global ADS-B coverage may enable an airline to have up-to-date and real-time or near real-time visibility of its entire fleet of aircraft at any given moment.

FIG. 1B is a high-level block diagram that provides another illustration of an example of a space-based ADS-B system 5. As illustrated in FIG. 1B, system 5 includes satellite 10 in communication with and part of satellite network 20, and aircraft 70. In some implementations, satellite network 20, including satellite 10, may be a low Earth orbit (“LEO”) constellation of cross-linked communications satellites. As illustrated in FIG. 1B, terrestrial ADS-B ground station 60, air traffic management system 40 and satellite communication network earth terminal 30 are located on Earth 80′s surface.

Aircraft 70 carries an on-board ADS-B transponder 72 that broadcasts ADS-B messages containing flight status and tracking information. Satellite 10 carries payload 12 to receive ABS-B messages broadcast by aircraft 70 and other aircraft. In some implementations, multiple or all of the satellites in satellite network 20 may carry ADS-B payload to receive ADS-B messages broadcast by aircraft. Messages received at receiver 12 are relayed through satellite network 20 to satellite communication network earth terminal 30 and ultimately to air traffic management system 40 through terrestrial network 50. The air traffic management system 40 may receive aircraft status information from various aircraft and provide additional services such as air traffic control and scheduling or pass appropriate information along to other systems or entities.

In some implementations, ADS-B payload 12 may have one or more antennas and one or more receivers for receiving ADS-B messages broadcast by aircraft. Additionally or alternatively, in some implementations, ADS-B payload 12 may have a phased array antenna formed from multiple antenna elements that collectively are configured to provide multiple different beams for receiving ADS-B messages.

In certain implementations, satellite network 20 may have a primary mission other than receiving ADS-B messages broadcast by aircraft. For example, in some implementations, satellite network 20 may be a LEO, mobile satellite communications constellation. In such implementations, ADS-B payloads like ADS-B payload 12 may be hosted on satellites 10 of satellite network 20 as hosted or secondary payloads that may be considered secondary to the primary mission of the satellite network 20. Consequently, such ADS-B payloads when operated as hosted payloads may be constrained by certain limitations, such as, for example, a relatively low maximum weight and a relatively low power budget so as not to take away from the primary mission of the satellite network 20.

Terrestrial ADS-B ground station 60 provides aircraft surveillance coverage for a relatively small portion of airspace, for example, limited to aircraft within line of sight of ground station 60. Even if terrestrial ADS-B ground stations like ground station 60 are widely dispersed across land regions, large swaths of airspace (e.g., over the oceans) will remain uncovered. Meanwhile, a spaced-based ADS-B system 5 utilizing a satellite network like satellite network 20 may provide coverage of airspace over both land and sea regions without being limited to areas where ground-based surveillance infrastructure has been installed. Thus, a space-based ADS-B system may be preferable (or a valuable supplement) to terrestrial approaches.

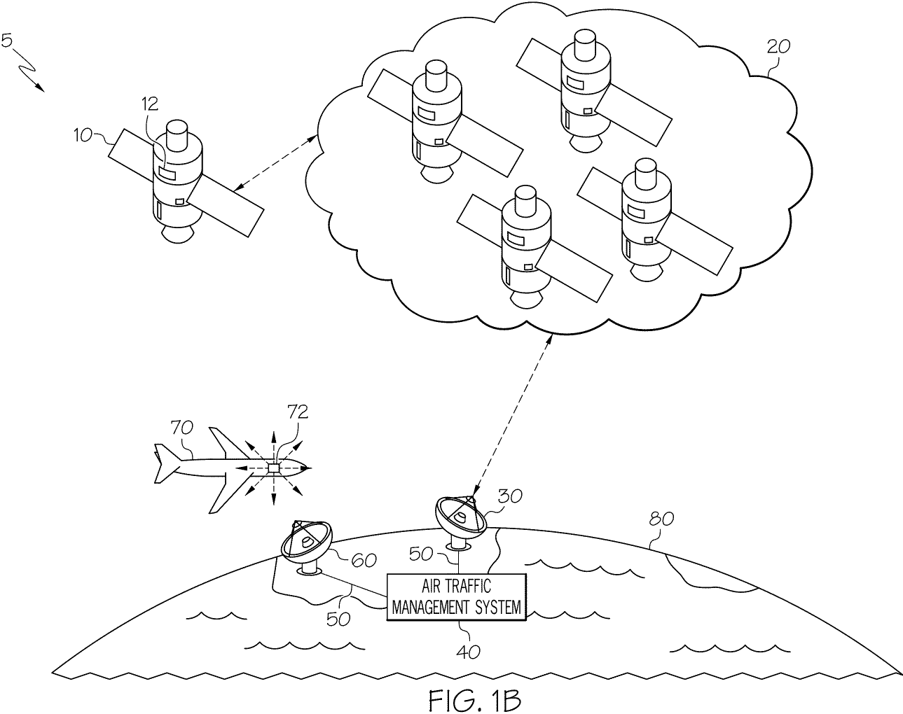

As described above, in some implementations, a space-based ADS-B system may include a constellation of multiple satellites equipped with one or more ADS-B receivers in low-Earth orbit (“LEO”) (e.g., 99-1,200 miles above the Earth’s surface). For example, as illustrated in FIG. 2, in one particular implementation, a space-based ADS-B system 200 may include 66 LEO satellites 202 equipped with one or more ADS-B receivers (not shown) arranged in 6 orbital planes 204 (e.g., in substantially polar orbits) of 11 satellites each. In this arrangement, the satellites 202 collectively may provide global (or substantially global) ADS-B coverage. For example, the individual satellites 202 of the constellation may have ADS-B coverage footprints that collectively are capable of covering every square inch (or nearly every square inch) of the Earth’s surface. As further illustrated in FIG. 2 and as also discussed above in connection with FIG. 1, in some implementations, communications cross-links may be established between individual satellites 202, thereby effectively forming a wireless mesh network in space that may enable the satellites 202 to communicate with each other and to relay ADS-B messages received by individual satellites 202 through the network. In the particular implementation illustrated in FIG. 2, each satellite is cross-linked to four satellites 202: one satellite 202 in each of the fore and aft direction of its orbital 204 plane and one satellite 202 in each of the adjacent orbital planes 204 to the left and right. Although the specific implementation illustrated in FIG. 2 is shown as including 66 LEO satellites 202 arranged in 6 orbital planes 204 (e.g., in substantially polar orbits) of 11 satellites 202 each, space-based ADS-B systems may include different numbers of satellites 202 (e.g., more or less than 66), arranged in different plane configurations (e.g., in different numbers of planes and/or in planes having different inclinations), and in different orbits (e.g., mid-Earth orbit (“MEO”), geostationary orbit (“GEO”), geosynchronous, and/or sun synchronous).

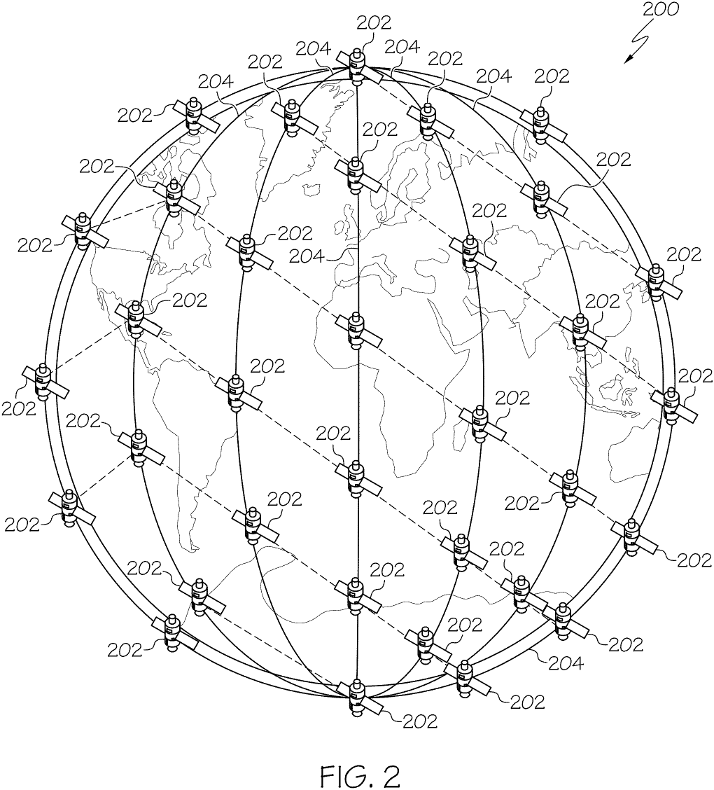

In some implementations, the satellites may have a primary mission other than receiving ADS-B messages transmitted by aircraft. For example, in some implementations, the satellites may be part of a LEO, mobile satellite communications network. In such implementations, individual satellites of the mobile satellite communications network may host secondary or auxiliary payloads that are configured to receive ADS-B messages transmitted by aircraft and that may be considered secondary to the primary, mobile communications mission of the satellite network. For example, as illustrated in FIG. 3, in some implementations, one or more mobile communications satellites 300 may host secondary payloads 302 that are configured to receive ADS-B messages transmitted by aircraft. In the particular example illustrated in FIG. 3, the mobile communications satellite 300 includes, among other features, a main mission antenna 304, for example, for communicating with mobile user terminals, feeder link antennas 306, for example, for communicating with the ground segment, and cross-link antennas 308, for example, for communicating with other satellites, all related to the main mobile satellite communications mission. In addition, satellite 300 includes hosted payload 302 that is configured to receive ADS-B messages transmitted by aircraft. Upon receipt, ADS-B messages received by hosted payload 302 may be transmitted to appropriate destinations via the satellite communications network. In the particular implementation illustrated in FIG. 3, hosted payload 302 includes 5 panels having antenna elements. In some implementations, hosted payload 302 may control these antenna elements to define the ADS-B coverage pattern for receiving ADS-B messages transmitted by aircraft for the hosted payload 302 during different periods of time. Although not shown in FIG. 3, hosted payload 302 also includes one or more receivers (e.g., implemented in hardware, software, or a combination of hardware) for processing signals received by hosted payload’s 302 antennas.

While a space-based ADS-B system may be preferable (or a valuable supplement) to terrestrial approaches, implementing a spaced-based ADS-B system may present a number of challenges. For example, satellite systems typically have limited power budgets. Consequently, the space segment, or individual satellites within the space segment, of a space-based ADS-B system may need to comply with a power budget. This may be particularly challenging when the space segment of a space-based ADS-B system is implemented as one or more secondary or auxiliary payloads hosted on one or more satellites having a different primary mission. In such implementations, the power budget available to the hosted payload(s) may be limited due to the secondary nature of the hosted payload(s) relative to the primary mission of the host satellite(s). In some such implementations, the power budget available to the hosted payload(s) may be defined on a system-wide basis. Additionally or alternatively, in some implementations, the power budget available to the hosted payload(s) may be defined on an individual payload basis. To comply with such power budgets, the resources of the satellites and/or payloads forming the space segment of the spaced-based ADS-B system may be managed intelligently. Specific examples of such intelligent resource management techniques are described in greater detail below in the section under the Intelligent Resource Management heading. In some implementations, resource management schedules for a particular satellite or payload during a period of time may be determined, at least in part, based on expected aircraft traffic in the region(s) covered by the satellite or payload during the period of time.

In some implementations, individual satellites or payloads within the space segment of a space-based ADS-B system may have antennas that are configured to generate multiple different beams for receiving ADS-B messages, and, in some implementations, one or more such beams may be steerable. For example, in some implementations, the antennas on individual satellites or payloads may be phased array antennas formed from multiple antenna elements that collectively are configured to provide multiple different beams for receiving ADS-B messages. In implementations in which individual satellites or payloads have antennas configured to generate multiple different beams for receiving ADS-B messages, individual satellites or payloads may benefit from intelligent beam scheduling techniques, for example, to achieve desired coverage without exceeding allowed power budgets and/or to operate within other constraints, such as, for example, size and/or processing constraints that may limit the number of receivers that may be implemented on an individual satellite or payload and/or the number of received signals that can be processed concurrently by an individual satellite or payload. Specific examples of such intelligent beam scheduling techniques are described in greater detail below in the section under the Beam Scheduling heading. In some implementations, beam schedules for a particular satellite or payload during a period of time may be determined, at least in part, based on expected aircraft traffic in the region(s) covered by the satellite or payload during the period of time.

In a space-based ADS-B system, there may be a significant distance between aircraft transmitting ADS-B messages and the satellites or payloads configured to receive ADS-B messages transmitted by the aircraft. For example, even a satellite in low-Earth orbit may orbit the Earth at an altitude as high as approximately 1,243 miles while aircraft typically do not fly much above 40,000 feet (approximately 7.6 miles) above the earth. The significant propagation distance for ADS-B messages may make successful detection and reception of ADS-B messages by a satellite-based ADS-B receiver much more difficult than by a terrestrial-based ADS-B receiver. Furthermore, satellites in low-Earth orbit may orbit the Earth at speeds upwards of 17,000 miles per hour, resulting in Doppler shifts that add additional complications to successfully receiving ADS-B messages. Moreover, given the wider coverage area provided by a satellite as compared to a terrestrial ground station, a satellite-based ADS-B receiver may be exposed to a much higher volume of ADS-B messages than a terrestrial-based ADS-B receiver. As a result, ADS-B messages may arrive at a satellite-based receiver in an interfering or overlapping manner. ADS-B messages that interfere and/or overlap with a desired ADS-B message may be referred to as (or may be one component of) false replies unsynchronized with interrogator transmissions or, alternatively, false replies unsynchronized in time (“FRUIT”). Other communications protocols that share the 1090 MHz band with ADS-B also may contribute interference and be a source of FRUIT. For example, aircraft implementing secondary surveillance radar (“SSR”) like Mode A, Mode C, or Mode S, may respond to interrogating SSR messages in the 1090 MHz band, potentially creating interference for ADS-B messages. Other transmitters within range of an ADS-B receiver transmitting in neighboring or nearby frequency bands also may generate interference or contribute to noise. Consequently, the signal-to-noise ratio (“SNR”) for an ADS-B message received by a space-based ADS-B receiver typically will be much lower than the SNR for an ADS-B message received by a terrestrial ADS-B receiver. Appropriately dealing with FRUIT and/or other interference/noise, particularly for airspaces with a high density of air traffic, is an example of another challenge faced in implementing a space-based ADS-B system.

Examples of satellite-based ADS-B receiver designs that may be employed in the space-based ADS-B systems disclosed herein are described in greater detail below in the section under the heading ADS-B Receiver Designs. In addition, the subsection under the heading ADS-B Receiver Designs - Non-Coherent Receivers describes examples of non-coherent ADS-B receiver designs, while the subsection under the heading ADS-B Receiver Designs - Coherent Receivers describes examples of coherent ADS-B receiver designs.

In some implementations, individual satellites or individual payloads within the space segment of a space-based ADS-B system may include multiple ADS-B receivers. The presence of multiple ADS-B receivers on an individual satellite or payload may enable the satellite or payload to process multiple incoming ADS-B messages concurrently. Furthermore, the presence of multiple ADS-B receivers on an individual satellite or payload may provide redundancy in the event of the failure of one or more ADS-B receivers. In some implementations, individual satellites or payloads within the space segment of a space-based ADS-B system may include one or more non-coherent ADS-B receivers and one or more coherent ADS-B receivers. Additionally or alternatively, in some implementations, one or more ADS-B receivers (and/or other processing elements of the space segment of a space-based ADS-B system) on individual satellites or payloads may be implemented by field-programmable gate arrays (“FPGAs”), which may be reprogrammable, or otherwise implemented in whole or in part in software, thereby providing a relatively flexible architecture that may be modified over time by uploading design changes and/or software updates to an individual satellite or payload (e.g., via a feeder link).

In some implementations, the ground segment of a space-based ADS-B system may include one or more computing systems responsible for or otherwise involved in managing and/or coordinating various aspects of the space-based ADS-B system. For example, in some implementations, the ground segment of a space-based ADS-B system may include one or more computing systems that intelligently manage the resources of the space segment, for example, as described below in the section under the heading Intelligent Resource Management and/or that intelligently schedule beams of the antennas of individual satellites or payloads within the space segment, for example, as described below in the section under the heading Beam Scheduling. In such implementations, the ground segment computing resources may determine resource and/or antenna beam schedules for the satellites or payloads within the space segment. The ground segment then may upload the resource and/or antenna beam schedules to the satellites or payloads within the space segment (e.g., via one or more feeder links between the ground segment and satellites or payloads within the space segment) where they may be implemented by the satellites or payloads. In implementations in which individual satellites or payloads within the space segment are connected by communications cross-links, resource and/or antenna beam schedules uploaded to the space segment by the ground segment may be distributed across the satellites or payloads of the space segment via the communications cross-links. In alternative implementations, instead of employing ground segment computing resources to determine resource and/or antenna beam schedules for the satellites or payloads within the space segment, processing resources in the space segment (e.g., processing resources of one or more satellites or payloads within the space segment) may determine resource and/or antenna beam schedules for satellites or payloads within the space segment.

In some implementations, the space segment of a space-based ADS-B message may intelligently process and/or retransmit received ADS-B messages to the ground segment. For example, in some implementations, individual satellites or payloads may screen received candidate ADS-B messages for potential false positives and determine to discard or otherwise not retransmit received candidate ADS-B messages determined to be false positives. Additionally or alternatively, in some implementations, individual satellites or payloads may employ error detection and correction techniques on received candidate ADS-B messages and only retransmit received candidate ADS-B messages in which no errors are detected or, in the event that errors are detected, for which error correction is successfully performed. Furthermore, in some implementations, individual satellites or payloads may determine not to retransmit a received candidate ADS-B message if they determine that they received and retransmitted another candidate ADS-B message from the same aircraft within a defined period of time. In this manner, the satellites or payloads may attempt to reduce the bandwidth consumed by retransmitting received ADS-B messages to the ground segment. Additionally or alternatively, in this manner, the satellites or payloads may attempt to prevent the retransmission of duplicate received ADS-B messages to the ground segment, for example, in the event that multiple receivers on the same satellite or payload receive the same ADS-B message.

A space-based ADS-B system implemented according to the teachings of this disclosure may meet the EUROCAE ED-129B and EUROCONTROL GEN SUR SPR specifications of providing a probability of update performance of greater than or equal to 95 percent within an 8-second time window. Additionally or alternatively, a space-based ADS-B system implemented according to the teachings of this disclosure may achieve availability of up to or greater than 99.9% availability and end-to-end latency from initial transmission of an ADS-B message by an aircraft to ultimate delivery of the ADS-B message to air traffic control or another destination of between 1-2 seconds.

### Intelligent Resource Management

As described above, implementing a space-based ADS-B system, such as, for example, system 100 illustrated in FIG. 1A or system 5 illustrated in FIG. 1B may present a number of challenges. For example, in certain implementations, individual satellites may have limited power budgets within which to operate. As such, the individual satellites (or ADS-B payloads hosted on the satellites) may benefit from intelligent resource management techniques. This section of the present disclosure describes specific examples of such intelligent resource management techniques. While the disclosed resource management techniques generally are described in the context of a space-based ADS-B system, the techniques may have broad application and can be employed in a variety of other different contexts. In some implementations, the disclosed techniques may be performed on a terrestrial computing platform (or similar resource) with resultant instructions thereafter being uploaded to individual satellites. Additionally or alternatively, in some implementations, satellites may perform the techniques disclosed herein themselves either individually or collectively.

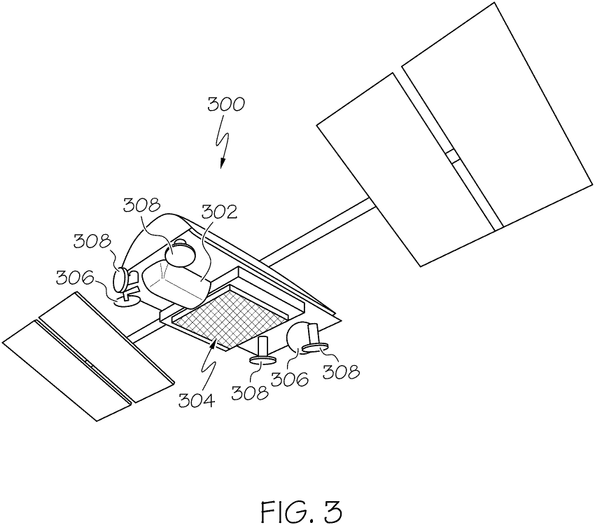

FIG. 4 illustrates a plurality of satellites 4102 providing coverage to a service area 4104 on Earth. The satellites 4102(1), 4102(2) and 4102(3) may be part of a constellation of satellites, which may comprise tens, hundreds or thousands of satellites depending, for example, on what service(s) are being provided by the constellation and/or the design of the constellation. It should be noted that although the singular word service occasionally may be used in the description herein, in some cases, multiple services may be provided by satellites according to the present disclosure, and, thus, the word service may represent a single service or a plurality of services. In some implementations, an individual satellite 4102 may have a single or primary payload configured to provide one or multiple services. For example, an individual satellite may have a primary payload configured to provide a space-based surveillance service. More particularly, an individual satellite may have a primary payload configured to provide a space-based ADS-B service, for example, by receiving ADS-B signals from aircraft equipped with ADS-B avionics transmitting ADS-B messages. In such implementations, the payload may be or include an ADS-B receiver. Alternatively, an individual satellite may have a primary payload configured to provide voice and/or data communication services to terrestrial subscribers. Additionally or alternatively, an individual satellite 102 may have multiple payloads, each of which is configured to provide one or more different services. For example, an individual satellite may have a primary payload configured to provide voice and/or data communication services to terrestrial subscribers and a secondary or hosted payload configured to provide a space-based surveillance service such as, but not limited to, a space-based ADS-B surveillance service for aircraft equipped with ADS-B avionics transmitting ADS-B signals. In such implementations, the secondary or hosted payload may be or include an ADS-B receiver.

In some implementations, the satellites 4102 may be part of a constellation of low Earth orbit (LEO) satellites (that may or may not be cross-linked to enable space-based communication between individual satellites within the constellation). In such implementations, the satellites 4102 may orbit the Earth at altitudes, for example, between 99 miles and 1,200 miles above the Earth’s surface and with orbital periods, for example, between 88 minutes and 127 minutes. The footprint covered by an individual satellite 4102 (or payload on board the satellite) may change as the satellite 4102 orbits.

In one particular example, the satellites 4102 may be arranged into a number of orbital planes (e.g., 6 orbital planes) with an equal (or different) number of satellites in each orbital plane (e.g., 11 satellites per orbital plane) and, furthermore, the satellites 4102 may be configured such that collectively the satellites (or payloads on board the satellites) are capable of providing coverage for the entire Earth or nearly the entire Earth. In this and other examples, the satellites 4102 may have polar or substantially polar orbits. As the satellites orbit, the footprints that the satellites 4102 (or payloads on board the satellites) cover may change. Nevertheless, the collective coverage area that the satellites 4102 (or payloads on board the satellites) can provide may remain the same or substantially the same over time (e.g., due to the coordinated arrangement and orbits of all of the satellites). Furthermore, in this example, individual satellites 4102 may include a primary payload configured to provide voice and/or data communication services to terrestrial subscribers and a secondary or hosted payload configured to provide a space-based ADS-B surveillance service. As such, satellites 4102 collectively may be capable of providing both a global (or nearly global) voice and/or data communications service and a global (or nearly global) space-based ADS-B surveillance service. In such implementations, the provisioning of the voice and/or data communications service may involve selecting a subset of the primary payloads to provide the communications service at different periods of time. Additionally or alternatively, the provisioning of the space-based ADS-B surveillance service may involve selecting a subset of the secondary payloads to provide the space-based ADS-B surveillance service at different periods of time.

The service area 4104 may be an area on the Earth’s surface and, in some cases, the space above such area on the Earth’s surface (e.g., in the case of a space-based ADS-B surveillance service for aircraft). In one implementation, the service area 4104 may be delineated into a plurality of unit or sub-areas. For example, the service area may be subdivided into multiple sub-areas of relatively similar area, which may be referred to as tiles. The size of a tile may be defined, for example, based on degrees of latitude and longitude, such as 1 degree latitude and 1 degree longitude, or any number of degrees (or a fraction of a degree) of latitude and any number of degrees (or a fraction of a degree) of longitude that are suitable for the service(s) being provided. In some implementations, the service area 4104 may include all of the Earth’s surface or substantially all of the Earth’s surface. In other implementations, the service area 4104 may include only a defined portion of the Earth or there may be multiple segregated service areas around the Earth.

As shown in FIG. 4, multiple satellites 4102 (or payloads on board the satellites) may provide coverage for the service area 4104 (or portions of the service area 4104). In some implementations, the footprints of multiple individual satellites 4102 (or payloads on board such satellites) may overlap at least during certain periods of time. In such cases, the region(s) where the satellites’ 4102 (or payloads’) footprints overlap may be covered by multiple satellites 4102 (or payloads) concurrently. The number of satellites (or payloads) providing coverage concurrently for one unit area (e.g., a tile) at a defined point in time or during a defined period of time may be referred to as the coverage number for the unit area at or during that time. Implementations of the present disclosure may attempt to provision satellite coverage for an individual unit area in an effort to ensure that the coverage number for the unit area at a defined point or during a defined period of time may be larger than or equal to a specific number required by the service to be provided for the unit area at or during the defined time, which may be referred to as the required coverage number for the unit area at or during the defined time. The required coverage number for a unit area at or during a defined time may be one but may also be a number larger than one. For example, for air traffic control or surveillance, the required coverage number for a particular unit area at or during a defined time may be one specific number (e.g., equal to or larger than one); for weather forecasting, the required coverage number may be another specific number (e.g., equal to or larger than one). Moreover, the service area 4104 may be a representative for a plurality of service areas that need to be covered by the satellites 4102(1), 4102(2) and 4102(3) (or payloads on board the satellites).

In addition to service areas, in certain implementations, there may be one or more areas defined as empty areas and one or more areas defined as nuisance areas on Earth. In such implementations, empty areas may not require coverage but they may be covered with an expectation that there will be substantially no negative effects for covering them. Nuisance areas, meanwhile, similarly may not require coverage and they may have noise sources such that covering them may lower the signal to noise ratio for signals from the service areas received by the satellite(s) 4102 (or payload(s)) covering such nuisance areas.

In some implementations, a tile may be referred to as being critically covered if two conditions are true: there are satellites 4102 (or payloads on board such satellites)) providing coverage for the tile, and the number of satellites 4102 (or payloads on board such satellites) covering the tile is equal to the required coverage number. In such cases, if a satellite 4102 (or payload on board the satellite) providing critical coverage of a tile is switched off (e.g., so as to not provide service), the coverage requirement will not be satisfied.

In some implementations, the satellites 4102 (or payloads on board the satellites) may be at least partially solar powered. In such implementations, each satellite 4102 may have one or more solar panels that collect solar energy when exposed to the Sun. The solar panel(s) may convert the solar energy into electrical energy to support operation of the respective satellites (or payloads on board the satellites). In some implementations, the satellites 4102 may include batteries that are capable of storing electrical energy generated by the solar panel(s) for later use by the satellites 4102. As illustrated in FIG. 4, as a satellite 4102(2) orbits the Earth, there may be periods of time during which the satellite 4102(2) may be in a shadow of the Earth and, thus, not in a direct line of sight of the Sun. During such periods, the satellite 4102(2) may be referred to as being in eclipse. When a satellite 4102 is in eclipse, the solar panels may not generate any electrical energy (e.g., because the eclipse condition prevents the solar panels from receiving solar energy) and the satellite’s 4102 operation may be solely (or largely) supported by battery or some other alternative energy source and this situation may be taken into consideration as described herein.

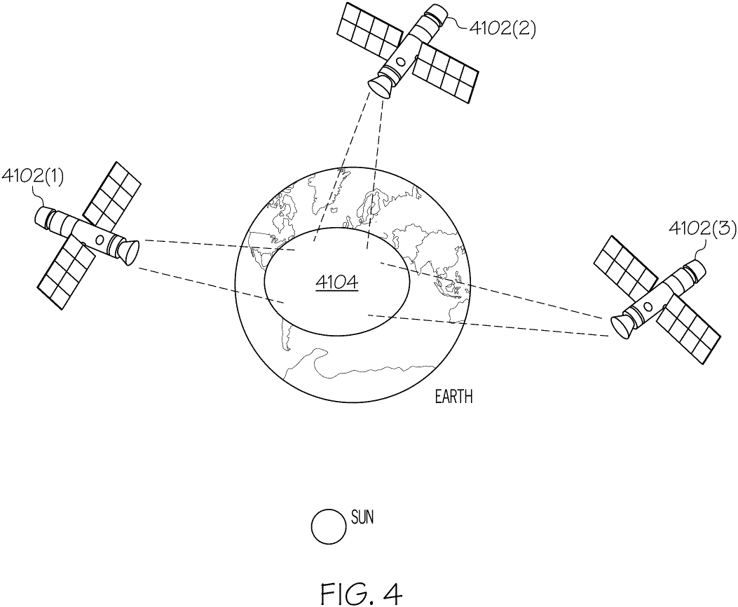

FIG. 5 illustrates an exemplary system configuration 5200 according to an implementation of the present disclosure. As shown in FIG. 5, the system 5200 may comprise a constellation of satellites 4102 (e.g., 4102(1), 4102(2), ..., 4102(n), with n being an integer number equal to or larger than three), a satellite information repository 5202 and a computing apparatus 5204. The satellite information repository 5202 may be implemented as computer (or some other form of electronic) storage and may store and/or model information related to the satellites 4102 including operational modes, power consumption levels, and ephemeris data (e.g., including orbit and eclipse information) for some or all of the satellites 4102 (or payloads on board some or all of the satellites 4102) in the constellation. Although shown as separate entities in FIG. 5, the satellite information repository 5202 may be part of the computing apparatus 5204 in some implementations. Moreover, in some implementations, the satellite information repository 5202 may comprise distributed storage such that portions of the information stored therein may be stored across multiple devices, which may be located geographically close (e.g., in the same room or in different buildings of the same campus) or remote (e.g., in different cities, counties, states, continents, etc.). Regardless of whether the satellite information repository 5202 is part of the computing apparatus 5204, either or both of the satellite information repository 5202 and the computing apparatus 5204 may be communicatively connected (e.g., either directly or indirectly) to each of the satellites 4102; therefore, the computing apparatus 5204 may remotely control the satellites 4102 (or payloads on board the satellites 4102) for provisioning of the satellite service. For example, in some implementations, computing apparatus 5204 may represent (separately from or together with satellite information repository 5202) a telemetry, tracking and command (TTAC) ground system. In alternative implementations, satellite information repository 5202 and computing apparatus 5204 may be hosted on or distributed across one or more of satellites 4102 such that the provisioning of the satellite service may be wholly or partially controlled by the one or more satellites 4102 (or payloads on board the one or more satellites 4102). As described in greater detail below, computing apparatus 5204 may determine which of several different operational modes each of the satellites 4102 (or payloads on board the satellites) should operate in during different periods of time and transmit instructions to individual satellites 4102 (or payloads on the individual satellites) instructing the satellites (or payloads) to enter the determined operational modes for the appropriate time periods.

In one particular example, computing apparatus 5204 (separately from or together with satellite information repository 5202) may represent or be communicatively coupled to a ground station that establishes wireless communications links (e.g., uplinks and/or downlinks) 5206 with one or more of satellites 4102, for instance via electromagnetic signals (e.g., in the K or Kₐ band). In this example, as the satellites 4102 orbit, individual satellites 4102 may go in and out of view of the ground station. Therefore, the ground station may dynamically establish and relinquish communications links 5206 with individual satellites 4102 as the satellites 4102 go in and out of view of the ground station. When a communications link 5206 exists between an individual satellite 4102 and the ground station, the ground station may transmit control information to the satellite 4102 via the communications link 5206 for use in provisioning the service. In some cases, such control information may be specific to the individual satellite 4102 (or a payload on board the individual satellite 4102). In other cases, wireless crosslinks 5208 (e.g., in the K or Kₐ band) may communicatively connect individual satellites 4102 to each other, and the control information transmitted to a satellite 4102 by the ground station may be propagated to one or more or all of the other satellites 4102 via the crosslinks 5208 for use in provisioning the service.

In one implementation, all satellites 4102 (or individual payloads on board all of the satellites 4102) in the constellation may be configured to operate within the same set of different modes having the same average (or estimated) power consumption levels as indicated in Table 1 below.

TABLE 1

Power Levels

| | |
|---|---|
| Mode | Average Power Consumption (in watts “W”) |
| High On | AA |
| Medium On | BB |
| Low On | CC |
| High Idle | XX |
| Low Idle | YY |

In such an implementation, each satellite 4102 (or an individual payload on board each satellite 4102) may comprise multiple service providing elements. For example, in implementations that provide a surveillance service (e.g., a spaced-based ADS-B surveillance service), the service providing elements may be antennas and/or receivers for receiving ADS-B signals. Additionally or alternatively, the service providing elements may be antennas and/or transmitters or transceivers that are capable of transmitting signals. When a satellite 4102 (or individual payload on board a satellite 4102) is operated in the “High On” mode, all (or a relatively large number) of the service providing elements on the satellite 4102 (or payload on board the satellite 4102) may be turned on to provide the coverage and, collectively, these elements may consume power at the average (or estimated) rate of AA W and provide a relatively high level of coverage within the footprint of the satellite (or payload on board the satellite). For example, when operating in the “High On” mode, the satellite (or the payload on board the satellite), may provide a relatively large number of receive and/or transmit beams within the footprint of the satellite (or the payload on the satellite). Consequently, the satellite (or the payload on board the satellite) may provide coverage to a relatively large number of tiles within the footprint of the satellite (or payload on board the satellite) when operating in the “High On” mode.

When a satellite 4102 (or individual payload on board a satellite 4102) is operated in the “Medium On” mode, a subset of the service providing elements on the satellite 4102 (or payload on board the satellite 4102) that is less than the service providing elements turned on during the “High On” mode may be turned on to provide the coverage and, collectively, these elements may consume power at the average (or estimated) rate of BB W, which is less than the rate of AA W, and provide a relatively moderate level of coverage within the footprint of the satellite (or payload on board the satellite) that is less than the level of coverage when the satellite (or payload on board the satellite) is operated in the “High On” mode. For example, when operating in the “Medium On” mode, the satellite (or the payload on board the satellite), may provide a relatively moderate number of receive and/or transmit beams within the footprint of the satellite (or the payload on the satellite) that is less than the number of beams that the satellite (or payload on board the satellite) provides when operating in the “High On” mode. Consequently, the satellite (or the payload on board the satellite) may provide coverage to a relatively moderate number of tiles within the footprint of the satellite (or payload on board the satellite) that is less than the number of tiles covered when operating in the “High On” mode.

When a satellite 4102 (or individual payload on board a satellite 4102) is operated in the “Low On” mode, a subset of the service providing elements on the satellite 4102 (or payload on board the satellite 4102) that is less than the service providing elements turned on during the “Medium On” mode may be turned on to provide the coverage and these elements, collectively, may consume power at an average (or estimated) rate of CC W, which is less than the rate of BB W and provide a relatively low level of coverage within the footprint of the satellite (or payload on board the satellite) that is less than the level of coverage when the satellite (or payload on board the satellite) is operated in the “Medium On” mode. For example, when operating in the “Low On” mode, the satellite (or the payload on board the satellite), may provide a relatively low number of receive and/or transmit beams within the footprint of the satellite (or the payload on the satellite) that is less than the number of beams that the satellite (or payload on board the satellite) provides when operating in the “Medium On” mode. Consequently, the satellite (or the payload on board the satellite) may provide coverage to a relatively low number of tiles within the footprint of the satellite (or payload on board the satellite) that is less than the number of tiles covered when operating in the “Medium On” mode.

When operated in one of the above-described “On” modes, a satellite 4102 (or payload on board the satellite 4102) may be referred to as being in a “functioning” mode (e.g., because the satellite 4102 (or payload) is capable of providing service).

When a satellite 4102 (or individual payload on board a satellite 4102) is operated in the “High Idle” mode, all of the service providing elements may be turned off and the satellite 4102 (or payload), thus, may provide no coverage. Nevertheless, while the satellite 4102 (or payload) is operated in the “High Idle” mode, other circuitry and/or components on board the satellite 4102 (or payload) may still be on and consuming energy at the average (or estimated) rate of XX W, which is less than the rate of CC W. For example, in some implementations, one or more Field Programmable Gate Arrays (FPGAs) may be on board a satellite 4102 (or payload) (e.g., to provide signal processing functions). In such implementations, one or more FPGAs may remain powered on while the satellite 4102 (or payload) is operated in the “High Idle” mode such that the FPGA(s) consumes power at an average (or estimated) rate of XX W. The “High Idle” mode may be referred to as a reduced power mode.

When a satellite 4102 (or individual payload on board a satellite 4102) is operated in the “Low Idle” mode, all of the service providing elements and a significant amount of other circuitry and/or components (e.g., FPGAs) may be turned off. In this mode, the satellite 4102 (or payload) may consume power at an average (or estimated) rate of YY W, which is less than XX W, for instance, to keep the system critical circuitry and/or componentry on, such as, for example, the system timer, hardware setting, etc. In some implementations, the “Low Idle” mode may be the “off” mode but with the system critical circuitry on, such that the satellite may be remotely turned on. When operated in the “High Idle” mode or the “Low Idle” mode, a satellite 4102 (or payload on board the satellite 4102) may be referred to as being in a “non-functioning” mode (e.g., because the satellite 4102 (or payload) is not capable of providing service).

In another implementation, the satellites 4102 (or individual payloads on board of the satellites 4102) in the constellation may not necessarily be configured to operate within the same set of different modes having the same average (or estimated) power consumption levels. For example, a first subset of the satellites 4102 (or payloads on board the first subset of satellites 4102) in the constellation may be configured to operate in the modes depicted in Table 1, but another subset of the satellites 4102 (or payloads on board the second subset of satellites 4102) in the constellation may be configured to operate in three modes: “On” with an average (or estimated) power consumption rate of AA1 W; “High Idle” with an average (or estimated) power consumption rate of XX1 W, which is less than a rate of AA1 W; and “Idle” or “Off′ with an average (or estimated) power consumption rate of YY1 W, which is less than a rate of XX1 W.

Regardless of whether the satellites 4102 (or individual payloads on board the satellites 102) in the constellation are configured to operate in the same modes, the satellite information repository 5202 may store power consumption information for the different operational modes of all satellites 4102 (or payloads on board the satellites 4102) in the constellation. Each symbol referenced above in connection with power consumption levels, e.g., “AA,” “BB,” “CC,” “XX,” “YY,” “AA1,” “XX1,” and “YY1,” may represent a numerical value of a power consumption rate, which, for example, may be obtained by circuit design data or as empirical data among other approaches. It should be appreciated that at least one or more satellites (or payloads or board such satellites) in one implementation may have two “on” modes or more than three “on” modes and the respective power consumption level for each “on” mode may be used for the satellite (or payload) coverage provisioning process accordingly.

The computing apparatus 5204 may provision the satellite coverage based on the information in the satellite information repository 5202 and/or other information. In provisioning the satellite coverage, certain constraints (or other factors) may be taken into account. For example, a first time-related constraint may be that the total power consumption by an individual satellite 4102 (or payload on board the individual satellite 4102) during a defined sliding time window of length T_{w} be less than some first defined maximum amount, and a second time-related constraint may be that the total power consumption by the satellite (or payload on board the satellite) during an eclipse period be less than some second defined maximum amount. In some implementations, the sliding window of time (T_{w}) may be the same duration as the satellite orbit period (e.g., ~5 minutes for a satellite at an 800 km altitude). In one implementation, the computing apparatus 204 may provision the satellite coverage according to a greedy algorithm that seeks to minimize the power consumption for each individual satellite 4102 (or a payload on board each individual satellite) rather than focusing on the total power consumption of the satellites 4102 (or payloads on board the satellites) in the constellation in the aggregate.

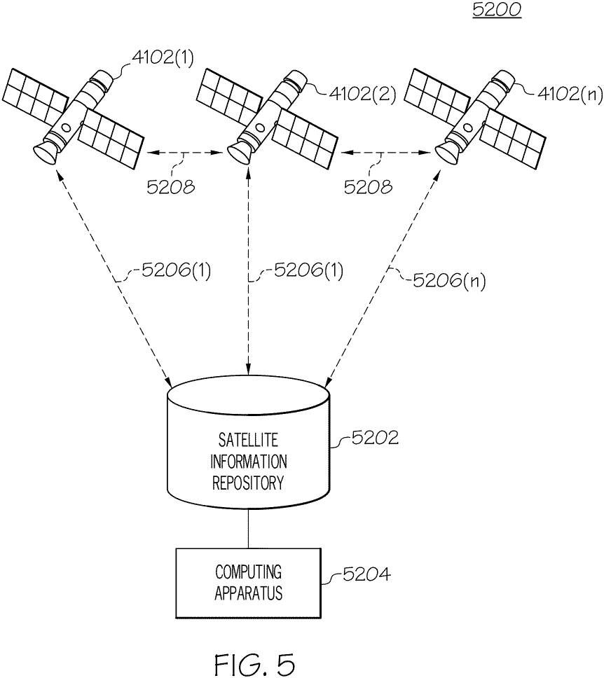

Additionally or alternatively, irrespective of other factors, the computing apparatus 5204 may determine to turn an individual satellite 4102 (or payload on board the individual satellite 102) off (e.g., put it into a “High Idle” or “Low Idle” mode) in response to determining (i) that the total cumulative power consumption by the satellite (or payload on board the satellite) at any point during a defined time period (e.g., T_{w}) will or has exceeded a defined power consumption threshold level or (ii) the total cumulative power consumption by the satellite 4102 (or payload on board the satellite 4102) during an eclipse period will or has exceeded a defined eclipse period power consumption threshold level. An example of how an individual satellite (or payload on board a satellite) may be powered on and off (e.g., switched between a functional mode and a non-functional mode) according to a power consumption constraint is shown in FIG. 6, which illustrates a hysteresis for cumulative power consumption during a sliding window of time (e.g., T_{w}) for a satellite (or payload on board the satellite) according to an implementation. As shown in FIG. 6, a cumulative power consumption curve 6302 may represent the (actual or projected) cumulative power consumption for one satellite (or a payload on board the satellite) over sliding window period T_{w}. Two cumulative power consumption threshold values may be defined: Q_{off} and Qₒₙ. The threshold values Q_{off} and Qₒₙ may not be absolute values; instead, they may represent threshold values within a sliding time window of the length T_{w}. The threshold Q_{off} may designate a cumulative power consumption value during the period T_{w} that, if reached (or projected to be reached) by the satellite (or payload on board the satellite) causes the satellite (or payload on board the satellite) to be turned off, e.g., transitioning the satellite (or payload on board the satellite) into the “High Idle” or “Low Idle” mode. In some implementations, the power consumption in the “High Idle” mode may be too large to give any benefit when and if an emergency hits. Therefore, in these implementations, the satellite (or payload on board the satellite) may be transitioned to the “Low Idle” mode when Q_{off} is exceeded (or projected to be exceeded) during T_{w}, and the “Low Idle” mode may be referred to as an “emergency mode” or “minimal energy consumption” mode. In the case where a satellite (or payload on board the satellite) has been placed in a lower power mode such as an “emergency mode,” the satellite (or payload on board the satellite) can be restored to a higher power mode (e.g., one of the “High On,” “Medium On,” “Low On,” or “High Idle” modes) in response to the cumulative power consumption within the sliding time window falling (or projected to fall) to a cumulative power consumption threshold Qₒₙ that is less than the cumulative power consumption threshold Q_{off}. It should be appreciated that FIG. 6 shows an example of a situation in which a satellite (or payload on board a satellite) turns on, keeps consuming power until its cumulative power consumption within a sliding window of time hits Q_{off} and is turned off (or turned to a reduced power consumption mode), but, after some time, its cumulative power consumption during the sliding window of time goes down and falls to Qₒₙ and is turned on again (or returned to a higher power consumption mode) in response. In various scenarios, however, the (actual or projected) cumulative power consumption curve of a satellite (or a payload on the satellite) may go up and down between the two threshold values Q_{off} and Qₒₙ over time without necessarily reaching either threshold value.

Having two cumulative power consumption threshold values Q_{off} and Qₒₙ, respectively, essentially provides hysteresis that prevents the satellite (or payload on board the satellite) from frequently toggling between higher and lower power consumption modes. For example, if a satellite (or payload on board a satellite) is in a higher power consumption mode over a significant period of time, it is possible the cumulative power consumed within the sliding time window at some point may exceed (or be projected to exceed) the threshold Q_{off}, causing the satellite (or payload on board the satellite) to enter a lower power consumption mode. Once in the lower power consumption mode, the cumulative power consumed during the sliding time window may diminish below the cumulative power consumption threshold Q_{off}, but the satellite (or payload on board the satellite) may not be restored to a higher power consumption mode until the cumulative power consumed (or projected to be consumed) during the sliding time window diminishes to the lower cumulative power consumption threshold Qₒₙ. Thereafter, the satellite (or payload on board the satellite) may then remain in the higher power consumption mode until the cumulative power consumed (or projected to be consumed) during the sliding time window again exceeds (or is projected to exceed) the higher cumulative power consumption threshold Q_{off}.

In some implementations, the hysteresis for cumulative power consumption shown in FIG. 6 may not be employed when a satellite is in an eclipse period. In one implementation, if a satellite (or payload on board the satellite) is put into an emergency mode during an eclipse period, the satellite (or the payload on board the satellite) may be retained in the emergency mode until the eclipse period ends.

In an effort to keep the power consumption of an individual satellite (or payload on board the satellite) as low as possible, the computing apparatus 5204 may implement features as follows:
1) Keep track of the cumulative power consumption (e.g., actual or projected) in a current sliding time window (the cumulative eclipse power consumption may be tracked separately) and turn the satellite (or payload on board the satellite) to the “Low Idle” mode in response to detecting that the satellite (or the payload on board the satellite) has hit (or is projected to hit) its emergency threshold.
2) While the satellite (or payload on board the satellite) is operating in an operational mode, aggressively try to switch the satellite (or payload on board the satellite) to a lower power consumption mode (e.g., the “High Idle” mode) whenever the satellite (or payload on board the satellite) does not provide critical coverage to any tile within its footprint (or any tiles expected to be within its footprint during a defined period of time)., For example, if all of the tiles within the satellite’s (or payload’s) footprint (or expected to be within its footprint during a defined period of time) are more than critically covered, the satellite(s) (or payload(s) on board the satellite(s)) with larger cumulative power consumption (or projected power consumption) and/or eclipse power consumption may be switched to the “High Idle” mode.
3) After the satellite (or the payload on board the satellite) has operated in the “High Idle” mode for a defined period of time, switch the satellite (or payload on board the satellite) to the “Low Idle” mode.

Additionally or alternatively, in some implementations, a periodic or aperiodic reboot of the satellite (or the payload on board the satellite) may be planned as part of the satellite (or payload) provisioning process. This may be provided, for example, to satisfy a satellite (or payload) requirement, which may require a reboot at least once per orbit period (e.g., to support thermal dissipation). In some implementations, the reboot may be performed when the satellite is in a non-functional mode. In at least one implementation, the provisioning process may define a maximal waiting time for the satellite (or payload on board the satellite) since the last time the satellite (or payload on board the satellite) was operated in a non-functional mode (T_{wait}), and switch the satellite (or payload on board the satellite) to a non-functional mode at least once after (or during) such maximal waiting time.

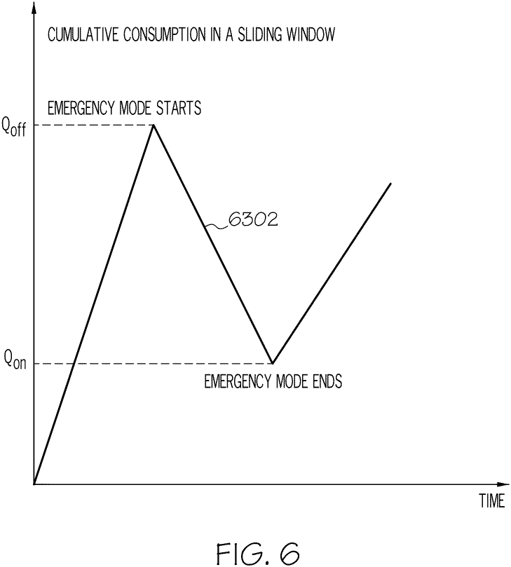

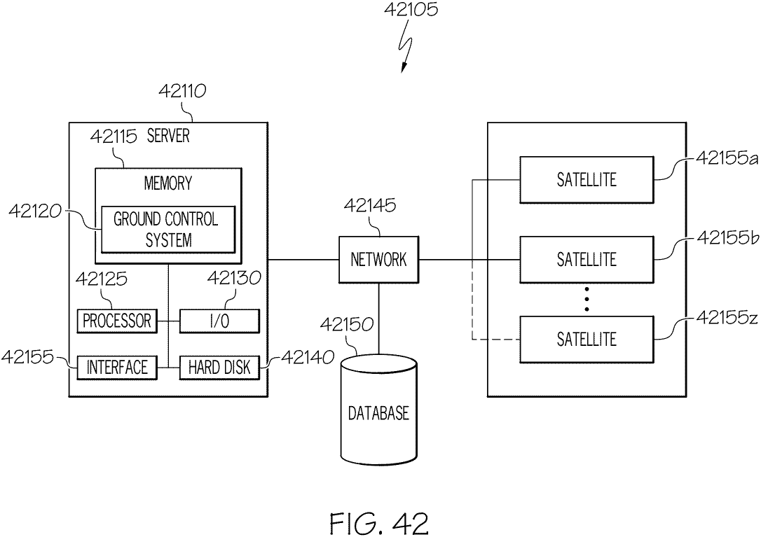

FIG. 7 illustrates a flow diagram of an exemplary satellite coverage provisioning process 7400 according to an implementation of the present disclosure. In some implementations, the process may be performed by or in conjunction with a computing apparatus such as, for example, computing apparatus 5204 of FIG. 5 (or ground control system 42120 implemented on computing platform 42110 as illustrated in FIG. 42) and/or a computing apparatus on board a satellite. The satellite coverage provisioning process 7400 may start at block 7402, at which power consumption states for satellites (or payloads on board the satellites) within a constellation of satellites may be updated. In some implementations, information about the power consumption states of the satellites (or payloads on board the satellites) may be stored in a satellite information repository, such as, for example, satellite information repository 5202. The power consumption state of each satellite (or a payload on the satellite) may include without limitation the satellite’s (or payload’s) current power consumption information, historical power level information (e.g., cumulative power consumption during a sliding window of time), current operational mode, and/or projected future power consumption.

At block 5404, whether each satellite (or a payload on each satellite) of the constellation of satellites is required to be in a minimal energy consumption mode (e.g., the “Low Idle” mode) may be determined, for example, based on the updated power consumption state of the satellite (or the payload on board the satellite) and/or other factors. For example, it may be determined whether the cumulative power consumption of the satellite (or a payload on board the satellite) during a sliding window of time exceeds a first threshold value and/or whether the cumulative power consumption of the satellite (or a payload on the satellite) during an eclipse period exceeds a second threshold value. In some implementations, this determination may be based, at least in part, on projected future power consumption. For example, if the projected future power consumption of the satellite (or a payload on board the satellite) during a defined future time period suggests that the cumulative power consumption of the satellite (or payload on board the satellite) during a sliding window of time that includes at least a portion of the defined future time period will exceed a defined threshold value, a determination may be made that the satellite (or payload on board the satellite) is required to be in a minimal energy consumption mode. Each satellite (or payload on board the satellite) determined to be required to be in a minimal energy consumption mode then may be controlled to be transitioned to the minimal energy consumption mode. For example, a signal may be sent to the satellite (or the payload on the satellite) instructing the satellite to transition to the minimal energy consumption mode.

At block 7406, for each satellite of the constellation of satellites (or a payload on each satellite of the constellation of satellites) that is not required to be in the minimal power consumption mode, a power consumption score may be calculated. The power consumption score may be a numerical value representing how close the satellite’s (or payload’s) cumulative power consumption in a sliding time window is to a limit (e.g., the maximal allowable power consumption during the sliding time window). In some implementations, the power consumption score for a satellite (or payload on board the satellite) may be based on historic power consumption by the satellite (or payload on board the satellite). Additionally or alternatively, in some implementations, the power consumption score for a satellite (or payload on board the satellite) may be based, at least in part, on projected future power consumption by the satellite (or payload on board the satellite). In one implementation, a satellite (or a payload on board the satellite) having a higher power consumption score may be closer to the maximal allowable cumulative power consumption threshold than a satellite (or payload on board the satellite) having a lower power consumption score. As described herein, in some implementations, the power consumption score may be calculated by taking into consideration whether the satellite (or payload on board the satellite) is in an eclipse period. Moreover, in some implementations, inputs used in calculating the power consumption score for a satellite (or a payload on board the satellite) may be retrieved from a satellite information repository, such as, for example, satellite information repository 5202 of FIG. 5.

At block 7408, the satellites (or payloads on the satellites) that are not required to be in the minimal power consumption mode may be sorted according to their respective power consumption scores. At block 7410, the satellite coverage provisioning process 7400 may determine, based on respective power consumption scores of the satellites (or payloads on the satellites) and coverage of the service area, whether each of the satellites (or payloads on board the satellites) that are not required to be in the minimal power consumption mode can be put into a reduced power mode (e.g., the “High Idle” mode). For example, in some implementations, starting with the satellite (or payload on the satellite) closest to the maximal power consumption threshold, a determination may be made, based on the current operational modes of the satellites in the constellation and other information stored in the satellite information repository 5202 (e.g., satellite (or payload) ephemeris), as to whether all of the tiles in the footprint of the satellite (or payload on board the satellite) (or expected to be within the footprint of the satellite (or payload on board the satellite) within a defined period of time) requiring coverage are (or will be) critically covered or more than critically covered. If the result is affirmative and transitioning the satellite (or payload on board the satellite) to a reduced power mode will not result in any of the tiles requiring coverage dropping below a critical coverage level, it may be determined to transition the satellite (or payload on board the satellite) to a reduced power mode. This determination thereafter may be repeated in order for each of the satellites (or payloads on board the satellites) in the sorted list. As described above, in some implementations, the satellites (or payloads on board the satellites) may be configured to operate in one of multiple different functional modes (e.g., “High On,” “Medium On,” and “Low On”). In such implementations, a particular functional mode for each satellite (or payload on board the satellite) not determined to be switched into the reduced power mode may be determined, for instance, based on the consumption score and coverage of the service areas. For example, a higher power consumption mode may be selected for a satellite (or payload on board the satellite) when the power consumption score is relatively low and/or the required coverage of the service area is relatively high than when the power consumption score is relatively high and/or the required coverage of the service area is relatively low.

At block 7412, whether each satellite (or payload on board the satellite) of the constellation of satellites that is in a reduced power mode (e.g., the “High Idle” mode) can be put into a minimal energy consumption (e.g., the “Low Idle” mode) mode may be determined. In some implementations, it may be determined that a satellite (or payload on board the satellite) can be put into the minimal energy consumption mode after the satellite (or payload on board the satellite) has been assigned to the reduced power mode for some defined number of consecutive schedule slots. The satellites (or payloads on the satellites) for which determinations were made to transition to different operating modes (e.g., into the “High Idle” or “Low Idle” modes) then may be instructed to be transitioned to the appropriate operating modes. For example, signals may be sent to each satellite (or the payload on the satellite) instructing the satellite to transition to the appropriate operating mode. Additionally or alternatively, in some implementations, process 7400 may be performed in advance in order to generate a provisioning schedule for each satellite that then is uploaded to each satellite, for example, via uplinks 5206. For example, future provisioning schedules for each satellite may be generated more than twenty-four hours (or more) out. These provisioning schedules (or portions of these provisioning schedules) then may be uploaded to each satellite. In some implementations, each schedule slot (e.g., possible new operational state) may be 30 seconds, and new provisioning schedules may be uploaded to the satellites every 120 seconds (or, in some implementations, more or less frequently). Each individual satellite then may adjust its operating mode in accordance with the appropriate provisioning schedule.

An exemplary satellite coverage provisioning process according to the present disclosure may implement a greedy algorithm that seeks to minimize power consumption of individual satellites (or payloads on individual satellites) instead of global power consumption across the constellation in the aggregate. In one implementation, the greedy algorithm may be implemented as a repeating loop with an incremental time step Δtₛ. This incremental time step Δtₛ and examples of a number of other configuration parameters, which may be stored, for example, in satellite information repository 5202 or otherwise accessible by computing apparatus 5204, are listed in Table 2 below.

TABLE 2

Exemplary Configuration Parameters for Satellite Coverage Provisioning

| | |
|---|---|
| Parameter | Description |
| Δtₛ | Calculation incremental time step |
| P_{High} | Power consumption level in “High On” mode |
| P_{Medium} | Power consumption level in “Medium On” mode |
| P_{Low} | Power consumption level in “Low On” mode |
| Pₐᵥₑᵣ | Average power consumption level when not in “High Idle” or “Low Idle” mode |
| P_{high.idle} | Power consumption level in “High Idle” mode |
| P_{idle} | Power consumption level in “Low Idle” mode |
| T_{w} | Sliding window of time from (t - T_{w}) to t, where t is the current time (the time being scheduled). |
| Q_{off} | Emergency threshold for cumulative power consumption in T_{w} |
| Qₒₙ | Cumulative power consumption in T_{w} threshold for coming out of the emergency mode, Qₒₙ < Q_{off} |
| Q_{max.eclipse} | Emergency cumulative power consumption threshold during eclipse period |
| T_{idle} | Minimum time satellite (or payload on satellite) remains in “Low Idle” mode after transitioning into “Low Idle”, in minutes |
| T_{wait} | Minimum time since satellite (or payload on satellite) was last in “Low Idle” mode before satellite (or payload on satellite) can return to “Low Idle” mode, in minutes |
| T_{reboot} | Maximal waiting time since the last reboot, in minutes |
| α | Weighting parameter for scoring power consumption during an eclipse period |

Most parameters in Table 2 have been explained above and/or will be explained in detail below. The quantities measured in Watts may be denoted as P with a respective subscript and the quantities measured in Watt-minutes as Q with a respective subscript.

As described above, in some implementations, service requirements may dictate a reboot (e.g., of the satellite, a payload on board the satellite, and/or certain componentry on board the satellite or on a payload) at least once per orbit (e.g., to support thermal dissipation). Thermal dissipation may be particularly applicable for FPGAs and other electronics in space due to accumulation of cosmic radiation and its impact on gate logic and signal processing while in operation. Thus, in addition to the other features already explained above, at least one reboot of the satellite (or payload on board the satellite) per orbit may be planned as part of the satellite coverage provisioning process. As indicated by the parameter T_{reboot} in Table 2, the maximal waiting time since the last reboot may be defined. In some implementations, the reboot may be done whenever the satellite (or payload on board the satellite) is in the “Low Idle” (or “High Idle”) mode (e.g., upon the satellite (or payload on board the satellite) transitioning into the “Low Idle” (or “High Idle”) mode). In at least one implementation, the satellite coverage provisioning process may define a maximal waiting time since the last “Low Idle” (or “High Idle”) mode (T_{reboot}), and reboot a satellite (or payload on board the satellite) at least once after (or during) such maximal waiting time. In other words, if the configured time period T_{reboot} elapses without the satellite (or payload on board the satellite) having been rebooted, the satellite coverage provisioning process may cause the satellite (or payload on board the satellite) to enter the “Low Idle” (or “High Idle”) mode and reboot. Alternatively, in some implementations, if the configured time period T_{reboot} elapses without the satellite (or payload on board the satellite) having been rebooted, the satellite coverage provisioning process may schedule the satellite (or payload on board the satellite) to enter the “Low Idle” (or “High Idle”) mode and reboot at the next opportunity determined to be convenient to do so.

In addition to the configuration parameters listed in Table 2, examples of information about the current and previous states of the satellites (or payloads on board the satellites) and other information potentially relevant to the satellite coverage provisioning, which may be stored, for example, in satellite information repository 5202 or otherwise accessible by computing apparatus 5204, are listed in Table 3 below.

TABLE 3

Exemplary Information Stored Per Satellite (or Payload On Board Satellite) for Satellite Coverage Provisioning Process

| | |
|---|---|
| Parameter | Description |
| Qₜₒₜₐₗ | Cumulative power consumption during the sliding window, initialized to zero |
| Cᵢ | Array of power consumption data with T_{W}/Δtₛ entries, C₀ corresponds to the most recent step, C₁ to the previous one etc. Initialized to zero. |
| Q_{eclipse} | Cumulative power consumption since beginning of an eclipse period, initialized to zero |
| EMERGENCY | Flag whether the satellite is in the emergency mode. |
| ECLIPSE | Flag whether the satellite is in an eclipse period. It may be set externally based on the ephemerides |
| t_{eclipse.left} | If the satellite is in an eclipse period, the time until the end of the current eclipse period, otherwise undefined. |
| M | Current operational mode |
| Mₚ | Previous operational mode |
| tₒₙ | Last time satellite (or payload on board satellite) came off a “High Idle” operational mode, in minutes |
| S | Power consumption score |

The quantities related to power in Table 3 may be measured in either Watt-minutes or average Watts, as long as the choice is the same for the actual consumption and the threshold values.

As described above, power consumption scores (denoted as S in Table 3) may be calculated for individual satellites (or payloads on board the satellites). In one implementation, when a satellite (or payload on board the satellite) is not in an eclipse period, the power consumption score for the satellite (or payload on board the satellite) may be calculated as a ratio of the cumulative power consumption Qₜₒₜₐₗ in the sliding window (T_{w}) to the maximal (e.g., emergency) energy consumption threshold Q_{off}.

$$S = {Q}_{t o t a l} / {Q}_{o f f}$$

In some implementations, when a satellite (or payload on board the satellite) is in an eclipse period, its cumulative power consumption until the end of the eclipse period is desired to be less than a maximal defined value during the eclipse period, which may be the configuration parameter “Emergency cumulative power consumption threshold during eclipse period” denoted as Q_{max.eclipse} in Table 2. If the satellite (or payload on board the satellite) remains in one of the “on” modes until the end of the eclipse period, its cumulative power consumption during the eclipse period may be equal to the cumulative power consumption since the beginning of the eclipse period (e.g., Q_{eclipse} in Table 3) plus future spending (e.g., t_{eclipse.left} multiplied by a power consumption rate P, where t_{eclipse.left} has been defined in Table 3 and P may be one of P_{High}, P_{Medium}, or P_{Low} as defined in Table 2). The time t_{eclipse.left} may be calculated based on the satellite’s orbit, travel scheduling information and the Sun’s position, any or all of which, for example, may be stored in satellite information repository 5202 or otherwise available to computing apparatus 5204. In one implementation, the average energy consumption Pₐᵥₑᵣ may be used for P. A power deficiency variable Q_{deficiency} may be calculated as:

$${Q}_{d e f i c i e n c y} = \left({Q}_{e c l i p s e} + {t}_{e c l i p s e . l e f t} P\right) - {Q}_{m a x . e c l i p s e}$$

As for calculating the power consumption score of a satellite (or a payload on board the satellite) in an eclipse period, a ratio of this deficiency to Q_{max.eclipse} may be calculated as:

$${S}_{e c l i p s e} = \left\{\begin{matrix}0 , & {Q}_{d e f i c i e n c y} \leq 0 \\ {Q}_{d e f i c i e n c y} / {Q}_{m a x . e c l i p s e} , & {Q}_{d e f i c i e n c y} > 0\end{matrix}\right)$$

Then the power consumption score for the satellite (or a payload on board the satellite) with eclipse adjustment may be calculated as:

$$S = \left\{\begin{matrix}{S}_{n o r m a l} , & \text{Not} \text{in} \text{eclipse} \\ {S}_{n o r m a l} + α {S}_{e c l i p s e} , & \text{In} \text{eclipse}\end{matrix}\right)$$

The parameter α in the equation (4) may represent the importance of the eclipse constraint. For example, by increasing the parameter α, the exemplary satellite coverage provisioning process may be more aggressive in switching off satellites (or payloads on board the satellites) in eclipse periods. In some implementations, the parameter α may be determined based on simulation. In one non-limiting implementation, the parameter α may be selected as α ≈ 0.1. Other values for α may also be used in different implementations.

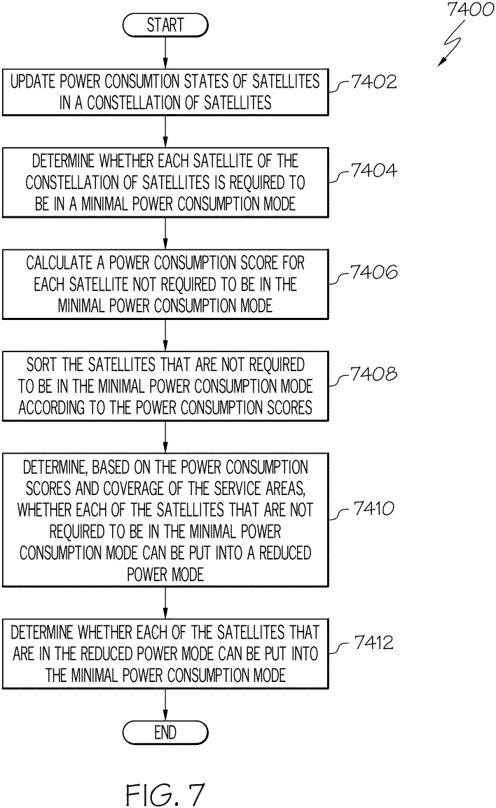

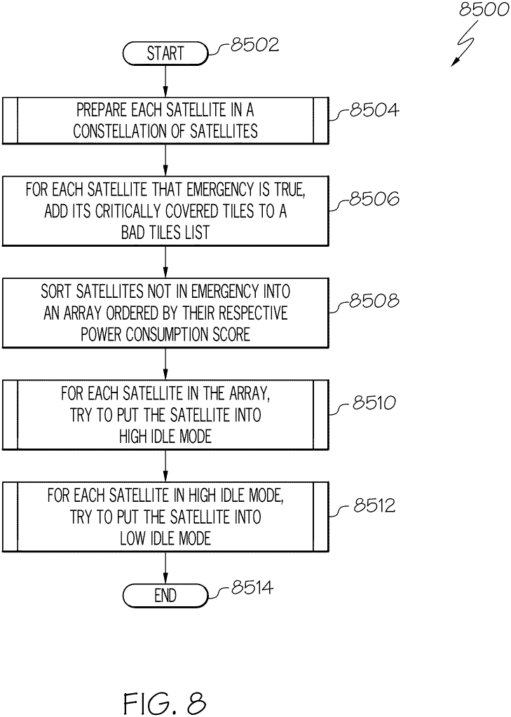

FIG. 8 illustrates an exemplary iteration 8500 of a loop for satellite coverage provisioning using a constellation of satellites (or payloads on board a constellation of satellites). In some implementations, the iteration 8500 may be performed by or in conjunction with a computing apparatus such as, for example, computing apparatus 5204 of FIG. 5 (or ground control system 42120 implemented on computing platform 42110 as illustrated in FIG. 42) and/or a computing apparatus on board a satellite. The iteration 8500 may be performed for each satellite (or a payload on board each satellite) for an incremental time step Δtₛ. One example Δtₛ may be a value between 5-30s depending on the orbital altitude/velocity and the desired accuracy of the coverage information. The iteration 8500 may start at 8502. At operation 8504, the iteration 8500 may prepare each satellite (or payload on board each satellite) in the constellation of satellites. In one implementation, the operation 8504 may include, for each of the satellites (or a payload on board each of the satellites) in the constellation, updating stored information about the current and/or past operational modes of the satellite (or payload on board the satellite), updating stored information about the current and/or past power consumption of the satellite (or payload on board the satellite), checking whether to remain in or enter emergency mode, and (if not in or entering emergency mode) calculating the power consumption score. In some implementations, as part of operation 8504, satellites (or payloads on board the satellites) for which it is determined to enter the emergency mode may be scheduled or instructed to enter the emergency mode. As described herein, a power consumption score for each satellite (or a payload on board each satellite) may be calculated with consideration of whether the satellite (or payload on board the satellite) is in an eclipse period. One exemplary implementation of the operation 8504 may be a subroutine or sub-process which may be invoked by the iteration 8500. A flowchart illustrating such a sub-process is shown in FIG. 9 and will be described below.

At operation 8506, for each satellite (or payload) that is in emergency mode (e.g., its EMERGENCY variable being true), the critically covered tiles by such a satellite (or payload) during a defined future time period (e.g., Δtₛ) while the satellite (or payload) remains in emergency mode may be added to a bad tiles list. As described above, a tile is critically covered if the number of satellites (or payloads) providing coverage of the tile is equal to the required number to provide the coverage. If a satellite (or payload on board the satellite) is in emergency mode, its service providing elements are turned off and thus, the satellite (or payload on board the satellite) cannot provide coverage. Therefore, any tiles being critically covered with coverage provided by the satellite (or payload on board the satellite) while the satellite (or payload) is in emergency mode is now not sufficiently covered. The bad tiles list may be used to keep track of tiles that have either no coverage or a shortage in the required or desired coverage. Ephemeris data for each satellite (or payload on board the satellite) (e.g., the projected orbit and corresponding footprint of the satellite (or payload) during the future time period) may be used in identifying bad tiles during the future time period.

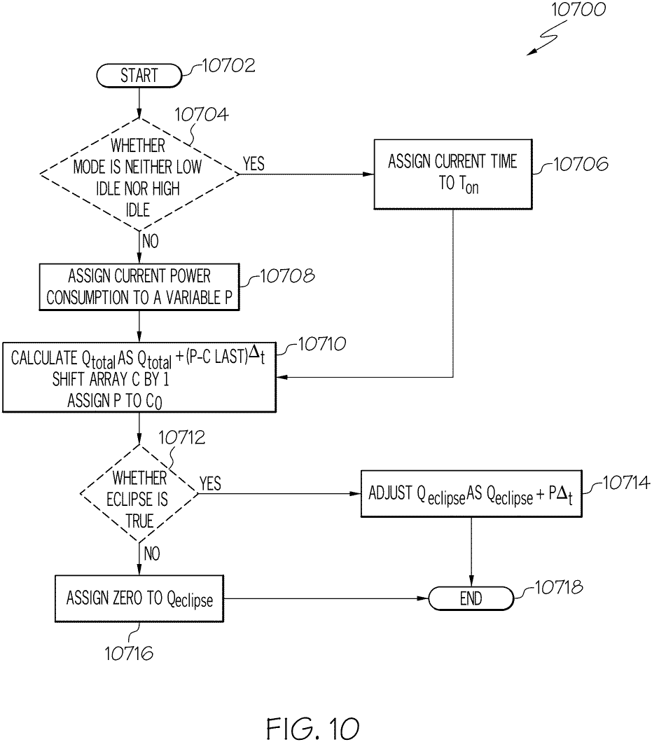

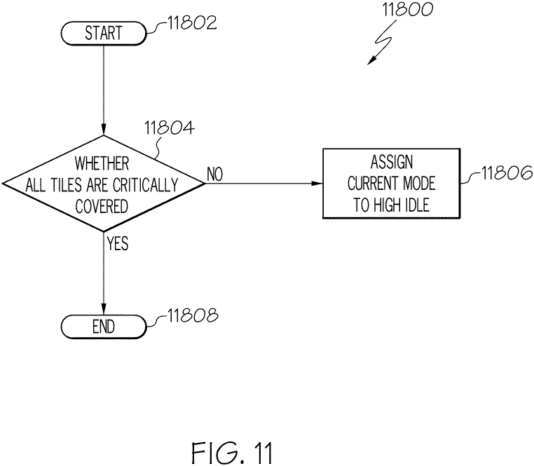

At operation 8508, the iteration 8500 may sort satellites (or payloads on board the satellites) not determined to remain in or enter the emergency mode (e.g., in operation 8504) into an array (e.g., denoted N) ordered by their respective power consumption scores. The power consumption scores may have been calculated as part of the sub-process for preparation of each satellite in operation 8504. In one implementation, the satellites (or payloads on board the satellites) may be arranged in the array in a descending order such that, in the next two operations, the satellites (or payloads on board the satellites) having higher power consumption scores may be processed earlier than those having lower power consumption scores. In some cases, two or more satellites (or payloads on board the satellites) may have equal power consumption scores. In such cases, satellites (or payloads on board the satellites) may be sorted first based on their power consumption scores and then based on one more additional attributes. At operation 8510, the iteration 8500 may iterate through the satellites (or payloads on board the satellites) in the array and determine whether each satellite (or payload on board the satellite) may be put into “High Idle” mode. Satellites (or payloads on board the satellites) for which it is determined to enter the “High Idle” mode may be instructed or scheduled to enter the “High Idle” mode. At operation 8512, the iteration 8500 may iterate through the satellites (or payloads on board the satellites) that already have been determined to be in or to enter the “High Idle” mode and determine whether each such satellite (or payload on board the satellite) may be put into “Low Idle” mode. Satellites (or payloads on board the satellites) for which it is determined to enter the “Low Idle” mode may be instructed or scheduled to enter the “Low Idle” mode. Each of operation 8510 and operation 8512 may be implemented in a subroutine or sub-process which may be invoked by the iteration 8500. A flowchart illustrating a sub-process for operation 8510 is shown in FIG. 11 and a flowchart illustrating a sub-process for operation 8512 is shown in FIG. 12. According to at least one implementation of the satellite coverage provisioning process, the higher the energy consumption score, the more urgent it is to switch off the satellite.

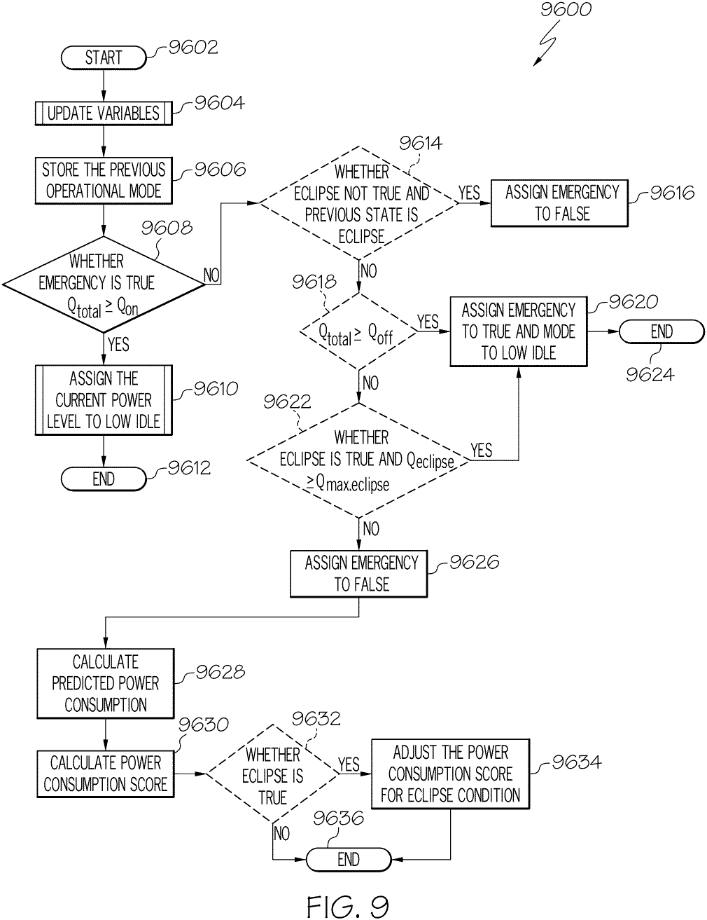

FIG. 9 illustrates an exemplary sub-process 9600 for preparing each satellite (or a payload on board each satellite). In one implementation, the sub-process 9600 may be invoked at operation 8504 at least once for each satellite (or a payload on board each satellite) in the constellation of satellites separately. The sub-process 9600 may start at 9602. At operation 9604, the sub-process 9600 may update variables for the satellite (or a payload on board the satellite) currently being processed. One exemplary implementation of the operation 9604 may be implemented in a subroutine or sub-process which may be invoked at operation 9604. A flowchart illustrating such a sub-process is shown in FIG. 10 and will be described below.

At operation 9606, the previous operational mode for the satellite (or payload on board the satellite) currently being processed may be stored. As indicated in Table 3, a current operational mode may be denoted as M and a previous operational mode may be denoted as Mₚ (“current” may be in the sense of being processed, not necessarily the operational mode contemporaneous with execution of the operation 9606). Thus, for example, operation 9606 may be implemented as an assignment, such as Mₚ = M in some common programming languages (e.g., C/C++, Java, FORTRAN, etc.). At operation 9608, whether the EMERGENCY variable is true and whether Qₜₒₜₐₗ is larger than or equal to Qₒₙ may be determined. If both conditions are true, the sub-process 9600 may proceed to block 9610, at which the current operational mode may be assigned to “Low Idle,” and then the sub-process 9600 may end at block 9612. (Unless indicated otherwise, the “end” blocks in FIGS. 9-12 may be implemented as a “return” in many common programming languages). In one implementation, operation 9610 may be used to continue the emergency mode for the satellite (or payload on board the satellite) currently under processing. In some implementations, after a determination is made that a satellite (or payload on board a satellite) should stay in or enter the “Low Idle” mode, the satellite (or payload on board the satellite) may be instructed or scheduled to stay in or enter the “Low Idle” mode accordingly. If either or both conditions “EMERGENCY variable is true” or “Qₜₒₜₐₗ is larger than or equal to Qₒₙ” are not true, the sub-process 9600 may proceed to block 9614, at which whether the ECLIPSE variable is true and whether the previous state is eclipse may be determined. If both conditions are true in block 9614, the sub-process 9600 may proceed to block 9616, at which the EMERGENCY flag may be cleared. In one implementation, the operation 9616 may be used to indicate that the satellite (or payload on board the satellite) currently being processed is coming out of an eclipse period. If either or both conditions are false in block 9614, or alternatively, after the operation 9616, the sub-process 9600 may proceed to block 9618, at which whether Qₜₒₜₐₗ is larger than or equal to Q_{off} may be determined. If Qₜₒₜₐₗ is larger than or equal to Q_{off}, the sub-process 9600 may proceed to block 9620, at which the satellite (or payload on board the satellite) may be put into the “Low Idle” mode for energy consumption and its EMERGENCY variable set as true. From block 9620, the sub-process 9600 may end at block 9624. If, however, Qₜₒₜₐₗ is less than Q_{off}, the sub-process 9600 may proceed to block 9622, at which whether ECLIPSE is true and Q_{eclipse} is larger than or equal to Q_{max.eclipse} may be determined. If ECLIPSE is true and Q_{eclipse} is larger than or equal to Q_{max.eclipse}, the sub-process 9600 may proceed to block 9620. If ECLIPSE is not true, Q_{eclipse} is less than Q_{max.eclipse}, or both, the sub-process 9600 may proceed to block 9626, at which the EMERGENCY variable may be assigned to false. Operation 9626 may indicate that the satellite (or payload on board the satellite) currently being processed is not in the emergency mode, if the sub-process 9600 reaches this block.

From block 9626, the sub-process 9600 may proceed to block 9628, at which the predicted cumulative power consumption for the satellite (or payload on board the satellite) may be calculated. As described above, the predicted cumulative power consumption may be calculated based on the operational modes of the satellite (or payload on board the satellite) and predicted time periods in the different operational modes. At least in one implementation, this calculation may use the average power Pₐᵥₑᵣ to calculate the predicted cumulative power consumption. Regardless of whether using specific power for the specific power modes (e.g., P_{High}, P_{Medium}, or P_{Low}) or using the average power Pₐᵥₑᵣ, this operation 626 may be implemented in a separate subroutine or sub-process in some implementations.

From block 9628, the sub-process 9600 may proceed to block 9630, at which the power consumption score may be calculated (e.g., using equation (1) and the predicted cumulative power consumption). At block 9632, whether ECLIPSE is true may be determined. If the satellite (or payload on board the satellite) currently being processed is in an eclipse period, the result of operation 9632 may be “YES,” and the sub-process 9600 may proceed to block 9634. At 9634, the power consumption score may be adjusted for the eclipse condition. As described above, the power deficiency variable Q_{deficiency} may be calculated according to equation (2) and the predicted cumulative power consumption, then a scoring parameter for eclipse S_{eclipse} as a ratio of this deficiency to Q_{max.eclipse} may be calculated according to equation (3), and the total power consumption score adjusted for eclipse may be calculated according to equation (4). From block 9634, the sub-process 9600 may proceed to block 9636 and end. If the satellite (or payload on board the satellite) currently being processed is not in an eclipse period, the result of operation 9632 may be “NO,” and the sub-process 9600 may also proceed to block 9636 and end.

FIG. 10 illustrates an exemplary sub-process 10700 for updating the operational status of each satellite (or a payload on board each satellite). In one implementation, the sub-process 10700 may be invoked at operation 9604. The sub-process 10700 may start at block 10702. At block 10704, whether the current operational mode is neither “Low Idle” nor “High Idle” may be determined. If operation 10704 returns “YES,” the sub-process 10700 may proceed to 10706, at which the current time may be assigned to the variable tₒₙ. This operation may represent storing the time that the satellite leaves the idle mode. If operation 10704 returns “NO,” or the operation at block 10706 has finished, the sub-process 10700 may proceed to block 10708, at which a current power consumption level may be assigned to a variable P (e.g., based on the operational mode of the satellite (or payload on board the satellite). For example, if the satellite (or payload on board the satellite) is in (or during the time period Δtₛwill be in) one of the operational modes, the variable P may be assigned a value of P_{High}, P_{Medium}, or P_{Low} as appropriate given the operational mode of the satellite (or payload on board the satellite). Alternatively, if the satellite (or payload on board the satellite) is in (or during the time period Δtₛ will be in) one of the operational modes, the variable P may be assigned a value of Pₐᵥₑᵣ. Then at block 10710, the cumulative power consumption Qₜₒₜₐₗ may be calculated as a previous value of Qₜₒₜₐₗ plus (P-Cₗₐₛₜ) multiplied by Δtₛ, the array C may be shifted by one, and the value of the variable P may be assigned to C₀. This process associated with array C creates the “sliding window” effect in an iterative way by updating Qₜₒₜₐₗ. At block 10712, whether the satellite (or payload on board the satellite) is in an eclipse period may be determined by checking whether the ECLIPSE variable is true. If the satellite (or payload on board the satellite) is in an eclipse period, the cumulative power consumption since the beginning of the eclipse Q_{eclipse} may be updated at block 10714 to account for the power consumed during the incremental time step Δtₛ such that Q_{eclipse} = Q_{eclipse} + P×Δtₛ, and the sub-process 10700 may end at block 10718. If the satellite (or payload on board the satellite) is not in an eclipse period, the power consumption since the beginning of the eclipse period Q_{eclipse} may be set to zero at block 10716, and the sub-process 10700 may end at block 10718.

FIG. 11 illustrates an exemplary sub-process 11800 for determining whether a satellite (or a payload on board the satellite) (e.g., a satellite (or a payload on board the satellite) not in emergency mode) may be put into a “High Idle” operational mode. In one implementation, the sub-process 11800 may be invoked at operation 8510. The sub-process 11800 may start at block 11802. At block 11804, whether all tiles covered by the satellite (or payload on board the satellite) currently being processed are critically covered (or will be critically covered during a future time period (e.g., Δtₛ) may be determined. If operation at block 11804 returns “YES,” that means the satellite (or payload on board the satellite) currently being processed provides (or will provide) redundant coverage for tiles it covers and thus, the satellite (or payload on board the satellite) currently being processed may be put to “High Idle” mode at block 11806. That is, the satellite (or payload on board the satellite) currently being processed may be configured to stop the coverage. If operation at block 11804 returns “NO,” or alternatively, after the block 11806, the sub-process 11800 may end at block 11808.

FIG. 12 illustrates an exemplary sub-process 12900 for determining whether a satellite (or payload on board the satellite) (e.g., a satellite (or payload on board the satellite) that is scheduled for “High Idle” mode) may be put into the “Low Idle” operational mode. In one implementation, the sub-process 12900 may be invoked at operation 8512. The sub-process 12900 may start at block 12902. At block 12904, whether the current mode for the satellite (or payload on board the satellite) currently being processed is in “High Idle” mode may be determined. If operation at block 12904 returns “NO,” the sub-process 12900 may end at block 12906. If operation at block 12904 returns “YES,” the sub-process 12900 may proceed to block 12908, at which the number of previous consecutive “High Idle” periods may be assigned to a variable N_{high.idle}. Each previous “High Idle” period may be for an incremental time step Δtₛ.

Then at block 12910, whether to reboot the satellite (or payload on board the satellite) currently being processed may be determined. As described above, certain services may require a satellite (or a payload on board the satellite) to be rebooted during a certain period of time, such as one orbit, for example. In one implementation, the condition for determining whether to reboot may be whether the current time T_{current.time} minus the last time the satellite (or payload on board the satellite) came off Low Idle mode Tₒₙ is larger than a pre-defined maximal waiting time value since the last reboot T_{reboot} (e.g., checking whether T_{current.time} - Tₒₙ > T_{reboot}). If operation 12910 returns “NO,” at block 12914, whether the length of time the satellite (or payload on board the satellite) has remained in consecutive “High Idle” periods is larger than an idle time threshold value T_{idle} and whether T_{current.time} - Tₒₙ > T_{wait} may be determined. If operation 12914 returns “NO,” the sub-process 12900 may end at block 12922. It should be noted that the sequence of blocks 12910 and 12914 is irrelevant and, in some implementations, they may be in a different order or even combined (e.g., both blocks combined into one conditional operation). If either of the operations 12910 or 12914 returns “YES,” the sub-process 12900 may proceed to block 12916, at which the satellite (or payload on board the satellite) currently being processed may be put into the “Low Idle” mode. At block 12916, “Low Idle” may be assigned as the current operational mode, “High Idle” may be assigned as the previous operational mode, previously scheduled upcoming “High Idle” periods may be changed to “Low Idle” periods, and the total scheduled energy consumption Qₜₒₜₐₗ may be adjusted to account for the change to “Low Idle” as well. With the previously scheduled N_{high.idle} “High Idle” periods changed to be “Low Idle” periods, the N_{high.idle} entries in the array C may be changed to P_{idle} at block 12916 as well. In at least one implementation, the adjustment to Qₜₒₜₐₗ may be performed as Qₜₒₜₐₗ = Qₜₒₜₐₗ - N_{high.idle} (P_{high.idle} - P_{idle}) Δtₛ. It should be noted that, in some implementations, the satellite coverage provisioning process described herein may be performed beforehand. That is, this process may not be executed in real time such that every decision may not be carried out immediately, but instead this process may be pre-performed such as to prepare a schedule for the future. Thus, previously scheduled “High Idle” periods may be adjusted to be “Low Idle” periods and this adjustment may not affect the satellite’s current operation. Additionally or alternatively, in some implementations, the satellite coverage provisioning process may be repeatedly iteratively such that periods previously scheduled for the satellite (or payload on board the satellite) may be changed during successive iterations.

From block 12916, the sub-process 12900 may proceed to block 12918, at which whether the satellite (or payload on board the satellite) currently being processed is in an eclipse period is determined. If operation 12918 determines that the ECLIPSE is true, at block 12920, the power consumption for eclipse Q_{eclipse} may be adjusted for all previously scheduled “High Idle” eclipse intervals to account for the change to “Low Idle.” In one implementation, such an adjustment may be performed by repeating the calculation Q_{eclipse} = Q_{eclipse} - (P_{high.idle} - P_{idle}) Δtₛ for all consecutive pervious states in ECLIPSE and “High Idle” mode. If operation 12918 returns “NO,” or alternatively, the block 12920 finishes, the sub-process 12900 may end at block 12922.

### Beam Scheduling

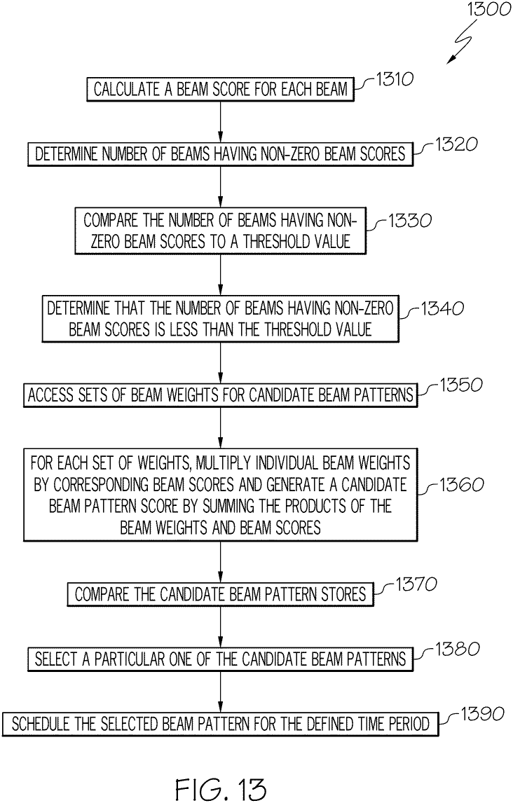

In one example of a spaced-based ADS-B system such as system 100 of FIG. 1A or system 5 of FIG. 1B, individual satellites (or individual ADS-B payloads) within the system may be configured to provide multiple different coverage beams for receiving ADS-B messages and may benefit from intelligent management of beam scheduling to achieve desired coverage without exceeding allowed power budgets. Referring now to FIG. 14, in one specific implementation, each individual satellite within the system (or each ADS-B payload) may be configured to have 33 different beams, for example, laid out as illustrated in the example beam pattern illustrated in FIG. 14. However, power (or other resource constraints) may prevent the concurrent use of all 33 beams at the same time. For example, operating all 33 beams at the same time may cause an individual satellite (or ADS-B payload) to exceed its allowed power budget. Additionally or alternatively, size and/or processing constraints may not allow for 33 individual receivers on board a satellite (or ADS-B payload) for concurrently processing signals received in all 33 beams. Therefore, individual satellites (or ADS-B payloads) may benefit from intelligent beam scheduling to achieve desired coverage within the constraints imposed on or by the satellite (or ADS-B payload).

This section of the present disclosure describes beam selection and scheduling techniques. While the disclosed beam selection and scheduling techniques generally are described in the context of selecting and scheduling beams of a satellite’s (or payload’s) antenna for receiving ADS-B messages, the beam selection and scheduling techniques may have broad application and can be employed in a variety of different contexts for the purpose of selecting and scheduling satellite antenna beams. As described in greater detail below, such beam selection and scheduling may be performed on a terrestrial computing platform (or similar resource) with the resultant beam schedules thereafter being uploaded to individual satellites. Additionally or alternatively, individual satellites may perform the beam selection and scheduling techniques disclosed herein themselves.

As described above, in some implementations, a space-based ADS-B system is formed from a constellation of satellites in low-Earth orbit (LEO). For example, a space-based ADS-B system may be formed from a number of LEO satellites arranged in some number of substantially polar orbital planes such that the constellation collectively provides coverage of substantially all of the Earth’s surface. In one particular implementation, a space-based ADS-B system may be formed from 66 LEO satellites arranged in 6 orbital planes each having 11 satellites in substantially polar orbits. The antennas for receiving ADS-B messages on each of the satellites of such a space-based ADS-B system may be substantially the same and may be configured to provide substantially the same beam patterns. In one particular example, the antennas may be configured to provide 33 beams for receiving ADS-B signals as illustrated in FIG. 4. In some implementations, the primary mission of the satellites may be to provide the space-based ADS-B system. In other implementations, the satellites may have one or more other missions and the space-based ADS-B system may be implemented by ADS-B payloads hosted on the satellites as hosted or secondary payloads. Therefore, it should be understood that references herein to a satellite or an antenna on board a satellite may refer to a satellite or a satellite’s primary payload as well as a hosted or secondary payload and an antenna for a hosted or secondary payload.

Due to power (and/or other) constraints, it may be desirable (or necessary) to use less than a satellite’s full complement of beams for receiving ADS-B messages. Therefore, beam selection and scheduling techniques may be performed in an effort to satisfy such constraints while still providing the desired coverage. In some implementations, the beam selection and scheduling techniques may schedule specific beam configurations for defined periods of time, each of which may be subdivided into segments. For example, in one implementation, the beam selection and scheduling techniques may schedule specific beam configurations for defined periods of time that may be referred to herein as beam cycle periods that are further subdivided into four segments (e.g., Segment A, Segment B, Segment C, and Segment D). In some implementations, the time period for a beam cycle period may be configurable. Examples of different time periods for a beam cycle period in different implementations or according to different configurations include 5 seconds, 8 seconds, and 10 seconds. For each such beam cycle period, the satellite may be assigned a particular power budget, for example, based on whether the satellite is in a position from which solar power is available or in an eclipse position from which solar power is not available because the Earth blocks the sun. The scheduling of the four segments and the different beams that may be turned on and off during individual segments then may be determined in an effort to achieve the desired coverage while satisfying the power budget (and/or other constraints).

In some implementations, the earth may be divided into a grid of 1° ×1° tiles over WGS-84 latitude and longitude. Such tiles may be divided into four categories: class one tiles in low update interval service volumes (e.g., update intervals of approximately 10-15 seconds); class two tiles in service volumes that may benefit from special treatment (e.g., tiles near high traffic areas where so-called FRUIT (false replies unsynchronized in time) levels may be expected to be high or tiles where satellite coverage overlap may be low, such as, for instance, near the equator in the case of a constellation of satellites in substantially polar orbits); class three tiles in high update interval service volumes (e.g., update intervals of approximately 30 seconds); and class four tiles where coverage is not desired or provided. In some implementations, an individual class two tile also may be considered to be either a class one tile or a class three tile (e.g., based on the desired update interval for the service volume where the tile is located). These tile classifications may inform beam selection and scheduling decisions.

A variety of different techniques may be employed to accomplish such beam selection and scheduling during each such beam cycle period for a satellite’s antenna. For example, one technique may be referred to as a default sector scan. When a default sector scan is employed, each of the four segments may be assigned to a different quadrant of the antenna’s beam pattern (e.g., as depicted in FIG. 14), and all (or some portion of all) of the antenna’s beams in an individual quadrant may be turned on during the corresponding segment and off during the other segments. For example, during Segment A, all (or some portion of all) of the antenna’s beams in Quadrant 1 may be turned on while all of the antenna’s other beams are turned off. Similarly, during Segment B, all (or some portion of all) of the antenna’s beams in Quadrant 2 may be turned on while all of the antenna’s other beams are turned off. Likewise, during Segment C, all (or some portion of all) of the antenna’s beams in Quadrant 3 may be turned on while all of the antenna’s other beams are turned off; and, during Segment D, all (or some portion of all) of the antenna’s beams in Quadrant 4 may be turned on while all of the antenna’s other beams are turned off. In some implementations, the default sector scan technique may be configured to spend an equal dwell time (e.g., 1 second) in each of the four quadrants. Alternatively, in other implementations, the default sector scan may be configured to spend different dwell times in each of the four quadrants (e.g., based on the classifications of tiles within each quadrant). While the default sector scan technique may provide relatively good coverage, a default sector scan also may require a relatively large power budget to operate and, therefore, may not always be a suitable option.

Another technique that may be used to accomplish beam selection and scheduling during a beam cycle period is to turn off all of the antenna’s beams during one or more segments and to select one or more different beam patterns during the remaining segments. In one particular example, this technique may involve selecting particular beam patterns to be employed during Segment A and Segment C while turning all of the antenna’s beams off during Segment B and Segment D. In this example, the beam patterns selected for Segments A and C may be referred to herein as paired beam patterns. In such an approach, the length of each individual segment may be determined in an effort to comply with the defined power budget for the beam cycle period. For example, if the defined power budget is relatively low, the lengths of Segment B and Segment D, where all of the antenna’s beams are turned off, may be scheduled to be relatively long; whereas, if the defined power budget is relatively high, the lengths of Segment B and Segment D may be scheduled to be relatively short. For example, in one implementation, the length of time for each of Segments A and C and the length of time for each of Segments B and D may be calculated according to the following equation:

$$\left(B e a m C y c l e P e r i o d - T i m e O n\right) = T i m e O n \left(\frac{P o w e {r}_{O n} - P o w e {r}_{B u d g e t}}{P o w e {r}_{B u d g e t} - P o w e {r}_{O f f}}\right)$$

where “Beam Cycle Period” represents the time period for the beam cycle period, “Time On” represents two times the length of time for each of Segments A and C, “Beam Cycle Period” minus “Time On” represents two times the length of time for each of Segments B and D, “Poweron” represents a measure of the power consumed with the beams turned on during Segments A and C, “Power_{Off}” represents a measure of the power consumed with the beams turned off during Segments B and D, and “Power_{Buaget}” is the defined power budget for the beam cycle period.

Additionally or alternatively, in some implementations, the tiles to be covered by the satellite during the beam cycle period may be taken into account when determining the length of time for each individual segment. For example, if one or more of the tiles to be covered by the satellite during the beam cycle period are class one tiles for which relatively short update intervals are desired, the lengths of Segment A and Segment C may be scheduled to be relatively long.

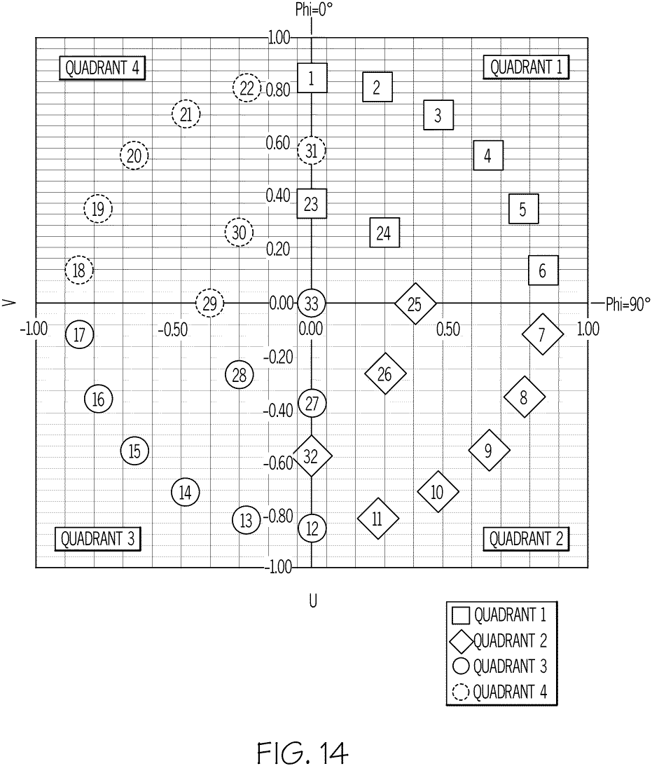

A variety of different beam patterns may be available for selection for Segment A and Segment C. For example, in some cases, a first so-called “Omni” beam pattern that covers nearly all of the azimuth and elevation space within the satellite’s coverage footprint may be selected for Segment A and a second “Omni” beam pattern that overlaps with the first “Omni” beam pattern but provides slightly different coverage of the azimuth and elevation space within the satellite’s coverage footprint may be selected for Segment C. Referring to the specific example beam configuration illustrated in FIG. 14, the first “Omni” beam pattern for Segment A may employ beams 1, 4, 7, 10, 12, 15, 18, 21, 23, 27, 31, and 33, while the second “Omni” beam pattern for Segment C may employ beams 2, 5, 8, 11, 13, 16, 19, 22, 23, 27, 31, and 33. Plots showing examples of the probability of detection (PD) of ADS-B messages when these two “Omni” beam patterns are used are illustrated in FIG. 15A and FIG. 15B, respectively.

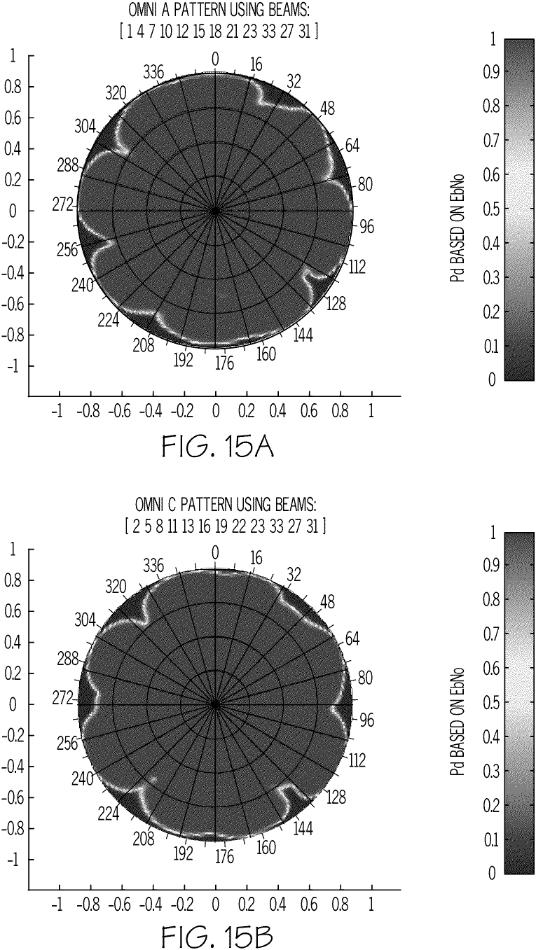

Additionally or alternatively, in some cases, a first so-called “Hemi” beam pattern that approximately covers one half of the azimuth and elevation space within the satellite’s coverage footprint may be selected for Segment A and a second “Hemi” beam pattern that approximately covers the other half of the azimuth and elevation space within the satellite’s coverage footprint may be selected for Segment C. Referring to the specific example beam configuration illustrated in FIG. 14, the first “Hemi” beam pattern for Segment A may employ beams 2, 3, 4, 5, 6, 8, 10, 12, 23, 24, 26, and 33, while the second “hemi” beam pattern for Segment C may employ beams 1, 13, 14, 15, 17, 19, 20, 21, 27, 28, 30, and 33. Plots showing examples of the probability of detection (PD) of ADS-B messages when these two “hemi” beam patterns are used are illustrated in FIG. 16A and FIG. 16B, respectively.

In some implementations, many additional paired beam patterns may be available for selection for Segment A and Segment C. For example, one example of an additional paired beam pattern may be a so-called “East Hemi” paired beam pattern that focuses coverage within quadrants 1 and 2 of the azimuth and elevation space of the satellite’s coverage footprint. Referring to the specific example beam configuration illustrated in FIG. 14, the “East Hemi” beam pattern for Segment A may employ beams 1, 3, 4, 6, 8, 10, 12, 23, 24, 25, 26, and 32, while the “East Hemi” beam pattern for Segment C may employ beams 2, 4, 5, 7, 9, 11, 23, 24, 25, 26, 27, and 31. Alternatively, another example of an additional paired beam pattern may be a so-called “West Hemi” paired beam pattern that focuses coverage within quadrants 3 and 4 of the azimuth and elevation space of the satellite’s coverage footprint. Referring to the specific example beam configuration illustrated in FIG. 14, the “West Hemi” beam pattern for Segment A may employ beams 1, 21, 19, 17, 15, 13, 31, 30, 29, 28, 27, and 32, while the “West Hemi” beam pattern for Segment C may employ beams 22, 20, 18, 16, 14, 12, 23, 27, 28, 29, 30, and 31. Numerous other paired beam patterns also may be available. For example, paired beam patterns focusing on individual quadrants also may be available. Additionally or alternatively, paired beam patterns focusing on three quadrants also may be available.

In some implementations, each paired beam pattern may be associated with a set of weights, with each weight corresponding to an individual one of the beams of the satellite’s antenna. For example, referring to the specific example beam configuration of 33 beams illustrated in FIG. 14 and recalling the “East Hemi” paired beam pattern described above, the following table illustrates examples of weights assigned to each beam of the satellite’s antenna for the purposes of the “East Hemi” paired beam pattern:

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0.4 | 1 | 1 | 1 | 1 | 1 | 1 | 1 | 1 | 1 | 1 | 0.4 | 0 | 0 | -1 | -1 |
| 17 | 18 | 19 | 20 | 21 | 22 | 23 | 24 | 25 | 26 | 27 | 28 | 29 | 30 | 31 | 32 |
| -1 | -1 | -1 | -1 | 0 | 0 | 0.4 | 1 | 1 | 1 | 0.4 | 0 | -1 | 0 | 0.4 | 04 |
| 33 | | | | | | | | | | | | | | | |
| 0.4 | | | | | | | | | | | | | | | |

These sets of weights for each of the available paired beam patterns may be used in the process of selecting an appropriate paired beam pattern for a satellite for a particular beam cycle period. For example, the expected gain (in some cases quantified as the link margin, or the energy per bit to noise power spectral density ratio, E_{b}/N₀) of each beam during the particular beam cycle period may be multiplied by the beam’s corresponding weight for each paired beam pattern, and the resulting products for each of the beams of a given paired beam pattern may be summed to generate a score for the paired beam pattern. The paired beam pattern with the highest score for the particular beam cycle period then may be selected as the appropriate paired beam pattern for the particular beam cycle period.

In some implementations, the expected gain for a beam may be a function of one or more different factors. For example, the expected gain for a beam may be a function of the orientation (e.g., angle) of the satellite’s antenna (or relevant antenna elements) relative to the coverage area covered by the beam. Additionally or alternatively, the excepted gain for a beam also may take into account the desired coverage area. For example, if the coverage area covered by a beam during a particular period of time covers only tiles for which coverage is not desired, the expected gain for the beam may be set to zero irrespective of the actual expected gain of the beam during that particular period.

In some implementations, the expected gain for a beam may change over time, for example, as the satellite orbits the Earth and the orientation of the satellite’s antenna relative to the Earth changes. Consequently, in some implementations, changes to the expected gain for a beam over time may be taken into account in the beam selection processes described herein. For example, in some implementations, a beam score may be calculated for each beam of a satellite’s antenna for a particular beam cycle period by dividing the particular beam cycle period into some smaller number of sub-periods (e.g., 10 sub-periods) and calculating the sum (or the average) of the expected gain for the beam across all of the sub-periods. Such beam scores can be used in a number of different ways in the beam selection processes described herein. For example, the beam scores for each of the beams of a satellite’s antenna can be multiplied by the corresponding beam weights associated with the paired antenna patterns as part of the process for selecting an appropriate paired antenna pattern as described above.

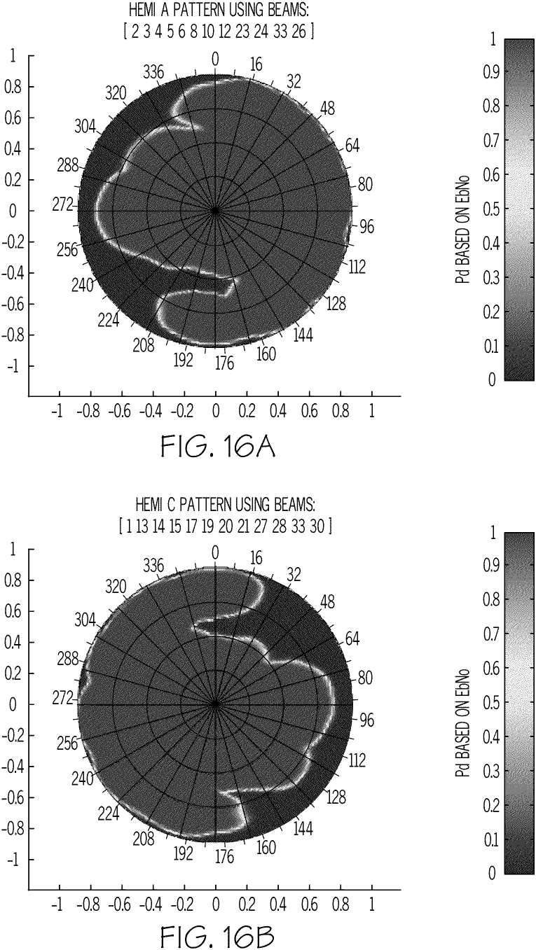

Referring now to FIG. 17, a flow chart of an example of a process 1700 for selecting a beam configuration for the beams of a satellite’s antenna during a defined time period (e.g., a beam cycle period) is illustrated in accordance with a non-limiting implementation of the present disclosure. Process 1700 may be performed by a ground control system implemented on a computing platform, such as, for example, ground control system 42120 implemented on computing platform 42110 as illustrated in FIG. 42. In such cases, beam selection schedules generated by performing process 1700 may be uploaded to individual satellites 42155 and, thereafter, used by the individual satellites 42155 to control the beams of the satellites’ antennas. Additionally or alternatively, process 1700 may be performed by computing resources on board one or more satellites.

In some implementations, process 1700 may be performed multiple times and in advance to develop a beam selection schedule for an individual satellite for many defined time periods (e.g., beam cycle periods). For example, in some implementations, process 1700 may be performed to generate a forward-looking beam selection schedule for an individual satellite as much as twenty-four hours or more in advance. In such implementations, small portions of such beam selection schedules may be uploaded to the satellites at time. For example, in some implementations, beam selection schedules defining beam selections for 120 second time periods may be uploaded to the satellites. It will be appreciated that process 1700 may be performed for each of several different satellites to generate beam selection schedules for each individual satellite.

Referring specifically to FIG. 17, at step 1800, a determination is made as to whether the number of active beams of the satellite’s antenna during a defined time period (e.g., a beam cycle period) exceeds the number of receivers available on the satellite for processing signals received by the antenna by less a defined first threshold value. In some implementations, an active beam may be considered to be a beam that has a non-zero expected gain during the defined time period or a non-zero beam score during the defined time period. In one example, a satellite may have 12 receivers available for processing signals received by the antenna, and the first threshold value may be 3. In this example, if the satellite’s antenna has 14 or fewer active beams, it may be determined at step 1800 that the number of active beams exceeds the number of available receivers by less than the first threshold value. Alternatively, if the satellite’s antenna has 15 or more active beams, it may be determined at step 1800 that the number of active beams does not exceed the number of available receivers by less than the first threshold value.

If it is determined that the number of active beams of the satellite’s antenna exceeds the number of available receivers by less than the first threshold value, the process 1700 proceeds to step 1802. At step 1802, a beam selection process is performed that focuses on selecting the best available active beams for the satellite during the defined time period. For example, the defined time period may be subdivided into Segments A, B, C, and D, and beam scores for each beam of the satellite’s antenna during the defined time period may be used to rank each of the beams during the defined time period. Some number (e.g., corresponding to the number of receivers available on the satellite) of the top-ranked beams then may be selected to be turned on during each of Segment A and Segment C while all of the beams may be turned off during Segment B and Segment D. For example, continuing with the example of the satellite having 12 receivers introduced above, if the satellite’s antenna has 13 active beams during the defined time period, the 12 top-ranked beams may be selected to be turned on during Segment A and the 11 top-ranked beams and the 13th-ranked beam may be selected to be turned on during Segment C.

Returning again to step 1800, if it is determined that the number of active beams of the satellite’s antenna does not exceed the number of available receivers by less than the threshold value, the process proceeds to step 1804. At step 1804, a determination is made as to whether any of the tiles that will be within the coverage footprint of the satellite’s antenna during the defined time period (or that will be within the coverage footprint of the active beams of the satellite’s antenna during the defined time period) may benefit from special treatment, for example, because the tiles are near high traffic areas where FRUIT levels may be expected to be high (perhaps particularly during specific windows of time when traffic is known to usually be high) or because the tiles are located in areas where satellite coverage overlap may be low.

If it is determined that one or more of the tiles that will be within the coverage of the footprint of the satellite during the defined time period may benefit from special treatment, the process 1700 proceeds to step 1806 where a determination is made as to whether a sufficient power budget is available during the defined time period to support such special treatment. In some implementations, the determination of whether there is a sufficient power budget available during the defined time period may be based on whether there is a sufficient power budget available to support a default sector scan as described above. In such implementations, if it is determined that a sufficient power budget is available during the defined time period, at step 1808, a default sector scan may be scheduled for the beams of the satellite’s antenna during the defined time period.

If it is determined that no tiles that will be within the coverage footprint of the satellite’s antenna during the defined time period will benefit from special treatment or that a sufficient power budget is not available to support such special treatment, the process 1700 proceeds to step 1810 where a determination is made as to whether the number of active beams of the satellite’s antenna will exceed a second threshold value during the defined time period. If it is determined that the number of active beams of the satellite’s antenna will exceed the second threshold value during the defined time period, the process 1700 proceeds to step 1812 where a default paired beam pattern (e.g., one of the “Omni” paired beam pattern or the “Hemi” paired beam pattern described above) is scheduled for the beams of the satellite’s antenna during the defined time period.

Alternatively, if it is determined that the number of active beams of the satellite’s antenna will not exceed the second threshold value during the defined time period, the process 1700 proceeds to step 1814 where a pattern association process is initiated. In particular, the defined time period may be subdivided into Segments A, B, C, and D, and, at step 1816, the beam scores for each of the antenna’s beams during the defined time period are multiplied by the corresponding beam weights for each of several defined paired beam patterns. Thereafter, at step 1818, the paired beam pattern for which the sum of the products of the beam scores and beam weights is highest may be selected as the paired beam pattern for the antenna’s beams during the defined period of time. At step 1820, the actual beam patterns for Segment A and Segment C corresponding to the selected paired beam pattern are retrieved, and, at step 1822, a determination is made as to whether all of the tiles for which coverage is desired (e.g., all tiles classified as class 1, class 2, and/or class 3) within the coverage footprint of the satellite’s antenna (or within the coverage footprint of the active beams of the satellite’s antenna) will be covered by the retrieved beam patterns. If it is determined that all of the tiles for which coverage is desired will be covered by the retrieved beam patterns, the process proceeds to step 1824 where the retrieved beam patterns are scheduled for the beams of the satellite’s antenna during the defined time period. Alternatively, if it is determined that not all of the tiles for which coverage is desired will be covered by the retrieved beam patterns, the process proceeds to step 1812 where a default paired beam pattern (e.g., one of the “Omni” paired beam pattern or the “Hemi” paired beam pattern described above) is scheduled for the beams of the satellite’s antenna during the defined time period.

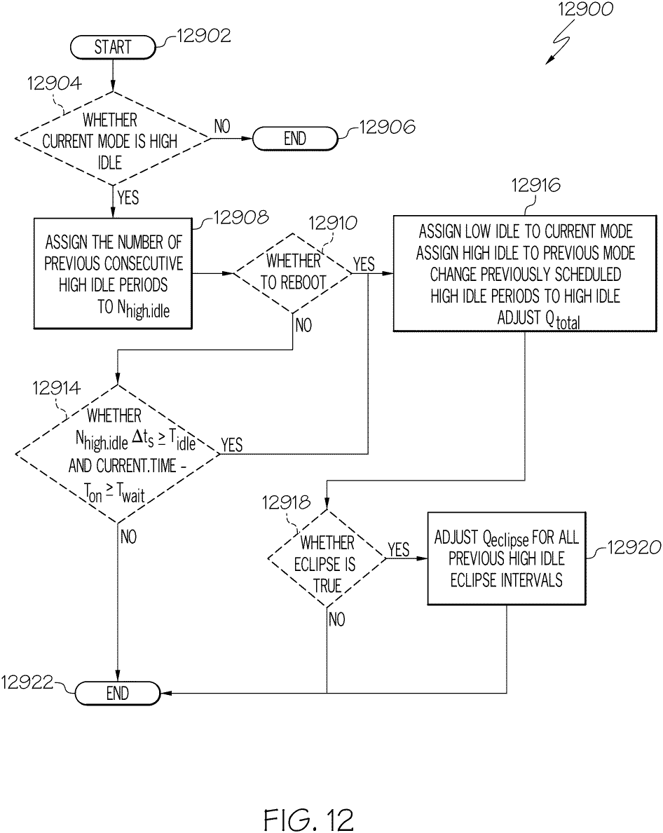

FIG. 13 is a flow chart of an example of a process 1300 for selecting a beam configuration for the beams of a satellite’s antenna during a defined time period in accordance with a non-limiting implementation of the present disclosure. Process 1300 may be performed by a ground control system implemented on a computing platform, such as, for example, ground control system 42120 implemented on computing platform 42110 as illustrated in FIG. 42. In such cases, beam selection schedules may be uploaded to individual satellites 42155 and, thereafter, used by the individual satellites 42155 to control the beams of the satellites’ antennas. Additionally or alternatively, process 1300 may be performed by computing resources on board one or more satellites. In some implementations, process 1300 may be performed multiple times and in advance to develop a beam selection schedule for an individual satellite for multiple defined time periods. It also will be appreciated that process 1300 may be performed for each of several different satellites to generate beam selection schedules for each individual satellite.

At step 1300, a beam score is calculated for each beam of the antenna based, at least in part, on the expected gain of the beam during the defined time period. In some implementations, the beam score for a beam may be calculated by subdividing the time period into multiple sub-periods and calculating the sum or average of the expected gain of the beam across the sub-periods. Additionally or alternatively, in some implementations, beam scores may take into account desired coverage areas. For example, in some implementations, if the area covered by an individual beam during the defined time period is not an area for which coverage is desired, the beam score for the beam for the defined time period may be set to zero (or some other value to reflect that coverage is not desired for the area covered by the beam during the defined timer period).

At step 1320, the number of beams of the antenna having non-zero beam scores during the defined time period is determined. Thereafter, at step 1330, the number of beams of the antenna having non-zero beam scores during the defined time period is compared to a threshold value, and, at step 1340, it is determined that the number of beams of the antenna having non-zero beam scores during the defined time period is less than the threshold value.

At step 1350, as a consequence of having determined that the number of beams of the antenna having non-zero beam scores during the defined time period is less than the threshold value, a set of beam weights for each of multiple different candidate beam patterns, each of which has a weight corresponding to each of the antenna’s beams, is accessed. Thereafter, at step 1360, for each set of weights, the individual beam weights are multiplied by the corresponding beam scores for each of the beams of the antenna during the defined time period, and a candidate beam pattern score is generated by calculating a sum of the products of the beam weights and corresponding beam scores.

The candidate beam pattern scores for the different candidate beam patterns then are compared at step 1370, and, at step 1380, a particular one of the candidate beam patterns is selected based on the candidate beam pattern scores. For example, in some implementations, the candidate beam pattern having the highest candidate beam pattern score may be selected. Finally, at step 1390, the selected beam pattern is scheduled for the beams of the antenna for the defined time period.

### ADS-B Receiver Designs

As described above, implementing a spaced-based ADS-B system, such as, for example, system 100 of FIG. 1A or system 5 of FIG. 1B presents a number of challenges. For instance, as illustrated in FIG. 1B, the distance between transponder 72 on an aircraft 70 and terrestrial ADS-B ground station 60 may be much shorter than the distance between a transponder 72 on an aircraft and a satellite 12, which may be, for example, in low-Earth orbit. For example, a typical terrestrial ADS-B ground station like ADS-B ground station 60 may have a typical maximum range of approximately 150 miles whereas a satellite in low-Earth orbit may orbit the Earth at an altitude as high as approximately 1,243 miles. This significant difference in propagation distance for ADS-B messages may make successful detection and reception of ADS-B messages by a satellite-based ADS-B receiver much more difficult than by a terrestrial-based ADS-B receiver. Furthermore, satellites in low-Earth orbit may orbit the Earth at speeds upwards of 17,000 miles per hour, resulting in Doppler shifts that add additional complications to successfully receiving ADS-B messages. Moreover, given the wider coverage area provided by a satellite as compared to a terrestrial ground station, a satellite-based ADS-B receiver may be exposed to a much higher volume of ADS-B messages than a terrestrial-based ADS-B receiver. This increased volume of received ADS-B messages only compounds the difficulty of successfully detecting and receiving ADS-B messages with a satellite-based ADS-B receiver relative to a terrestrial-based ADS-B receiver.

For terrestrial ADS-B receivers, the physical channel may be assumed to exhibit the characteristics of an interference channel, where interference and/or noise may result from interference or noise in the physical channel itself as well as interference or noise in the antenna or receiver. Interference and/or noise in the physical channel may result from multiple aircraft within range of a terrestrial ADS-B receiver broadcasting ADS-B messages in a fashion that is uncoordinated in time. As a result, ADS-B messages that arrive at the terrestrial receiver may interfere and/or overlap with one another. ADS-B messages that interfere and/or overlap with a desired ADS-B message may be referred to as (or may be one component of) false replies unsynchronized with interrogator transmissions or, alternatively, false replies unsynchronized in time (“FRUIT”).

Other communications protocols that share the 1090 MHz band with ADS-B also may contribute interference and be a source of FRUIT. For example, aircraft implementing secondary surveillance radar (“SSR”) like Mode A, Mode C, or Mode S, may respond to interrogating SSR messages in the 1090 MHz band, potentially creating interference for ADS-B messages. Other transmitters within range of a terrestrial ADS-B receiver transmitting in neighboring or nearby frequency bands also may generate interference or contribute to noise in the physical channel. Appropriately dealing with FRUIT and other interference/noise, particularly for airspaces with a high density of air traffic, may be one challenge faced by a terrestrial ADS-B receiver.

Another challenge faced by a terrestrial ADS-B receiver may be the so-called near-far problem where a signal received at the ADS-B receiver from a relatively nearby aircraft is significantly stronger than a signal received at the ADS-B receiver at the same time from an aircraft that is relatively far from the ADS-B receiver.

A space-based ADS-B receiver may face the same challenges as a terrestrial ADS-B receiver. In addition, as discussed above, a space-based ADS-B receiver may face additional challenges that may be even more imposing than those faced by a terrestrial ADS-B receiver due to, for example, but not limited to, the significantly greater propagation distance between aircraft broadcasting ADS-B messages and the space-based ADS-B receiver, significant Doppler shifts due to the orbital velocity of a satellite, and/or the significantly greater volume of ADS-B messages within the coverage area of a space-based ADS-B receiver relative to a terrestrial ADS-B receiver. Different from the physical channel for a terrestrial ADS-B receiver, the physical channel for a space-based ADS-B receiver may be dominated by noise. Consequently, for a space-based ADS-B receiver, the physical channel may be assumed to exhibit the characteristics of an additive white Gaussian noise (“AWGN”) channel with additional interference channel characteristics. Because of this additional noise, the signal-to-noise ratio (“SNR”) for an ADS-B message received by a space-based ADS-B receiver typically will be much lower than the SNR for an ADS-B message received by a terrestrial ADS-B receiver. Existing terrestrial ADS-B receivers have been shown to be incapable of achieving satisfactory performance for space-based operation due to the lower SNR of ADS-B messages to be received in space. In fact, existing terrestrial ADS-B receivers are believed to require an SNR that is ~7-10 dB greater than the SNR of an ADS-B message to be received in low-Earth orbit in order to achieve satisfactory performance. For example, a space-based ADS-B receiver in low-Earth orbit may be designed to achieve performance of not worse than 10% bit (or message) error rate at an energy per bit to noise power spectral density ratio (“E_{b}/Nₒ”) no more than or equal to 10 dB, whereas existing terrestrial ADS-B receivers typically achieve 10% bit error rate at E_{b}/Nₒ greater than or equal to approximately 18 dB.

The teachings of the present disclosure present receiver designs and techniques for receiving ABS-B messages transmitted by aircraft, particularly 1090 MHz Mode S ES ADS-B messages, from space, for example, on one or more low-Earth orbit satellites. As described in greater detail below, the expected pulse pattern of the preamble and the first few bit periods of the data block for a 1090 MHz Mode S ES ADS-B message may be used to process a signal received by a space-based ADS-B receiver to determine if it is likely to include an ADS-B message. A signal that is determined to be likely to include an ADS-B message then is subjected to further screening, for example, to confirm the presence of an ADS-B message, demodulate the ADS-B message from the received signal, and/or perform error detection and correction of the bits of the demodulated message.

The structure and format of a 1090 MHz Mode S ES ADS-B message is defined in the Radio Technical Commission for Aeronautics′ (“RTCA”) “DO-260B Minimum Operational Performance Standards for 1090 MHz Extended Squitter Automatic Dependent Surveillance -Broadcast (ADS-B) and Traffic Information Services - Broadcast (TIS-B).” 1090 MHz Mode S ES ADS-B messages are pulse position modulated and have 1 µsec bit periods. A pulse transmitted in the first half of the bit period represents the value of the bit as a “1,” while a pulse transmitted in the second half of the bit period represents the value of the bit as a “0.” All 1090 MHz Mode S ES ADS-B messages have a specific 8 µsec preamble that identifies such messages as 1090 MHz Mode S ES ADS-B messages followed by a 112 µsec (or 112 bit) data block. The preamble that identifies a message as a 1090 MHz Mode S ES ADS-B message includes a first pulse from 0.0-0.5 µsec, a second pulse from 1.0-1.5 µsec, a third pulse from 3.5-4.0 µsec, and a fourth pulse from 4.5-5.0 µsec.

While detecting the presence of pulses corresponding to the pattern for the preamble for a 1090 MHz Mode S ES ADS-B message may be helpful in identifying the potential presence of an ADS-B message in the received signal, it may be difficult to detect the preamble pulse pattern, which only includes four pulses over the course of 8 bit periods (or 8 µsec), in the presence of noise, particularly for a space-based ADS-B receiver where the pulses may have very little energy and the SNR is very low due to the propagation distance between an aircraft and the space-based ADS-B receiver. Fortunately, however, subsequent bits of a 1090 MHz Mode S ES ADS-B message also may have an expected pulse pattern and be considered in an effort to detect the potential presence of a Mode S 1090 ES ADS-B message in a received signal. Specifically, for a Mode S 1090 ES ADS-B message, the first five bits of the data block following the preamble identify the downlink format (“DF”) for the ADS-B message, and, in some implementations of a space-based ADS-B receiver, only ADS-B messages having specific downlink formats may be relevant. For example, in some implementations, only ADS-B messages having downlink formats DF=17, DF=18, or DF=19, which share three bits, may be relevant. Consequently, in addition to the preamble, the first 5 bits of a received signal also may be helpful in identifying the potential presence of an ADS-B message within a received signal, which may improve accuracy in the presence of noise relative to only using the preamble, particularly in the case of a space-based ADS-B receiver where the pulses have very little energy and the SNR is very low due to the propagation distance between an aircraft and the space-based ADS-B receiver.

In some implementations, the cross-correlation between samples of a portion of a received signal (e.g., 13 µsec (or bit periods) of a received signal) and a reference signal representing a first portion (e.g., the first 13 µsec (or bit periods)) of an ADS-B signal may be calculated to determine a measure of the likelihood that the received signal includes an ADS-B message. If the result of calculating the cross-correlation of the samples of the portion of the received signal and the reference signal exceeds a defined threshold value, then additional screening may be performed to determine if the received signal does, in fact, include an ADS-B message.

For instance, constant false alarm rate (“CFAR”) detection processing may be applied to a portion of the received signal to further assess the likelihood that the received signal includes an ADS-B message, for example, by determining if the power in the received signal exceeds a threshold level above which the received signal may be considered likely to include an ADS-B message. In some implementations, the threshold may be set in an effort to achieve a desired probability of false alarm (or false alarm rate or time between false alarms), hence the name constant false alarm rate detection. In some implementations, the background against which ADS-B messages are to be detected may be assumed to be constant with time and space, such that a fixed threshold level may be chosen to achieve the desired probability of false alarm, which will be a function of the probability density function of the noise and/or signal-to-noise ratio. In alternative implementations, noise levels may be assumed to change both spatially and temporally, in which case a changing threshold may be used, where the threshold level is raised and lowered to maintain a desired probability of false alarm. Various different algorithms may be used to adaptively select the threshold level, for example, based on the statistics of the background in which the ADS-B messages are to be detected.

If the result of CFAR detection processing suggests that the received signal includes an ADS-B message, a minimum mean square error (MMSE) estimator may be used to generate an estimate of the ADS-B message, or a portion thereof, and various screening techniques may be employed on the ADS-B message estimate to further assess the likelihood that the received signal includes an ADS-B message. In some implementations, a feature vector representing some number n different features of the ADS-B message estimate may be projected into an n-dimensional feature space and the distance between the projection and a region (e.g., a cluster) or a position in the n-dimensional feature space where ADS-B messages would be expected to appear may be calculated. If the distance is less than some defined threshold value, a determination may be made that the received signal is likely to include an ADS-B message. For example, in some implementations, a three-dimensional feature vector representing three features of the ADS-B message estimate may be generated and projected into a three-dimensional feature space. In such implementations, the three features may represent (1) a measure of the consistency of the pulse amplitude across the ADS-B message estimate, (2) a measure of phase consistency across the ADS-B message, and (3) a measure of the residual phase error of the ADS-B message estimate. If the projection of the feature vector in the 3-dimensional feature space is within a defined threshold distance of a region or position in the three-dimensional feature space where ADS-B messages would be expected to appear, a determination may be made that the received signal includes an ADS-B message. Thereafter, in some implementations, the received signal then may be input to a non-coherent matched filter, such as, for example described below in the subsection under the heading ADS-B Receiver Designs - Non-Coherent Receivers, to recover the ADS-B message from the received signal. Additionally or alternatively, in some implementations, such as, for example described below in the subsection under the heading ADS-B Receiver Designs - Coherent Receivers, the received signal may be input to a carrier refinement module that may estimate the frequency of carrier pulses in the received signal, and, if appropriate, shift the frequency of carrier pulses in the received signal toward a desired frequency and/or align the phase of carrier pulses in the received signal with a desired phase before the received signal is input to a coherent matched filter that is phase-matched to the desired phase to recover the ADS-B message from the received signal.

### ADS-B Receiver Designs - Non-Coherent Receivers

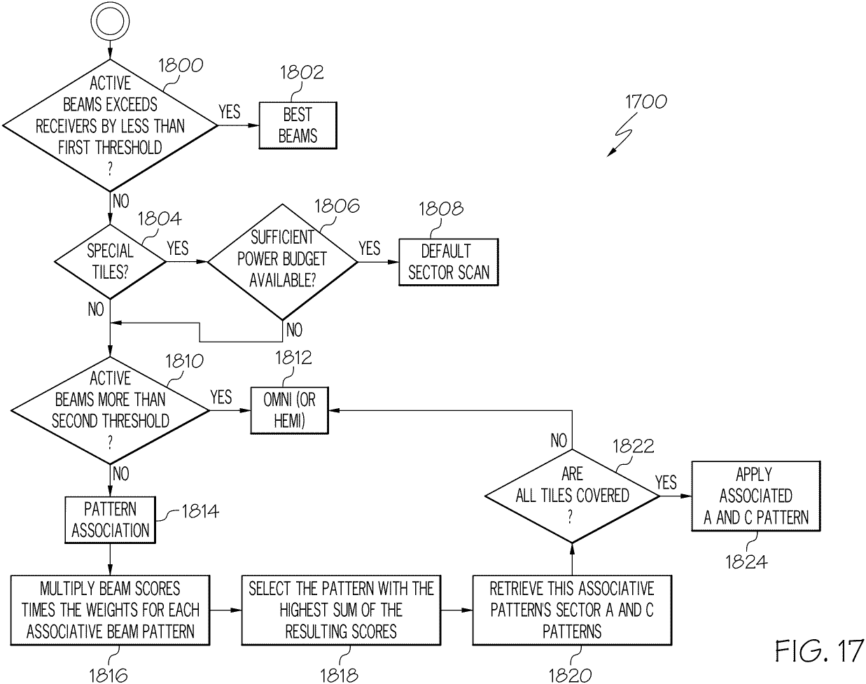

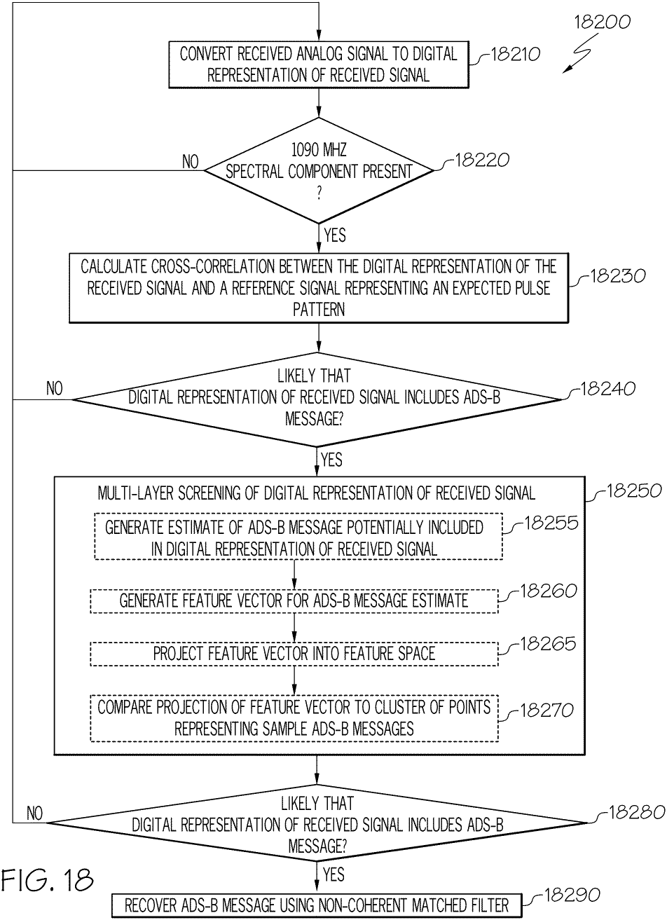

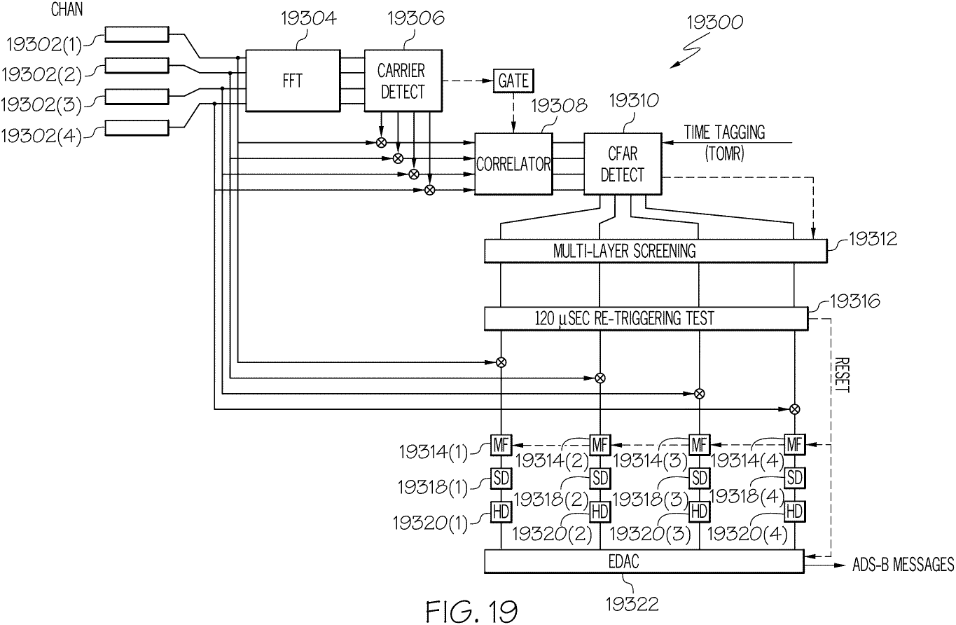

With reference to FIG. 18, a flow chart of a method 18200 for receiving 1090 MHz Mode S ES ADS-B messages using a non-coherent receiver is illustrated in accordance with a non-limiting implementation of the present disclosure. In some implementations, method 18200 may be performed by a receiver for receiving 1090 MHz Mode S ES ADS-B messages that is implemented in one or more logic modules of a field programmable gate array (“FPGA”). FIG. 19 is a functional block diagram of one example of a receiver 19300 (e.g., a multi-channel receiver) for receiving 1090 MHz Mode S ES ADS-B messages that may perform method 18200. In some implementations, each block represented in FIG. 19 may correspond to a specific logic module of an FPGA. As illustrated in FIG. 19, receiver 19300 includes four channels 19302(1)-19302(4). Consequently, receiver 19300 is capable of processing four received signals concurrently in parallel. Similar to FIG. 19, FIG. 20 is a functional block diagram of one example of a receiver 20400 for receiving 1090 MHz Mode S ES ADS-B messages that may perform method 18200. As with receiver 19300 illustrated in FIG. 19, each block represented in FIG. 20 may correspond to a specific logic module of an FPGA. Although the receiver 20400 illustrated in FIG. 20 is shown as having only a single channel, implementations of receiver 20400 may include multiple channels (e.g., 4 channels like the receiver 19300 illustrated in FIG. 19).

For the purposes of the present disclosure, the method 18200 illustrated in FIG. 18 will be described with reference to the receiver 19300 of FIG. 19, and, in particular, with reference to a single channel 19302 of receiver 19300. However, the method 18200 illustrated in FIG. 18 may be performed by a variety of different hardware architectures. For example, in contrast to the FPGA implementation of receiver 19300, in some implementations, the method 18200 illustrated in FIG. 18 may be implemented by one or more microprocessors executing machine-readable instructions stored in electronic memory.

Referring now to FIG. 18, at step 18210, a received analog signal (or at least a portion of a received analog signal) is converted into a digital representation of the received analog signal. In some implementations, at least fifteen samples per 1090 MHz Mode S ES ADS-B message bit period (e.g., 15 samples per µsec) may be taken in converting the received analog signal to digital.

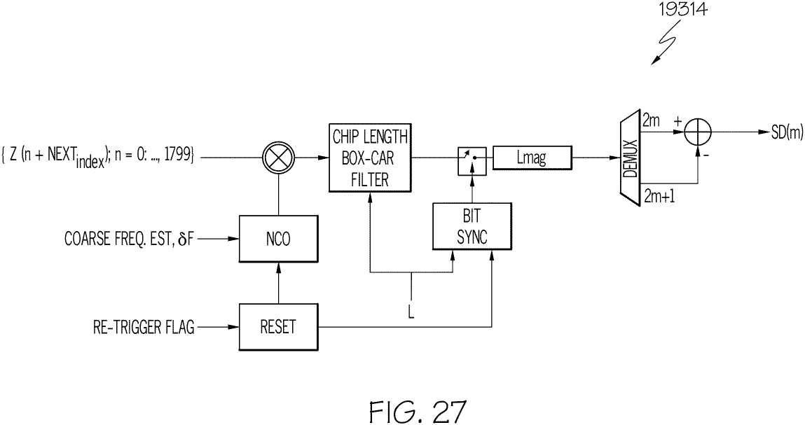

At step 18220, the digital representation of the received signal may be processed to determine if a 1090 MHz spectral component is present. For example, block 19304 of receiver 19300 of FIG. 19 may perform a fast Fourier transform (FFT) on the digital representation of the received signal (or a portion of the digital representation of the received signal) to convert the digital representation of the received signal (or portion thereof) into the frequency domain. Block 19306 then may analyze the frequency domain representation of the digital representation of the received signal (or portion thereof) to determine if a 1090 MHz spectral component is present. In some implementations, a 1090 MHz spectral component may be determined to be present if a spectral component within some defined range of 1090 MHz is present (e.g., +/- 1.05 MHz). Additionally or alternatively, in some implementations block 19306 may detect the phase of the envelope of the digital representation of the received signal and remove the phase to facilitate detection of the carrier. Furthermore, in some implementations, block 19306 also may shift (or attempt to shift) the frequency of the digital representation of the received signal closer to 1090 MHz (e.g., to account for Doppler shift). Moreover, in some implementations, block 19306 may include a carrier frequency estimator, such as, for example, a preliminary quadratic frequency estimator, one particular example of which is illustrated in FIG. 28. In some implementations, 8 µsec (e.g., corresponding to the length of the preamble of a 1090 MHz Mode S ES ADS-B message) or 13 µsec (e.g., corresponding to the length of the preamble and the first 5 bit periods of the data block of a 1090 MHz Mode S ES ADS-B message) may be processed to determine if a 1090 MHz spectral component is present.

Referring again to FIG. 18, if a 1090 MHz spectral component is not determined to be present, the digital representation of the received signal (or portion thereof) may be discarded and the process 18200 may return to step 18210. Alternatively, if a 1090 MHz spectral component is determined to be present, the process 18200 may proceed to step 18230.

At step 18230, the cross-correlation between the digital representation of the received signal (or a portion thereof) and a reference signal representing an expected pulse pattern is calculated. For example, block 19308 of receiver 19300 of FIG. 19 may calculate the cross-correlation (or the complex cross-correlation) between an 8 µsec or 13 µsec segment of the digital representation of the received signal and a reference signal representing the expected pulse pattern of the preamble of a 1090 MHz Mode S ES ADS-B message (e.g., in the case of an 8 µsec segment) or the expected pulse pattern of the preamble and the first 5 bit periods of the data block of a 1090 MHz Mode S ES ADS-B message (e.g., in the case of a 13 µsec segment). In some implementations, the reference signal may represent the perfect theoretical expected pulse pattern (e.g., baseband pulse pattern) in the absence of any noise.

Thereafter, at 18240, a determination may be made as to whether it is likely that the digital representation of the received signal includes a 1090 MHz Mode S ES ADS-B message based on the calculated cross-correlation. For example, block 19308 of receiver 19300 of FIG. 19 may compare a measure of the cross-correlation to a threshold value and determine that it is unlikely that the digital representation of the received signal includes a 1090 MHz Mode S ES ADS-B message if the measure is less than a threshold value or that it is likely that the digital representation of the received signal includes a 1090 MHz Mode S ES ADS-B message if the measure is greater than the threshold value.

In some implementations, additional information may be taken into account at step 18240 when determining the likelihood that the digital representation of the received signal includes a 1090 MHz Mode S ES ADS-B message. For example, in some implementations, block 19310 of receiver 19300 of FIG. 19 may perform CFAR detection processing on the digital representation of the received signal (or portion thereof) as part of determining the likelihood that the digital representation of the received signal includes a 1090 MHz Mode S ES ADS-B message. In such implementations, a determination may be made that it is likely that the digital representation of the received signal includes a 1090 MHz Mode S ES ADS-B message if the measure of the cross-correlation of the digital representation of the received signal (or portion thereof) and the reference signal exceeds a first threshold value and the CFAR detection processing reveals that the power in the received signal exceeds a second threshold level, which may be adjusted dynamically over time in an effort to maintain a desired rate of false alert detection. Otherwise, a determination may be made that it is unlikely that the digital representation of the received signal includes a 1090 MHz Mode S ES ADS-B message.

Referring again to FIG. 18, if it is determined that it is unlikely that the digital representation of the received signal includes a 1090 MHz Mode S ES ADS-B message, the digital representation of the received signal (or portion thereof) may be discarded, and process 18200 may return to step 18210. Alternatively, if it is determined that it is likely that the digital representation of the received signal includes a 1090 MHz Mode S ES ADS-B message, process 18200 may proceed to step 18250.

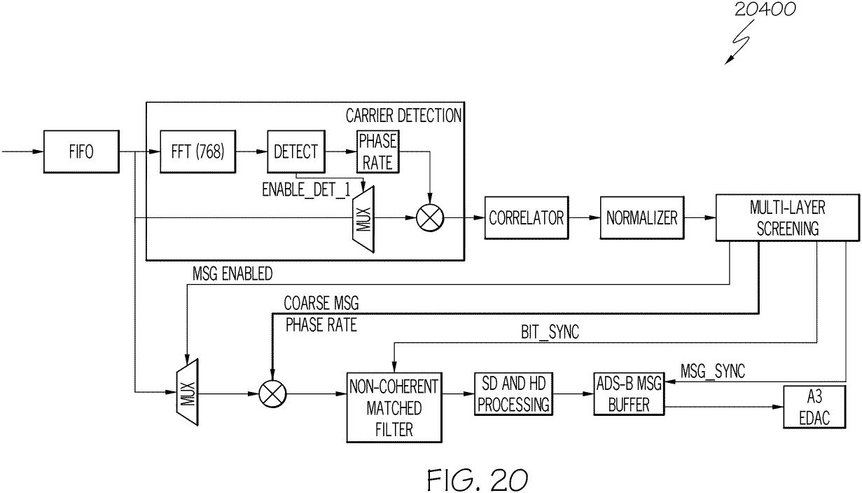

At step 18250, additional multi-layer screening of the digital representation of the received signal is performed to further assess the likelihood that the digital representation of the received signal includes a 1090 MHz Mode S ES ADS-B message. For example, multi-layer signal screening test block 19312 of receiver 19300 of FIG. 19, one particular example of which is illustrated in greater detail in FIG. 21, may perform various different multi-layer screening techniques to further assess the likelihood that the digital representation of the signal includes a 1090 MHz Mode S ES ADS-B message.

In some implementations, and as illustrated in steps 18255, 18260, 18265, and 18270 of the example process 18200 of FIG. 18 and described in greater detail below, such multi-layer screening may include: (i) generating an estimate of a 1090 MHz Mode S ES ADS-B message (or an estimate of a portion of the 1090 MHz Mode S ES ADS-B message) potentially included in the digital representation of the received signal from the digital representation of the received signal (or from a portion of the digital representation of the received signal) (18255); (ii) generating a feature vector representing n ≥ 2 features of the estimated 1090 MHz Mode S ES ADS-B message (or portion thereof) (18260); (iii) projecting the feature vector into an n-dimensional feature space (18265); and (iv) comparing the projection of the feature vector to a cluster of points in the feature space representing sample 1090 MHz Mode S ES ADS-B messages (18270).

Referring specifically to step 18255, in some implementations, an estimate of a 1090 MHz Mode S ES ADS-B message (or a portion thereof (e.g., the preamble or the first 13 bit periods) potentially included in the digital representation of the received signal may be generated from the digital representation of the received signal using a minimum mean square error (“MMSE”) estimator. For example, in some implementations, an MMSE estimator may be used to generate an estimate of an 8 µsec portion of a 1090 MHz Mode S ES ADS-B message potentially included in the digital representation of the received signal for the purpose of comparing certain features of the estimate to expected or representative features of the preamble of a 1090 MHz Mode S ES ADS-B message. Alternatively, in other implementations, an MMSE estimator may be used to generate an estimate of a 13 µsec portion of a 1090 MHz Mode S ES ADS-B message potentially included in the digital representation of the received signal for the purpose of comparing certain features of the estimate to expected or representative features of the preamble and the first 5 bit periods of a 1090 MHz Mode S ES ADS-B message.

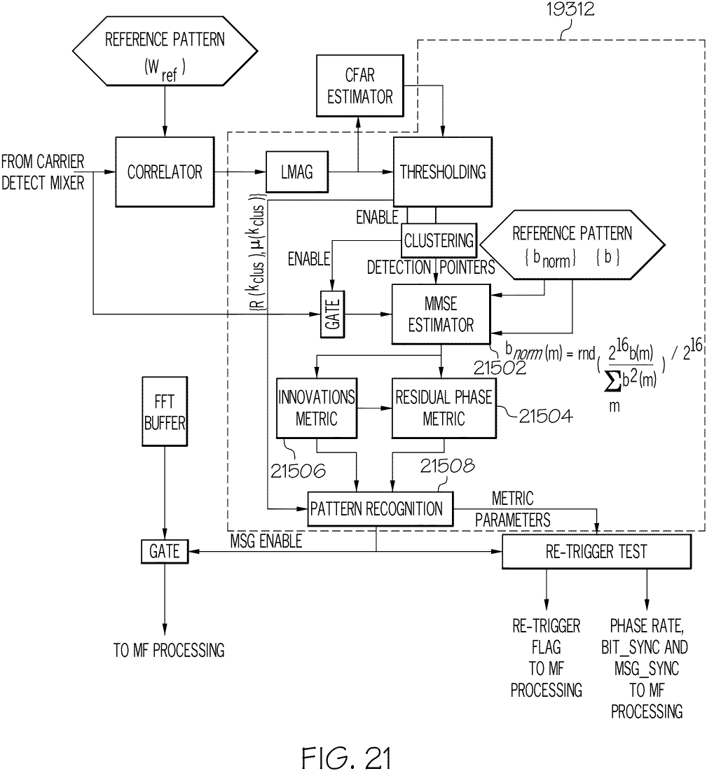

Referring now to FIG. 21, in some implementations, the estimate of the 1090 MHz Mode S ES ADS-B message (or a portion thereof) may be generated by MMSE estimator block 21502 of the example multi-layer screening test block 19312, one particular example of which is illustrated in greater detail in FIG. 22.

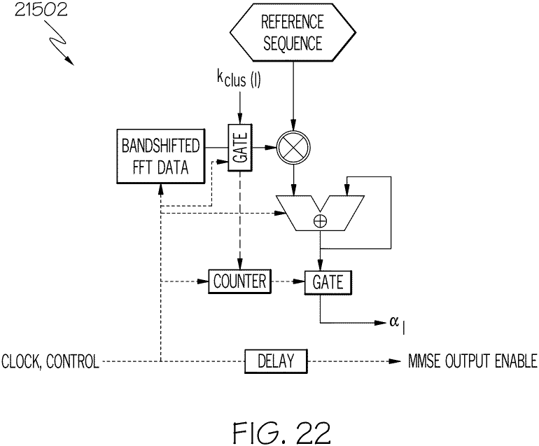

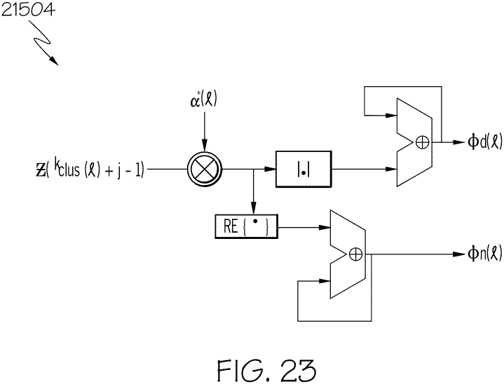

Referring again to FIG. 18, at step 18260, a feature vector representing some number n different features of the estimate of the 1090 MHz Mode S ES ADS-B message (or portion thereof) may be generated. Depending on the implementation, various different features of the estimate may be represented in the feature vector. In some implementations, one or more of a measure of the amplitude consistency of pulses within the estimate, a measure of the phase consistency of the estimate, and a measure of the residual phase error of the estimate may be calculated and represented in the feature vector. For example, referring to FIG. 21, in some implementations, a measure of the residual phase error of the estimate may be calculated by the residual phase metric block 21504 of the example multi-layer screening test block 19312, one particular example of which is illustrated in greater detail in FIG. 23. Additionally or alternatively, in some implementations a measure of the amplitude consistency of pulses within the estimate and/or a measure of the phase consistency of the estimate may be calculated by the innovations metric block 21506 of the example multi-layer screening test block 19312, one particular example of which is illustrated in greater detail in FIG. 24.

Referring again to FIG. 18, at step 18265 the feature vector may be projected into an n-dimensional feature space where each individual dimension of the feature space represents one of the features represented in the feature vector. Thereafter, at step 18270, the projection of the feature vector of the estimate in the feature space is compared to a cluster of points in the feature space representing sample 1090 MHz Mode S ES ADS-B messages (or, if the estimate represents a portion of a 1090 MHz Mode S ES ADS-B message (e.g., the first 8 µsec or 13 µsec), corresponding portions of sample ADS-B messages).

At step 18280, another determination is made as to the likelihood that the digital representation of the received signal includes a 1090 MHz Mode S ES ADS-B message, this time based on the results of the multi-layer screening of the digital representation of the received signal (or portion thereof). In the particular example illustrated in FIG. 18, where the multi-layer screening involves (i) generating an estimate of a 1090 MHz Mode S ES ADS-B message (or an estimate of a portion of a 1090 MHz Mode S ES ADS-B message) potentially included in the digital representation of the received signal from the digital representation of the received signal (or from a portion of the digital representation of the received signal) (18255), (ii) generating a feature vector representing the estimate (18260), (iii) projecting the feature vector into a feature space (18265), and (iv) comparing the projection of the feature vector to a cluster of points in the feature space representing sample 1090 MHz Mode S ES ADS-B messages (or portions thereof) (18270), the determination of the likelihood that the digital representation of the received signal includes a 1090 MHz Mode S ES ADS-B message may be based on the comparison of the projection of the feature vector to the cluster of samples.

For example, the comparison of the projection of the feature vector to the cluster of samples may involve calculating some measure of the distance between the projection of the feature vector and the cluster of samples in the feature space, and the determination of the likelihood that the digital representation of the received signal includes a 1090 MHz Mode S ES ADS-B message may be based on the calculated distance. For example, if the distance is less than some predefined threshold value, it may be determined that it is likely that the digital representation of the received signal includes a 1090 MHz Mode S ES ADS-B message. In contrast, if the distance is greater than the predefined threshold value, it may be determined that it is unlikely that the digital representation of the received signal includes a 1090 MHz Mode S ES ADS-B message. In some particular implementations where the comparison of the projection of the feature vector to the cluster of samples involves calculating a measure of the distance between the projection of the feature vector and the cluster of samples in the feature space, the measure of the distance may be calculated by calculating the Mahalanobis distance between the projection of the feature vector and a distribution of the samples in the feature space.

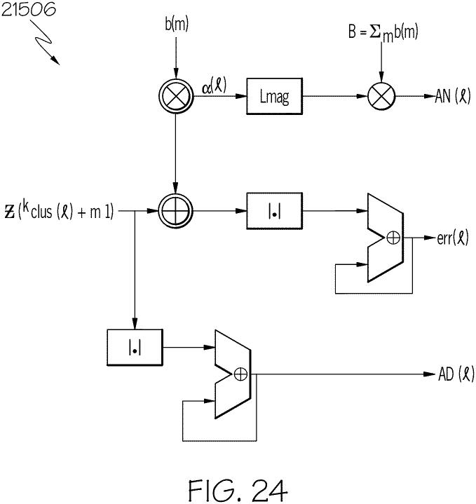

Referring now to FIG. 21, in the particular example implementation described above where the multi-layer screening of the digital representation of the received signal involves generating an estimate of a 1090 MHz Mode S ES ADS-B message (or an estimate of a portion of a 1090 MHz Mode S ES ADS-B message) potentially included in the digital representation of the received signal from the digital representation of the received signal (or from a portion of the digital representation of the received signal), generating a feature vector representing the residual phase error of the estimate, the amplitude consistency of pulses within the estimate, and the phase consistency of the estimate, projecting the feature vector into a corresponding 3-dimensional feature space, and determining the likelihood that the digital representation of the received signal includes a 1090 MHz Mode S ES ADS-B message based on the distance between the projection of the feature vector and a cluster of points representing sample 1090 MHz Mode S ES ADS-B messages (or portions thereof), pattern recognition module 21508 of multi-layer screening module 19312, one particular example of which is represented in greater detail in FIG. 25, generates the feature vector, projects the feature vector into the feature space, and calculates the distance between the projection of the feature vector and the cluster of samples.

In some implementations, pattern recognition module 21508 may be implemented in circuitry that performs processing that is functionally equivalent (or functionally similar) to the functions of generating the feature vector, projecting the feature vector into the feature space, and calculating the distance between the projection of the feature vector and the cluster of samples. Additionally or alternatively, in some implementations, pattern recognition module 21508 may perform the functions (or functional equivalents) of generating the feature vector, projecting the feature vector into the feature space, and calculating the distance between the projection of the feature vector and the cluster of samples in one dimension in a manner that approximates performing such functions in n dimensions.

In some implementations, based on the estimate of the 1090 MHz Mode S ES ADS-B message (or portion thereof) generated by multi-layer signal screening test block 19312, multi-layer signal screening test block 19312 may generate, among other output, an indication of a coarse estimate of the frequency of carrier pulses in the digital representation of the received signal, a bit_sync output that provides timing information about the digital representation of the received signal (e.g., suggesting where bit transitions occur in the digital representation of the received signal to facilitate the later sampling of bits from the output of the coherent matched filter), and/or a msg_sync output that provides an indication of the offset to the first data bit in the digital representation of the received signal (e.g., to facilitate subsequent processing of the actual message and not the preamble).

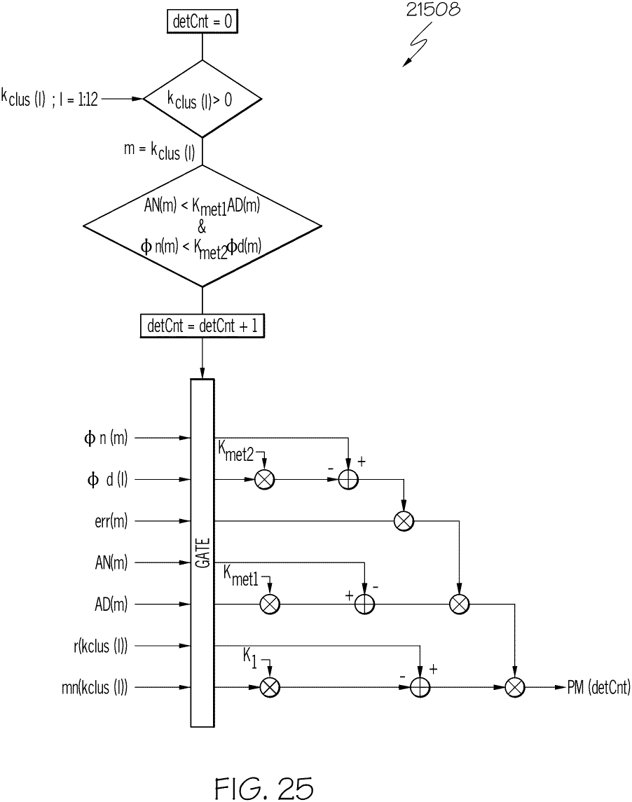

In some implementations, re-triggering testing may be performed while the digital representation of the received signal (or portion thereof) is being processed by multi-layer signal screening test block 19312. For example, re-triggering test module 19316 of receiver 19300 of FIG. 19, one example of a particular implementation of which is illustrated in more detail in FIG. 26, may perform such re-triggering testing. The purpose of this re-triggering testing may be to determine if upcoming samples of the received signal are more likely to include an actual 1090 MHz Mode S ES ADS-B message (or portion thereof) than the digital representation of the received signal (or portion thereof) currently being processed by multi-layer signal screening test block 19312 and, if so, to focus on the upcoming samples of the received signal determined to be more likely to include an actual 1090 MHz Mode S ES ADS-B message than the samples currently being processed.

Referring again to FIG. 18, if a determination is made that it is unlikely that the digital representation of the received signal includes a 1090 MHz Mode S ES ADS-B message, the process 18200 returns to step 18210. Alternatively, if a determination is made that it is likely that the digital representation of the received signal includes a 1090 MHz Mode S ES ADS-B message, the process 18200 may proceed to step 18290 where a non-coherent matched filter is used to recover the 1090 MHz Mode S ES ADS-B message from the digital representation of the received signal.

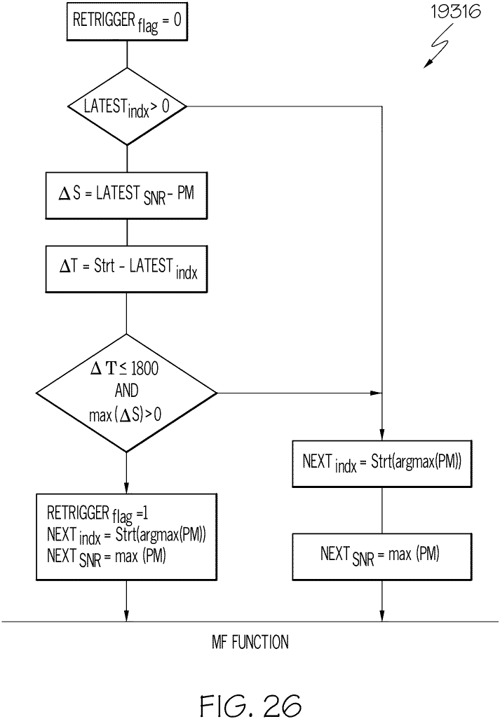

For example, non-coherent matched filter module 19314 of receiver 19300 of FIG. 19, one particular example of which is illustrated in greater detail in FIG. 27, may process the digital representation of the received signal to recover the 1090 MHz Mode S ES ADS-B message from the digital representation of the received signal. Non-coherent matched filter module 19314 may be said to include a matched filter because the filter is matched to the 0.5 µsec 1090 MHz expected pulse form of a 1090 MHz Mode S ES ADS-B message. Stated differently, the impulse response of the matched filter may be a 0.5 µsec 1090 MHz pulse matched to the expected pulse form of a 1090 MHz Mode S ES ADS-B message. For example, in some implementations, the matched filter may include a box-car filter. More particularly, where the received message is sampled at a rate of 15 samples per µsec, non-coherent matched filter module 19314 may include a box-car filter with 15 coefficients with the first seven coefficients having weights of 1 and the last eight coefficients having weights of 0. Furthermore, non-coherent matched filter module 19314 may be said to include a non-coherent filter because the filter included in non-coherent matched filter module 19314 recovers the 1090 MHz Mode S ES ADS-B message from the digital representation of the received signal without a priori knowledge of the phase of the 1090 MHz Mode S ES ADS-B message.

Non-coherent receiver designs such as the implementations described herein may have various advantages and/or differences relative to coherent designs. For example, a non-coherent receiver may handle signal variations, including phase variations, better than a coherent receiver. Additionally or alternatively, a non-coherent receiver that does not attempt to shift the frequency of carrier pulses in a received signal and/or that does not attempt to align the phase of carrier pulses in the received signal with a desired phase may be simpler, and, thus, potentially easier, cheaper, and/or smaller to implement than a coherent filter that does attempt to shift the frequency of carrier pulses in a received signal and/or that does attempt to align the phase of carrier pulses in the received signal.

In implementations in which multi-layer signal screening test block 19312 generates a bit_sync output that provides timing information about the digital representation of the received signal, non-coherent matched filter module 19314 may receive the bit_sync output from the multi-layer signal screening test block 19312 as input and use the bit_sync input to coordinate the timing of the sampling of the output of the non-coherent matched filter.

After the 1090 MHz Mode S ES ADS-B message has been recovered from the received signal, the actual bits of the message still need to be demodulated. For example, determinations need to be made as to whether samples of the recovered message correspond to 1 s or 0 s. Therefore, the recovered 1090 MHz Mode S ES ADS-B message output by non-coherent matched filter module 19314 may be processed by one or more of both soft-decision decoder 19318 and hard-decision decoder 19320 to demodulate the actual bits of the message. Additionally or alternatively, in some implementations, after the bits of the ADS-B message have been demodulated, the bits of the ADS-B message may be processed by an error detection and correction module 19322 in an effort to detect and correct any errors in the decoded bits (e.g., due to noise or other impairments during the transmission or processing of the received signal).

Thereafter, the recovered ADS-B message may be output by the receiver 19300, for example, for transmission to elsewhere in the system. For example, in implementations where receiver 19300 is hosted on a satellite, the recovered ADS-B message may be output by the receiver 19300 for transmission by the satellite to a terrestrial Earth terminal, either by the satellite directly or through a network of satellites, such as, for example, the network 20 of satellites illustrated in FIG. 1B.

### ADS-B Receiver Designs - Coherent Receivers

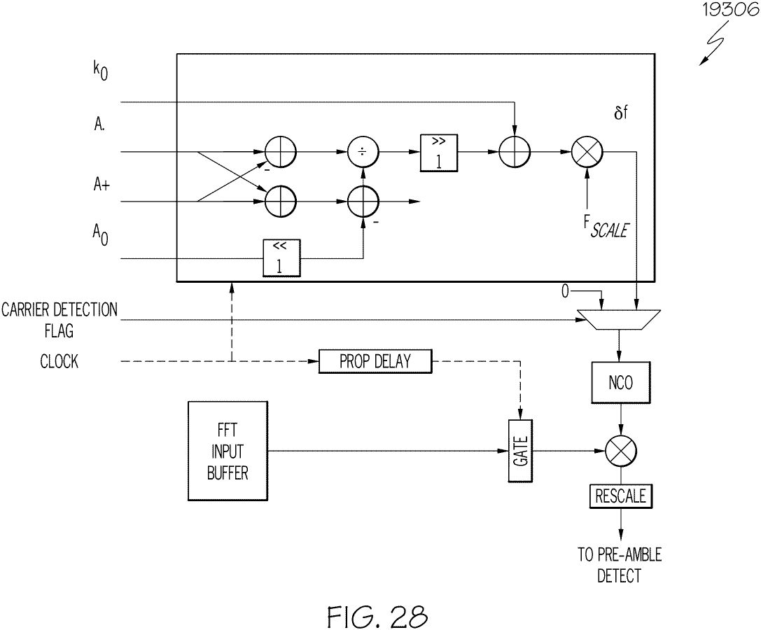

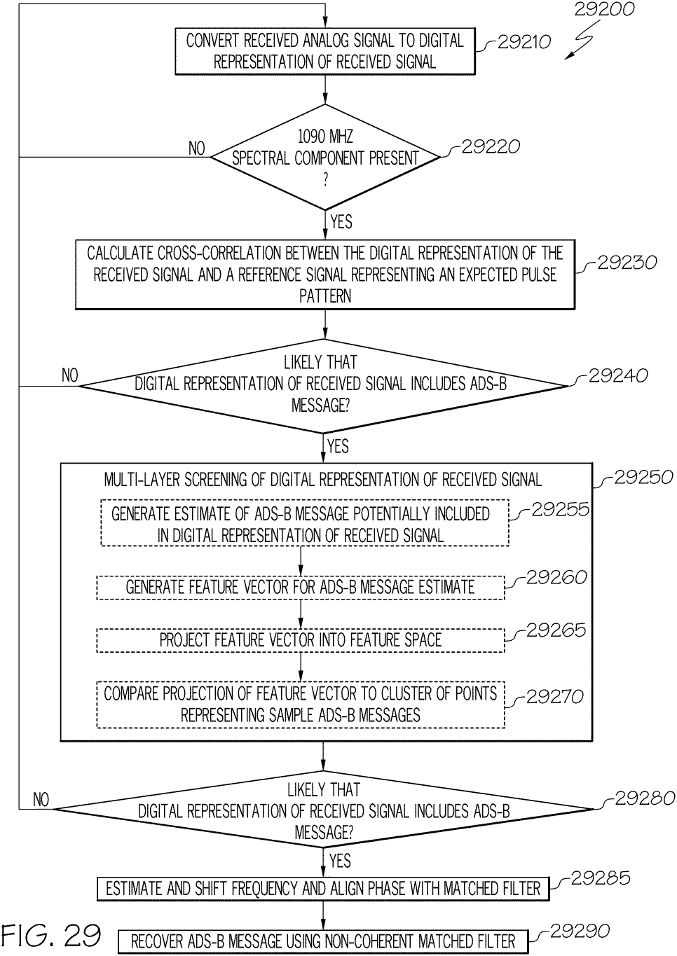

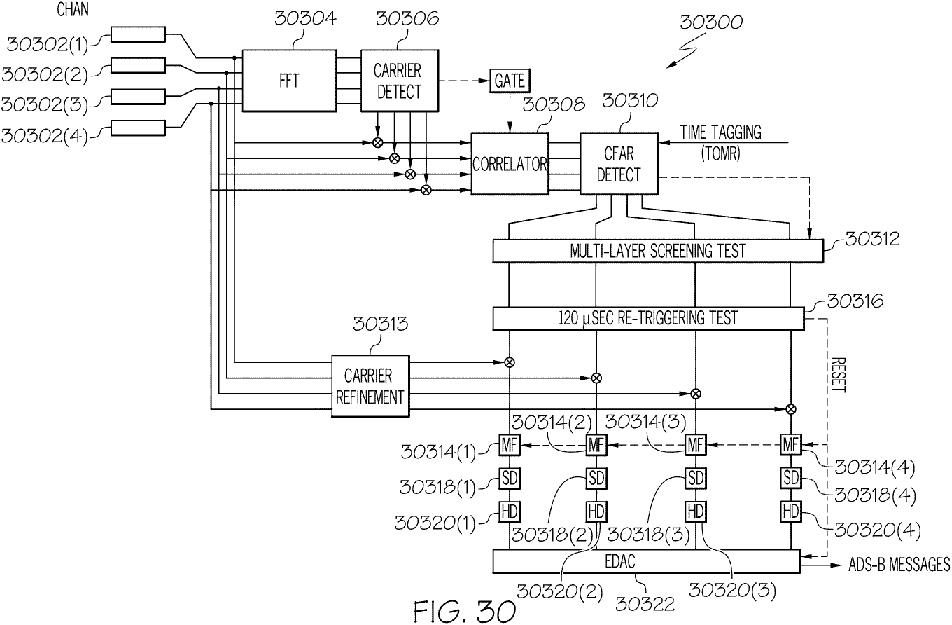

With reference to FIG. 29, a flow chart of a method 29200 for receiving 1090 MHz Mode S ES ADS-B messages using a coherent receiver is illustrated in accordance with a non-limiting implementation of the present disclosure. In some implementations, method 29200 may be performed by a receiver for receiving 1090 MHz Mode S ES ADS-B messages that is implemented in one or more logic modules of a field programmable gate array (“FPGA”). FIG. 30 is a functional block diagram of one example of a receiver 30300 for receiving 1090 MHz Mode S ES ADS-B messages that may perform method 29200. In some implementations, each block represented in FIG. 30 may correspond to a specific logic module of an FPGA. As illustrated in FIG. 30, receiver 30300 includes four channels 30302(1)-30302(4). Consequently, receiver 30300 is capable of processing four received signals concurrently in parallel. Similar to FIG. 30, FIG. 31 is a functional block diagram of one example of a receiver 31400 for receiving 1090 MHz Mode S ES ADS-B messages that may perform method 29200. As with receiver 30300 illustrated in FIG. 30, each block represented in FIG. 31 may correspond to a specific logic module of an FPGA. Although the receiver 31400 illustrated in FIG. 31 is shown as having only a single channel, implementations of receiver 31400 may include multiple channels (e.g., 4 channels like the receiver 30300 illustrated in FIG. 30).

For the purposes of the present disclosure, the method 29200 illustrated in FIG. 29 will be described with reference to the receiver 30300 of FIG. 30, and, in particular, with reference to a single channel 30302 of receiver 30300. However, the method 29200 illustrated in FIG. 29 may be performed by a variety of different hardware architectures. For example, in contrast to the FPGA implementation of receiver 30300, in some implementations, the method 29200 illustrated in FIG. 29 may be implemented by one or more microprocessors executing machine-readable instructions stored in electronic memory.

Referring now to FIG. 29, at step 29210, a received analog signal (or at least a portion of a received analog signal) is converted into a digital representation of the received analog signal. In some implementations, at least fifteen samples per 1090 MHz Mode S ES ADS-B message bit period (e.g., 15 samples per µsec) may be taken in converting the received analog signal to digital.

At step 29220, the digital representation of the received signal may be processed to determine if a 1090 MHz spectral component is present. For example, block 30304 of receiver 30300 of FIG. 30 may perform a fast Fourier transform (FFT) on the digital representation of the received signal (or a portion of the digital representation of the received signal) to convert the digital representation of the received signal (or portion thereof) into the frequency domain. Block 30306 then may analyze the frequency domain representation of the digital representation of the received signal (or portion thereof) to determine if a 1090 MHz spectral component is present. In some implementations, a 1090 MHz spectral component may be determined to be present if a spectral component within some defined range of 1090 MHz is present (e.g., +/- 1.05 MHz). Additionally or alternatively, in some implementations block 30306 may detect the phase of the envelope of the digital representation of the received signal and remove the phase to facilitate detection of the carrier. Furthermore, in some implementations, block 30306 also may shift (or attempt to shift) the frequency of the digital representation of the received signal closer to 1090 MHz (e.g., to account for Doppler shift). In some implementations, 8 µsec (e.g., corresponding to the length of the preamble of a 1090 MHz Mode S ES ADS-B message) or 13 µsec (e.g., corresponding to the length of the preamble and the first 5 bit periods of the data block of a 1090 MHz Mode S ES ADS-B message) may be processed to determine if a 1090 MHz spectral component is present.

Referring again to FIG. 29, if a 1090 MHz spectral component is not determined to be present, the digital representation of the received signal (or portion thereof) may be discarded and the process 29200 may return to step 29210. Alternatively, if a 1090 MHz spectral component is determined to be present, the process 29200 may proceed to step 29230.

At step 29230, the cross-correlation between the digital representation of the received signal (or a portion thereof) and a reference signal representing an expected pulse pattern is calculated. For example, block 30308 of receiver 30300 of FIG. 30 may calculate the cross-correlation (or the complex cross correlation) between an 8 µsec or 13 µsec segment of the digital representation of the received signal and a reference signal representing the expected pulse pattern of the preamble of a 1090 MHz Mode S ES ADS-B message (e.g., in the case of an 8 µsec segment) or the expected pulse pattern of the preamble and the first 5 bit periods of the data block of a 1090 MHz Mode S ES ADS-B message (e.g., in the case of a 13 µsec segment). In some implementations, the reference signal may represent the perfect theoretical expected pulse pattern (e.g., baseband pulse pattern) in the absence of any noise.

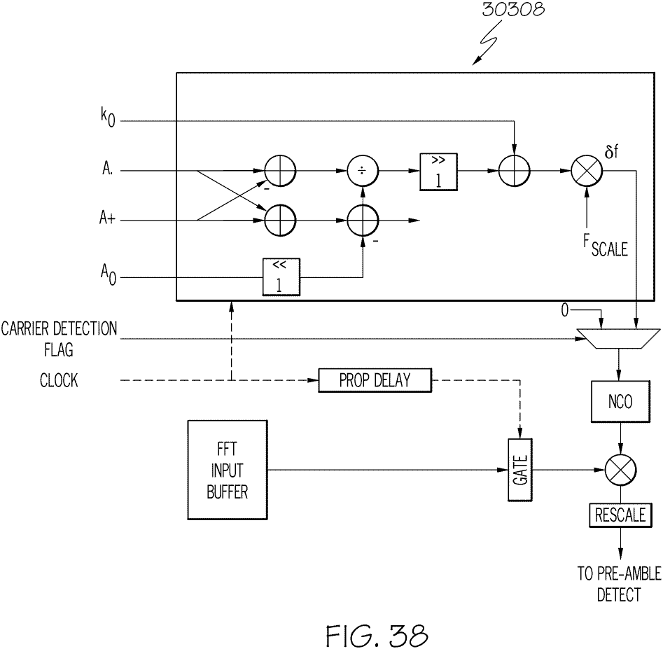

Thereafter, at 29240, a determination may be made as to whether it is likely that the digital representation of the received signal includes a 1090 MHz Mode S ES ADS-B message based on the calculated cross-correlation. For example, block 30308 of receiver 30300 of FIG. 30, one particular example of which is illustrated in greater detail in FIG. 38, may compare a measure of the cross-correlation to a threshold value and determine that it is unlikely that the digital representation of the received signal includes a 1090 MHz Mode S ES ADS-B message if the measure is less than a threshold value or that it is likely that the digital representation of the received signal includes a 1090 MHz Mode S ES ADS-B message if the measure is greater than the threshold value.

In some implementations, additional information may be taken into account at step 29240 when determining the likelihood that the digital representation of the received signal includes a 1090 MHz Mode S ES ADS-B message. For example, in some implementations, block 30310 of receiver 30300 of FIG. 30 may perform CFAR detection processing on the digital representation of the received signal (or portion thereof) as part of determining the likelihood that the digital representation of the received signal includes a 1090 MHz Mode S ES ADS-B message. In such implementations, a determination may be made that it is likely that the digital representation of the received signal includes a 1090 MHz Mode S ES ADS-B message if the measure of the cross-correlation of the digital representation of the received signal (or portion thereof) and the reference signal exceeds a first threshold value and the CFAR detection processing reveals that the power in the received signal exceeds a second threshold level, which may be adjusted dynamically over time in an effort to maintain a desired rate of false alert detection. Otherwise, a determination may be made that it is unlikely that the digital representation of the received signal includes a 1090 MHz Mode S ES ADS-B message.

Referring again to FIG. 29, if it is determined that it is unlikely that the digital representation of the received signal includes a 1090 MHz Mode S ES ADS-B message, the digital representation of the received signal (or portion thereof) may be discarded, and process 29200 may return to step 29210. Alternatively, if it is determined that it is likely that the digital representation of the received signal includes a 1090 MHz Mode S ES ADS-B message, process 29200 may proceed to step 29250.

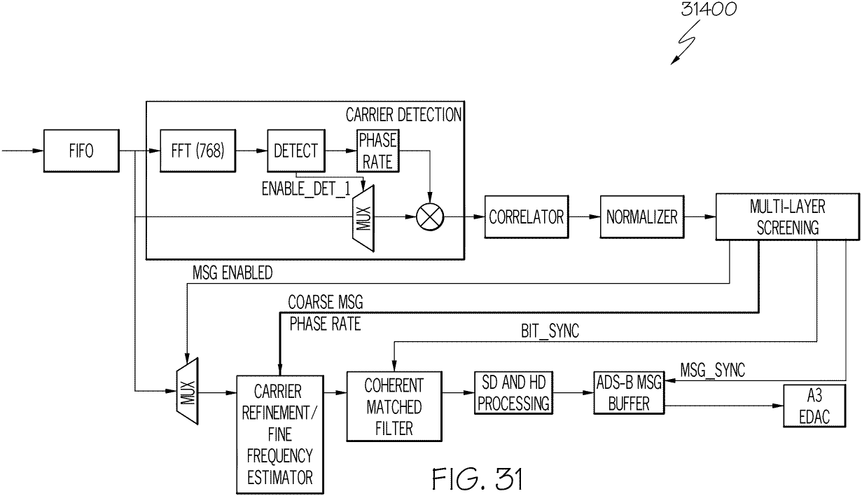

At step 29250, additional multi-layer screening of the digital representation of the received signal is performed to further assess the likelihood that the digital representation of the received signal includes a 1090 MHz Mode S ES ADS-B message. For example, multi-layer signal screening test block 30312 of receiver 30300 of FIG. 30, one particular example of which is illustrated in greater detail in FIG. 32, may perform various different multi-layer screening techniques to further assess the likelihood that the digital representation of the signal includes a 1090 MHz Mode S ES ADS-B message.

In some implementations, and as illustrated in steps 29255, 29260, 29265, and 29270 of the example process 29200 of FIG. 29 and described in greater detail below, such multi-layer screening may include: (i) generating an estimate of a 1090 MHz Mode S ES ADS-B message (or an estimate of a portion of the 1090 MHz Mode S ES ADS-B message) potentially included in the digital representation of the received signal from the digital representation of the received signal (or from a portion of the digital representation of the received signal) (29255); (ii) generating a feature vector representing n ≥ 2 features of the estimated 1090 MHz Mode S ES ADS-B message (or portion thereof) (29260); (iii) projecting the feature vector into an n-dimensional feature space (29265); and (iv) comparing the projection of the feature vector to a cluster of points in the feature space representing sample 1090 MHz Mode S ES ADS-B messages (29270).

Referring specifically to step 29255, in some implementations, an estimate of a 1090 MHz Mode S ES ADS-B message (or a portion thereof (e.g., the preamble or the first 13 bit periods) potentially included in the digital representation of the received signal may be generated from the digital representation of the received signal using a minimum mean square error (“MMSE”) estimator. For example, in some implementations, an MMSE estimator may be used to generate an estimate of an 8 µsec portion of a 1090 MHz Mode S ES ADS-B message potentially included in the digital representation of the received signal for the purpose of comparing certain features of the estimate to expected or representative features of the preamble of a 1090 MHz Mode S ES ADS-B message. Alternatively, in other implementations, an MMSE estimator may be used to generate an estimate of a 13 µsec portion of a 1090 MHz Mode S ES ADS-B message potentially included in the digital representation of the received signal for the purpose of comparing certain features of the estimate to expected or representative features of the preamble and the first 5 bit periods of a 1090 MHz Mode S ES ADS-B message.

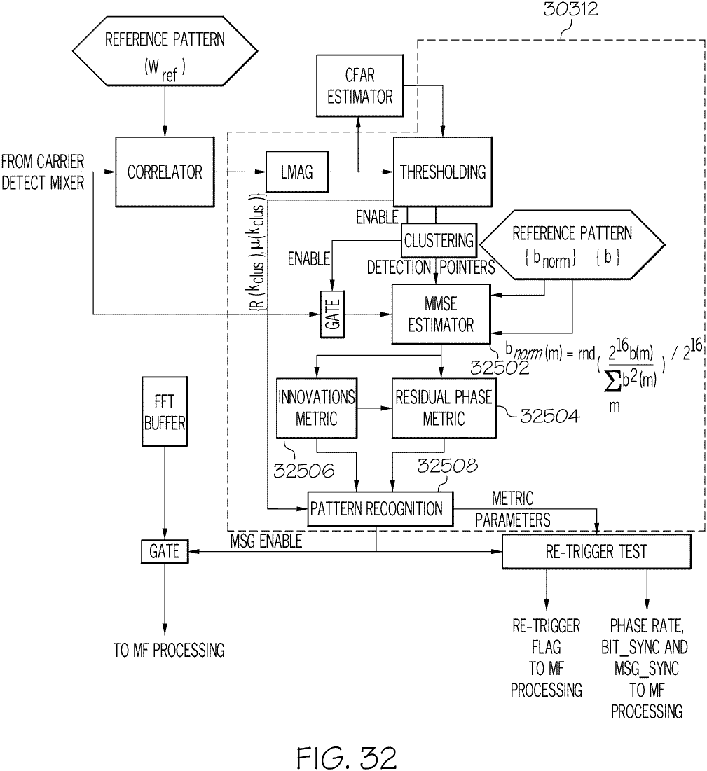

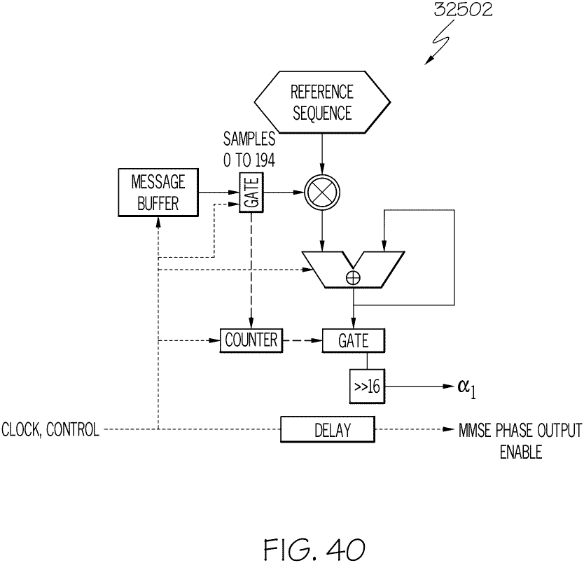

Referring now to FIG. 32, in some implementations, the estimate of the 1090 MHz Mode S ES ADS-B message (or a portion thereof) may be generated by MMSE estimator block 32502 of the example multi-layer screening test block 30312, one particular example of which is illustrated in greater detail in FIG. 33 and another particular example of which is illustrated in greater detail in FIG. 40.

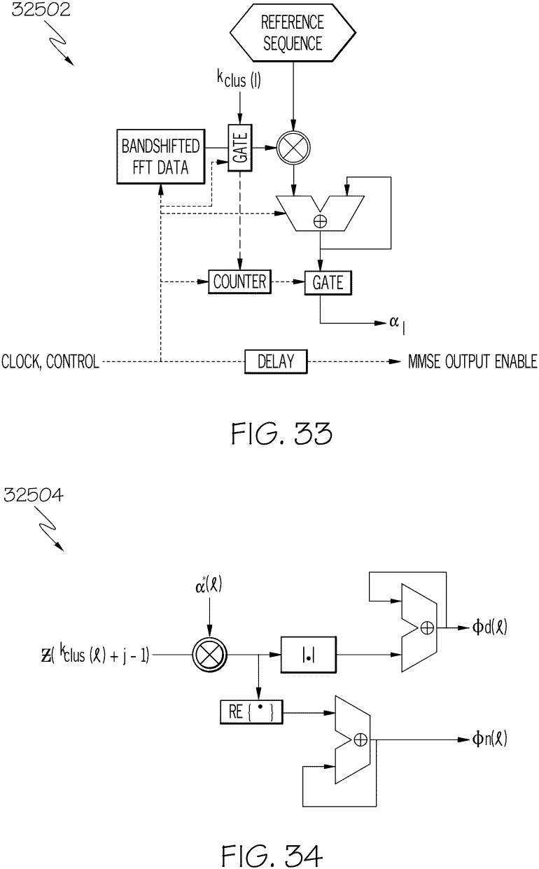

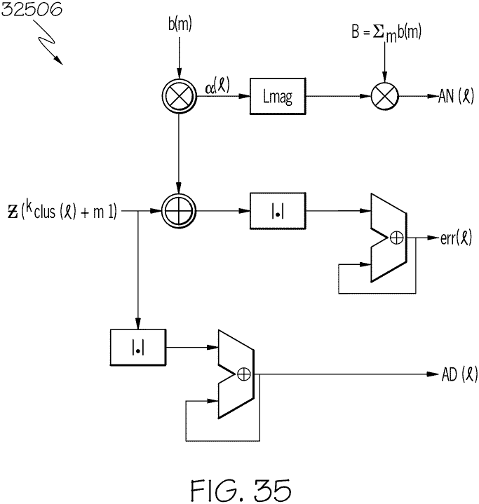

Referring again to FIG. 29, at step 29260, a feature vector representing some number n different features of the estimate of the 1090 MHz Mode S ES ADS-B message (or portion thereof) may be generated. Depending on the implementation, various different features of the estimate may be represented in the feature vector. In some implementations, one or more of a measure of the amplitude consistency of pulses within the estimate, a measure of the phase consistency of the estimate, and a measure of the residual phase error of the estimate may be calculated and represented in the feature vector. For example, referring to FIG. 32, in some implementations, a measure of the residual phase error of the estimate may be calculated by the residual phase metric block 32504 of the example multi-layer screening test block 30312, one particular example of which is illustrated in greater detail in FIG. 34. Additionally or alternatively, in some implementations a measure of the amplitude consistency of pulses within the estimate and/or a measure of the phase consistency of the estimate may be calculated by the innovations metric block 32506 of the example multi-layer screening test block 30312, one particular example of which is illustrated in greater detail in FIG. 35.

Referring again to FIG. 29, at step 29265 the feature vector may be projected into an n-dimensional feature space where each individual dimension of the feature space represents one of the features represented in the feature vector. Thereafter, at step 29270, the projection of the feature vector of the estimate in the feature space is compared to a cluster of points in the feature space representing sample 1090 MHz Mode S ES ADS-B messages (or, if the estimate represents a portion of a 1090 MHz Mode S ES ADS-B message (e.g., the first 8 µsec or 13 µsec), corresponding portions of sample ADS-B messages).

At step 29280, another determination is made as to the likelihood that the digital representation of the received signal includes a 1090 MHz Mode S ES ADS-B message, this time based on the results of the multi-layer screening of the digital representation of the received signal (or portion thereof). In the particular example illustrated in FIG. 29, where the multi-layer screening involves (i) generating an estimate of a 1090 MHz Mode S ES ADS-B message (or an estimate of a portion of a 1090 MHz Mode S ES ADS-B message) potentially included in the digital representation of the received signal from the digital representation of the received signal (or from a portion of the digital representation of the received signal) (29255), (ii) generating a feature vector representing the estimate (29260), (iii) projecting the feature vector into a feature space (29265), and (iv) comparing the projection of the feature vector to a cluster of points in the feature space representing sample 1090 MHz Mode S ES ADS-B messages (or portions thereof) (29270), the determination of the likelihood that the digital representation of the received signal includes a 1090 MHz Mode S ES ADS-B message may be based on the comparison of the projection of the feature vector to the cluster of samples.

For example, the comparison of the projection of the feature vector to the cluster of samples may involve calculating some measure of the distance between the projection of the feature vector and the cluster of samples in the feature space, and the determination of the likelihood that the digital representation of the received signal includes a 1090 MHz Mode S ES ADS-B message may be based on the calculated distance. For example, if the distance is less than some predefined threshold value, it may be determined that it is likely that the digital representation of the received signal includes a 1090 MHz Mode S ES ADS-B message. In contrast, if the distance is greater than the predefined threshold value, it may be determined that it is unlikely that the digital representation of the received signal includes a 1090 MHz Mode S ES ADS-B message. In some particular implementations where the comparison of the projection of the feature vector to the cluster of samples involves calculating a measure of the distance between the projection of the feature vector and the cluster of samples in the feature space, the measure of the distance may be calculated by calculating the Mahalanobis distance between the projection of the feature vector and a distribution of the samples in the feature space.

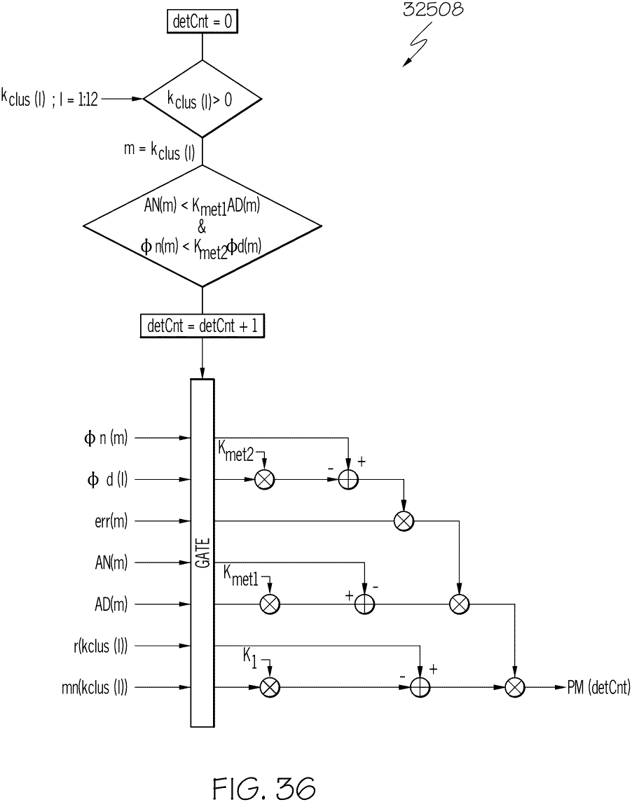

Referring now to FIG. 32, in the particular example implementation described above where the multi-layer screening of the digital representation of the received signal involves generating an estimate of a 1090 MHz Mode S ES ADS-B message (or an estimate of a portion of a 1090 MHz Mode S ES ADS-B message) potentially included in the digital representation of the received signal from the digital representation of the received signal (or from a portion of the digital representation of the received signal), generating a feature vector representing the residual phase error of the estimate, the amplitude consistency of pulses within the estimate, and the phase consistency of the estimate, projecting the feature vector into a corresponding 3-dimensional feature space, and determining the likelihood that the digital representation of the received signal includes a 1090 MHz Mode S ES ADS-B message based on the distance between the projection of the feature vector and a cluster of points representing sample 1090 MHz Mode S ES ADS-B messages (or portions thereof), pattern recognition module 32508 of multi-layer screening module 30312, one particular example of which is represented in greater detail in FIG. 36, generates the feature vector, projects the feature vector into the feature space, and calculates the distance between the projection of the feature vector and the cluster of samples.

In some implementations, pattern recognition module 32508 may be implemented in circuitry that performs processing that is functionally equivalent (or functionally similar) to the functions of generating the feature vector, projecting the feature vector into the feature space, and calculating the distance between the projection of the feature vector and the cluster of samples. Additionally or alternatively, in some implementations, pattern recognition module 32508 may perform the functions (or functional equivalents) of generating the feature vector, projecting the feature vector into the feature space, and calculating the distance between the projection of the feature vector and the cluster of samples in one dimension in a manner that approximates performing such functions in n dimensions.

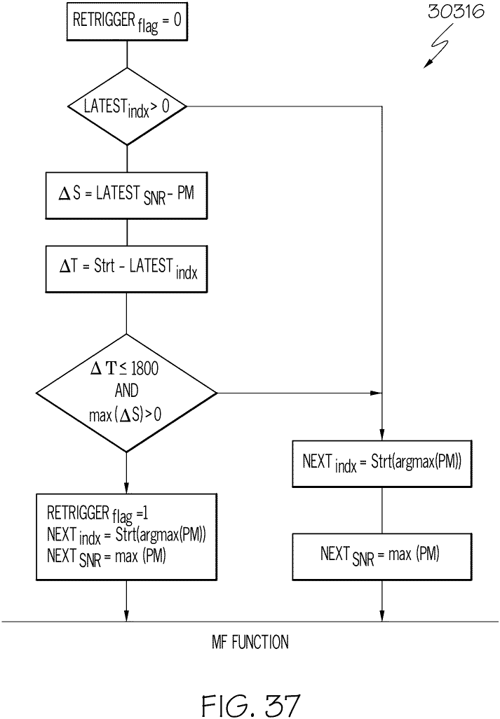

In some implementations, re-triggering testing may be performed while the digital representation of the received signal (or portion thereof) is being processed by multi-layer signal screening test block 30312. For example, re-triggering test module 30316 of receiver 30300 of FIG. 30, one example of a particular implementation of which is illustrated in more detail in FIG. 37, may perform such re-triggering testing. The purpose of this re-triggering testing may be to determine if upcoming samples of the received signal are more likely to include an actual 1090 MHz Mode S ES ADS-B message (or portion thereof) than the digital representation of the received signal (or portion thereof) currently being processed by multi-layer signal screening test block 30312 and, if so, to focus on the upcoming samples of the received signal determined to be more likely to include an actual 1090 MHz Mode S ES ADS-B message than the samples currently being processed.

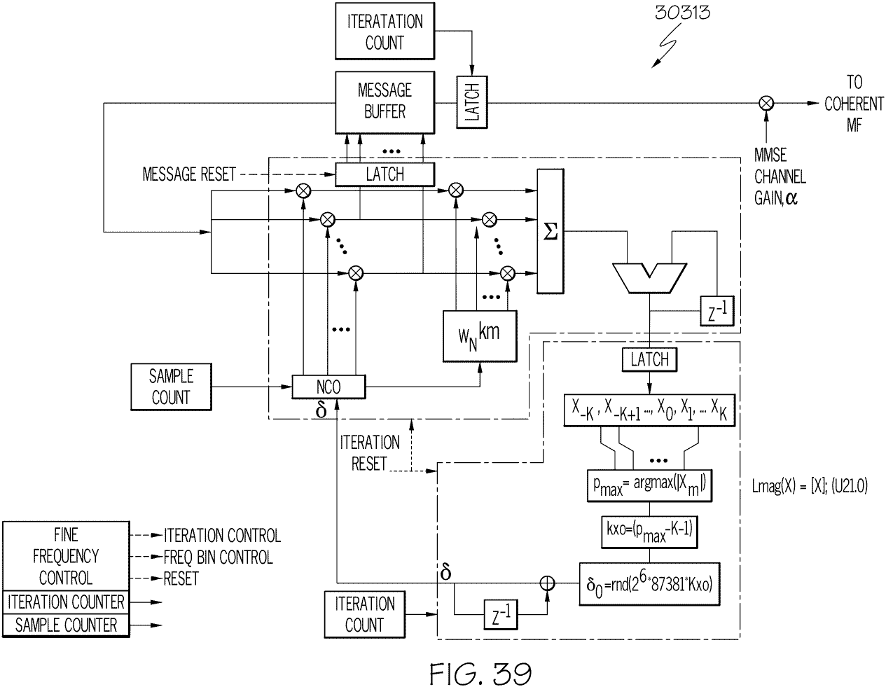

Referring again to FIG. 29, if a determination is made that it is unlikely that the digital representation of the received signal includes a 1090 MHz Mode S ES ADS-B message, the process 29200 returns to step 29210. Alternatively, if a determination is made that it is likely that the digital representation of the received signal includes a 1090 MHz Mode S ES ADS-B message, the process 29200 may proceed to step 29285 where the frequency of carrier pulses in the digital representation of the received signal may be estimated and shifted and the phase of carrier pulses in the digital representation of the received signal may be aligned with a desired phase. For example, in some implementations, carrier refinement module 30313 of receiver 30300 of FIG. 30, one particular example of which is illustrated in greater detail in FIG. 39, may estimate the frequency of carrier pulses in the digital representation of the received signal, shift the frequency of carrier pulses in the received signal toward a desired frequency and/or align the phase of carrier pulses in the digital representation of the received signal with a desired phase. It should be understood that, in the context of this disclosure, references to aligning the phase of carrier pulses in the digital representation of the received signal with a desired phase may not signify perfectly aligning the phase of carrier pulses in the digital representation of the received signal with a desired phase but, instead, may signify substantially aligning the phase of carrier pulses in the digital representation of the received signal with a desired phase. In some implementations, processing performed by carrier refinement module 30313 effectively may rotate signal power of the digital representation of the received signal from the imaginary axis to the real axis.

In some implementations, based on the estimate of the 1090 MHz Mode S ES ADS-B message (or portion thereof) generated by multi-layer signal screening test block 30312, multi-layer signal screening test block 30312 may generate, among other output, an indication of a coarse estimate of the frequency of carrier pulses in the digital representation of the received signal, a bit_sync output that provides timing information about the digital representation of the received signal (e.g., suggesting where bit transitions occur in the digital representation of the received signal to facilitate the later sampling of bits from the output of the coherent matched filter), and/or a msg_sync output that provides an indication of the offset to the first data bit in the digital representation of the received signal (e.g., to facilitate subsequent processing of the actual message and not the preamble).

In implementations in which multi-layer signal screening test block 30312 generates an indication of a coarse estimate of the frequency of carrier pulses in the digital representation of the received signal, carrier refinement module 30313 may receive the indication of the coarse estimate of the frequency of carrier pulses in the digital representation of the received signal and use the coarse estimate of the frequency of carrier pulses in the digital representation of the received signal in connection with more finely estimating the frequency of carrier pulses in the digital representation of the received signal, shifting the frequency of carrier pulses in the received signal to a desired frequency, and/or aligning the phase of carrier pulses in the digital representation of the received signal with a desired phase. For example, in some implementations, carrier refinement module 30313 may determine the offset between the desired frequency and the coarse estimate of the frequency of carrier pulses in the digital representation of the received signal and attempt to shift the frequency of the carrier pulses in the digital representation of the received signal by the determined offset in order to shift the frequency of the carrier pulses in the digital representation of the received signal toward the desired frequency. Thereafter, the carrier refinement module 30313 may use a fast Fourier transform (FFT) algorithm to compute the discrete-time Fourier transform (DTFT) of the digital representation of the received signal (or a portion thereof) and use the DTFT of the digital representation of the received signal (or portion thereof) to determine the frequency of the peak energy in the digital representation of the received signal (or portion thereof). The carrier refinement module 30313 then may determine the offset between the desired frequency and the frequency of the peak energy in the digital representation of the received signal (or portion thereof) and attempt to shift the frequency of the carrier pulses in the digital representation of the received signal by the determined offset in order to shift the frequency of the carrier pulses in the digital representation of the received signal toward the desired frequency. In some implementations, the carrier refinement module 30313 may iteratively repeat this process some defined number of times (e.g., 3 or 4 times) or until the offset between the desired frequency and the frequency of the peak energy in the digital representation of the received signal falls below a defined threshold value.

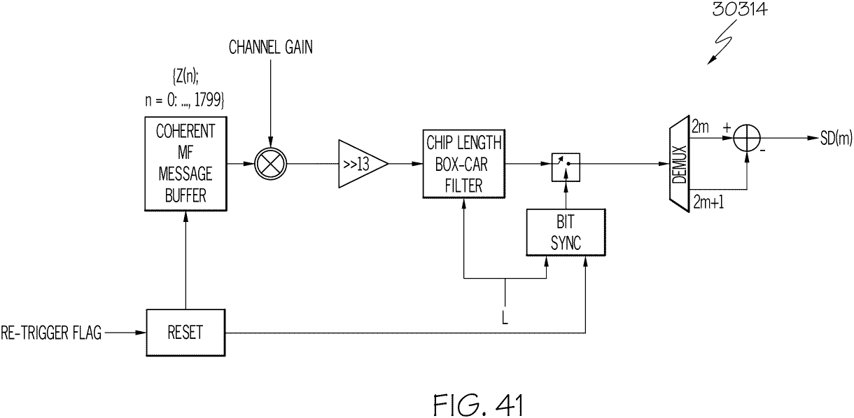

Referring again to FIG. 29, at step 29290, a coherent matched filter that is phase-matched to the desired phase is used to recover the 1090 MHz Mode S ES ADS-B message from the digital representation of the received signal. For example, coherent matched filter module 30314 of receiver 30300 of FIG. 30, one particular example of which is illustrated in greater detail in FIG. 41, may process the digital representation of the received signal to recover the 1090 MHz Mode S ES ADS-B message from the digital representation of the received signal. Coherent matched filter module 30314 may be said to include a matched filter because the filter is matched to the 0.5 µsec 1090 MHz expected pulse form of a 1090 MHz Mode S ES ADS-B message. Stated differently, the impulse response of the matched filter may be a 0.5 µsec 1090 MHz pulse matched to the expected pulse form of a 1090 MHz Mode S ES ADS-B message. For example, in some implementations, the matched filter may include a box-car filter. More particularly, where the received message is sampled at a rate of 15 samples per µsec, coherent matched filter module 30314 may include a box-car filter with 15 coefficients with the first seven coefficients having weights of 1 and the last eight coefficients having weights of 0. Furthermore, coherent matched filter module 30314 may be said to include a coherent filter because the phase of the carrier pulses in the digital representation of the received signal has been matched to the filter in the coherent matched filter module 30314.

In implementations in which multi-layer signal screening test block 30312 generates a bit_sync output that provides timing information about the digital representation of the received signal, coherent matched filter module 30314 may receive the bit sync output from the multi-layer signal screening test block 30312 as input and use the bit_sync input to coordinate the timing of the sampling of the output of the coherent matched filter.

After the 1090 MHz Mode S ES ADS-B message has been recovered from the received signal, the actual bits of the message still need to be demodulated. For example, determinations need to be made as to whether samples of the recovered message correspond to 1 s or 0 s. Therefore, the recovered 1090 MHz Mode S ES ADS-B message output by coherent matched filter module 30314 may be processed by one or more of both soft-decision decoder 30318 and hard-decision decoder 30320 to demodulate the actual bits of the message. Additionally or alternatively, in some implementations, after the bits of the ADS-B message have been demodulated, the bits of the ADS-B message may be processed by an error detection and correction module 30322 in an effort to detect and correct any errors in the decoded bits (e.g., due to noise or other impairments during the transmission or processing of the received signal).

Thereafter, the recovered ADS-B message may be output by the receiver 30300, for example, for transmission to elsewhere in the system. For example, in implementations where receiver 30300 is hosted on a satellite, the recovered ADS-B message may be output by the receiver 30300 for transmission by the satellite to a terrestrial Earth terminal, either by the satellite directly or through a network of satellites, such as, for example, the network 20 of satellites illustrated in FIG. 1B.

FIG. 42 is a functional block diagram of an example of a ground control system and satellite interaction ecosystem 42105 for a space-based ADS-B system in accordance with a non-limiting implementation of the present disclosure. As illustrated in FIG. 42, the ecosystem may include a server or other computing platform 42110, a memory 42115, a ground control system 42120, a processor 42125, an interface 42155, an input and output (“I/O”) device 42130, and a hard disk 42140. Ground control system 42120 processes may be performed on the computing platform 42110 shown in FIG. 42. Processor 42125 may be operable to load instructions from hard disk 42140 into memory 42115 and execute those instructions. Memory 42115 may store computer-readable instructions that may instruct the computing platform 42110 to perform certain processes. I/O device 42130 may receive one or more of data from another server, local database, or a network 42145. The computing platform 42110 may be considered a processing system.

Satellites 42155a-42155z may include ADS-B receivers or otherwise be configured to receive ADS-B messages broadcast by aircraft. As such, satellites 42155a-42155z may include antennas that provide multiple beams for receiving ADS-B messages.

Network 42145 may facilitate wireless communications of information and provisioning of satellites 42155a-42155z. For example, the ground control system 42120 may communicate with satellites 42155a-42155z via the network 42145. As such, network 42145 may include wireless (e.g., radio frequency (RF”) uplinks and downlinks for communicating with satellites 42155a-42155z. Communications sent by the ground control system 42120 to satellites 42155a-42155z via network 42145 may include resource management instructions, for example, as described in greater detail above in the section under the Intelligent Resource Management heading, and/or beam selection schedules, for example, as described in greater above in the section under the Beam Scheduling heading. Similarly, satellites 42155a-42155z may relay received ADS-B messages through network 42145 for terrestrial processing.

The ground control system 42120 may also include or have access to a database 42150 which may include, for example, additional servers, data storage, and resources. Ground control system 42120 may receive additional data from database 42150, such as, for example, expected antenna beam gain patterns, information about desired or required coverage areas, available beam patterns, and power budgets available to individual satellites 42155.

In some implementations, the ground control system 42120 may be configured to perform, among other functions, resource management processes for satellites 42155a-42155z, for example, as described above in the section under the Intelligent Resource Management heading, and/or beam selection and scheduling processes for satellites 42155a-42155z, for example, as described above in the section under the Beam Scheduling heading.

Aspects of the present disclosure may be implemented entirely in hardware, entirely in software (including firmware, resident software, micro-code, etc.) or in combinations of software and hardware that may all generally be referred to herein as a “circuit,” “module,” “component,” or “system.” Furthermore, aspects of the present disclosure may take the form of a computer program product embodied in one or more machine-readable media having machine-readable program code embodied thereon.

Any combination of one or more machine-readable media may be utilized. The machine-readable media may be a machine-readable signal medium or a machine-readable storage medium. A machine-readable storage medium may be, for example, but not limited to, an electronic, magnetic, optical, electromagnetic, or semiconductor system, apparatus, or device, or any suitable combination of the foregoing. More specific examples (a non-exhaustive list) of such a machine-readable storage medium include the following: a hard disk, a random access memory (RAM), a read-only memory (ROM), an erasable programmable read-only memory (EPROM or Flash memory), an appropriate optical fiber with a repeater, an optical storage device, a magnetic storage device, or any suitable combination of the foregoing. In the context of this document, a machine-readable storage medium may be any tangible medium that can contain, or store a program for use by or in connection with an instruction execution system, apparatus, or device, such as, for example, a microprocessor.

A machine-readable signal medium may include a propagated data signal with machine-readable program code embodied therein, for example, in baseband or as part of a carrier wave. Such a propagated signal may take any of a variety of forms, including, but not limited to, electromagnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device. Program code embodied on a machine-readable signal medium may be transmitted using any appropriate medium, including but not limited to wireless, wireline, optical fiber cable, RF signals, etc., or any suitable combination of the foregoing.

Computer program code for carrying out operations for aspects of the present disclosure may be written in any combination of one or more programming languages, including object oriented programming languages, dynamic programming languages, and/or procedural programming languages.

The flowcharts and block diagrams in the figures illustrate examples of the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order illustrated in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and machine-readable instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to explain the principles of the disclosure and the practical application, and to enable others of ordinary skill in the art to understand the disclosure with various modifications as are suited to the particular use contemplated.

What is claimed is:

1. A system for space-based aircraft monitoring comprising:
a ground segment;
multiple aircraft monitoring payloads on board corresponding satellites in orbit around the Earth; and
a resource scheduling system to schedule resources available to individual payloads, wherein:
individual payloads:
include antenna systems configured to provide multiple beams for receiving 1090 MHz Mode S ES ADS-B messages,
include two or more receivers implemented, at least in part, by reconfigurable field programmable gate arrays and configured to process 1090 MHz Mode S ES ADS-B messages received by their antenna systems, and
are configured to initiate transmission of 1090 MHz Mode S ES ADS-B messages processed by one or more of their receivers to the ground segment;
the ground segment is configured to:
receive 1090 MHz Mode S ES ADS-B messages for which the payloads initiated transmission to the ground segment, and
route received 1090 MHz Mode S ES ADS-B messages to one or more destinations for aircraft monitoring; and
the resource scheduling system is configured to control the antenna systems of individual payloads to dynamically adjust the beams for receiving 1090 MHz Mode S ES ADS-B messages of the individual antenna systems.

2. The system of claim 1 wherein, in addition to the aircraft monitoring payloads, the satellites also host other payloads configured to provide different functions than the aircraft monitoring payloads.

3. The system of claim 1 wherein the aircraft monitoring payloads are the primary payloads on board the corresponding satellites in orbit around the Earth.

4. The system of claim 1 wherein:
the resource scheduling system is a component of the ground segment, and
the ground segment is configured to transmit instructions to individual payloads controlling the resources available to such payloads.

5. The system of claim 1 wherein the resource scheduling system is distributed across one or more of the aircraft monitoring payloads.

6. The system of claim 1 wherein the resource scheduling system is configured to:
access information defining expected aircraft traffic at different times; and
control the antenna systems of individual payloads to dynamically adjust their beams for receiving 1090 MHz Mode S ES ADS-B messages based on the expected aircraft traffic at different times in areas covered by the beams of the antenna systems as a consequence of having accessed the information defining the excepted aircraft traffic at different times.

7. The system of claim 1 wherein the resource scheduling system is configured to:
access information defining available power budgets for individual payloads at different times; and
schedule resources available to individual payloads at different times to limit power consumed by the individual payloads at the different times based on the available power budgets for the individual payloads as a consequence of having accessed the information defining the available power budgets at different times.

8. The system of claim 7 wherein the resource scheduling system is further configured to:
access information defining expected aircraft traffic at different times; and
schedule resources available to individual payloads at different times based on the excepted aircraft traffic at different times in areas covered by the beams of the payloads’ antenna systems as a consequence of having accessed the information defining the excepted aircraft traffic at different times.

9. The system of claim 1 wherein at least one of the receivers included on each individual payload is a non-coherent receiver configured to process 1090 MHz Mode S ES ADS-B messages without a priori knowledge of the phase of the 1090 MHz Mode S ES ADS-B messages.

10. The system of claim 1 wherein at least one of the receivers included on each individual payload is a coherent receiver configured to process 1090 MHz Mode S ES ADS-B messages.

11. The system of claim 1 wherein individual payloads are configured to screen received 1090 MHz Mode S ES ADS-B messages for potential errors and not initiate transmission of received 1090 MHz Mode S ES ADS-B messages to the ground segment for which potential errors are detected.

12. The system of claim 1 wherein individual payloads are configured to screen 1090 MHz Mode S ES ADS-B messages received by the two or more receivers included in each payload for duplicates and initiate transmission of a single received 1090 MHz Mode S ES ADS-B message for which one or more duplicates are detected.

13. A payload for space-based aircraft monitoring comprising:
an antenna system configured to provide multiple beams for receiving 1090 MHz Mode S ES ADS-B messages while in orbit above the Earth and to dynamically adjust the beams for receiving 1090 MHz Mode S ES ADS-B messages;
two or more receivers implemented, at least in part, by reconfigurable field programmable gate arrays and configured to process 1090 MHz Mode S ES ADS-B messages received by the antenna system; and
a transmission system configured to initiate transmission of 1090 MHz Mode S ES ADS-B messages processed by the receivers to a ground segment while in orbit above the Earth.

14. The payload of claim 13 further comprising a resource scheduling system that issues instructions to the antenna system to dynamically adjust the beams for receiving 1090 MHz Mode S ES ADS-B messages.

15. The payload of claim 13 wherein the antenna system is configured to dynamically adjust the beams for receiving 1090 MHz Mode S ES ADS-B messages based on expected aircraft traffic at different times in areas covered by the beams of the antenna system.

16. The payload of claim 13 wherein at least one of the receivers is a non-coherent receiver configured to process 1090 MHz Mode S ES ADS-B messages without a priori knowledge of the phase of the 1090 MHz Mode S ES ADS-B messages.

17. The payload of claim 13 wherein at least one of the receivers is a coherent receiver configured to process 1090 MHz Mode S ES ADS-B messages.

18. The payload of claim 13 wherein the payload is configured to screen received 1090 MHz Mode S ES ADS-B messages for potential errors and not initiate transmission of received 1090 MHz Mode S ES ADS-B messages to the ground segment for which potential errors are detected.

19. The payload of claim 13 wherein the payload is configured to screen 1090 MHz Mode S ES ADS-B messages received by the receivers for duplicates and initiate transmission of a single received 1090 MHz Mode S ES ADS-B message for which one or more duplicates are detected.

20. A ground segment for a space-based aircraft monitoring system including multiple aircraft monitoring payloads on board corresponding satellites in orbit around the Earth, the ground segment comprising:
an antenna system configured to transmit communications to and receive communications from the satellites;
one or more processing elements; and
computer readable storage media storing instructions that, when executed by the one or more processing elements, cause the one or more processing elements to:
control antenna subsystems of individual aircraft monitoring payloads configured to provide beams for receiving 1090 MHz Mode S ES ADS-B messages to dynamically adjust the beams,
process 1090 MHz Mode S ES ADS-B messages received from the satellites, and route processed 1090 MHz Mode S ES ADS-B messages to one or more destinations for aircraft monitoring.
